(19) United States
(12) Patent Application Publication
(10) Pub. No.: US 2012/0101847 A1
(43) Pub. Date: Apr. 26, 2012

(54) Mobile Medical Information System and Methods of Use

(76) Inventors: Jacob Johnson, San Francisco, CA (US); Dianna Kane, San Francisco, CA (US); Kristen McCaleb, Daly City, CA (US)

(21) Appl. No.: 13/277,185

(22) Filed: Oct. 19, 2011

Related U.S. Application Data
(60) Provisional application No. 61/394,890, filed on Oct. 20, 2010.

(51) Int. Cl. G06Q 50/24; G06Q 50/22

(52) U.S. Cl. 705/3; 705/2

(57) ABSTRACT

Systems, methods and computer readable media performing mobile medical information management are provided. In one aspect, one or more web-based patient portals are accessed and medical history records of a patient are downloaded therefrom, based upon a user profile including personal information that uniquely identifies the patient. All or part of the downloaded data can be outputted to at least one of the patient and a physician or other authorized care provider treating or evaluating the patient.

### CROSS-REFERENCE

This application claims the benefit of U.S. Provisional Application No. 61/394,890, filed Oct. 20, 2010 and titled “Mobile Medical Information System and Methods of Use”, which application is hereby incorporated herein, in its entirety, by reference thereto, and to which application we claim priority to under 35 U.S.C. Section 119.

### BACKGROUND OF THE INVENTION

In the health care professions, paper files have typically been relied upon for recording and storing patient medical data and other personal data to track a patient's health, health care, hospital visits, medical billing, including third party payers, and more. In this mobile society, paper file tracking methods, as a sole method of keeping medical records have become outdated and present numerous problems. One such problem is that it is becoming much more likely that a patient will switch jobs over his/her working lifetime, often multiple times. With any job change can also come a change in the patient's insurer, which can also result in a change of primary health care provider. Further, a job change can also result in a change of physical location (residency) of the patient, necessitating a change in health care provider. With each of these changes, there is a risk presented that some or all of the patient's existing medical records will not successfully reach the new provider/location where the patient is to be treated and the patient also may not successfully obtain possession of all records.

Further, paper records are time consuming to generate, require a great deal of space for storage, are many times illegible, are expensive and time consuming to duplicate, are frequently misplaced or misfiled within a medical office and can be easily lost or damaged during transport.

Although there have been some sporadic efforts at digitizing and electronically storing medical data for some portions of the health care field (such as some prescriptions and pharmaceutical record keeping), there is a continuing need for low cost, mobile solutions for record keeping that allow more complete access to medical records and sharing of the same in a secure manner.

U.S. Patent Application Publication No. 2001/0039503 to Chan et al. discloses a system for managing chronic disease and wellness online. The system of Chan et al. acquires and collects data related to a health condition (e.g., diabetes, cardiovascular disease, hypertension, etc.) and makes physician-like recommendations based on the available data. Thus, this system endeavors to provide an automated type of health care to reduce the cost and time spent by a physician treating the patient. However, this system does not necessarily obtain all of the pre-existing medical records of the patient or even ensure that the result of the present treatments will be unified with pre-existing records of the patient.

U.S. Pat. No. 5,660,176 to Iliff discloses a computerized medical diagnostic and treatment advice system for giving medical advice to the general public over a telephone network. The patient interacts either by touch tone response to questions, or via program loaded into PC. Hierarchical staffing is required to support this system. A goal is to bring together high-qualified medical experts, encode their knowledge in a central location, and make it available to everyone. However, there are continuing needs for centralizing medical knowledge and making it more generally available to the public in a less costly manner.

U.S. Patent Application Publication No. 2007/0168228 A1 to Lawless discloses an integrated prescription management and compliance system that provides user-specific prescription data and makes it available to users through a personalized account and as part of a wireless prescription reminder service. The user account is stored in a database within a secondary database system. The secondary database system calculates evenly spaced daily prescription taking times. A user interface allows users to customize the prescription taking times, so that they can change them from the ones calculated by the secondary database system.

There is a continuing need for health care systems that are flexible to keep up with changes in a patient's life including geographic changes in residency, changes in medical providers, changes in third party payers, physical changes in the primary location in which a patient's medical records are kept, etc. In addition, trying to keep records together for multiple family members adds to the complexity of communicating with multiple provider's office and different record-keeping systems.

There are continuing needs for digitizing and integrating patient medical records to make them more complete and reliable.

There are continuing needs for reducing the costs of record keeping and record management, such as by simplifying techniques for establishing records as well as for distributing them to locations where they need to be properly stored, and ways for facilitating secure storage while reducing costs.

There are continuing needs for cost-effectively providing solutions for easier access to a patient's medical records by the patient.

There are continuing needs for the provision of solutions for recording and transcribing conversations between a patient and a health care professional, between healthcare professionals, etc.

There are continuing needs for more effective solutions for integrating new medical records into an existing medical record going forward.

There are continuing needs for solutions for automatically editing medical transcriptions, such as in the preparation of patient visit notes.

There are continuing needs for the capability of accessing web-based medical treatment data specific to those of a community that the patient lives in, to those in a zip code that the patient lives in and/or to the individual patient, and preparing a customized treatment plan for a patient that has already been diagnosed, as well as for the patient that has not yet been diagnosed, but has symptoms, customized according to the web-based medical treatment data accessed.

There is a continuing need for the capability of crowd sourcing of anonymous medical treatment data; updating of a customized treatment plan based on the anonymous medical treatment data; and sending or outputting the updated, customized treatment plan to at least one of the patient and physician.

There is a continuing need for solutions that relieve/reduce the burden of inputting new records by care providers, in order to free up care providers' time to spend more of it with the patients.

There is a continuing need for solutions that facilitate reduction of medical errors.

These and other needs are met by the present invention as set forth in the following detailed description and claims.

### SUMMARY OF THE INVENTION

In one aspect of the present invention, a computer readable medium including one or more sequences of instructions for performing mobile medical information management, wherein execution of the one or more sequences of instructions by one or more processors of a mobile medical computing device causes the mobile medical computing device to perform a process comprising: accessing one or more web-based patient portals and downloading medical history records of the patient from the one or more web-based portals, based upon a user profile including personal information that uniquely identifies the patient; and outputting data from the downloaded medical history to at least one of the patient and a physician or other authorized care provider treating or evaluating the patient.

In at least one embodiment, the mobile medical computing device, when executing the computer readable medium, records a conversation between the user and the physician or other authorized care provider, when the user is a patient, or between the user and a patient when the user is the physician or other authorized care provider, for later review by the user.

In at least one embodiment, instructions are provided, which, when executed by the mobile medical computing device, cause the device to: automatically transcribe the recorded conversation for outputting a transcribed version of the recorded conversation.

In at least one embodiment, instructions are provided, which, when executed by the mobile medical computing device, cause the device to perform a process comprising: outputting the transcribed recording, wherein said outputting comprises at least one of: printing the transcribed recording; providing voice recognition highlight of a chief complaint by the patient during the conversation; automatically incorporating the transcribed recording into the physician's or other authorized care provider's electronic medical record regarding the patient; automatically incorporating the transcribed recording into the patients electronic medical record stored in the mobile medical computing device; automatically electronically sending the transcribed recording over the internet or by wireless text transmission to another database of the patient, into the patients electronic medical record stored in the mobile medical computing device; automatically electronically sending the transcribed recording over the internet or by wireless text transmission to another physician's or other authorized care provider's electronic medical record regarding the patient and automatically incorporating the transcribed recording into the other physician's or other authorized care provider's electronic medical record regarding the patient.

In at least one embodiment, instructions are provided, which, when executed by the mobile medical computing device, cause the device to perform a process comprising: automatically editing the transcription, thereby creating a detailed visit note meeting requirements for transmitting to an insurer or another provider.

In at least one embodiment, instructions are provided, which, when executed by the mobile medical computing device, cause the device to perform a process comprising: accessing web-based medical treatment data; and preparing a customized treatment plan, customized according to the web-based medical treatment data accessed.

In at least one embodiment, the customized treatment plan is a Smart Treatment Plan.

In at least one embodiment, the customized treatment plan is a Symptom Relief Plan.

In at least one embodiment, relative weighting values of symptoms are provided in the customized treatment plan.

In at least one embodiment, the relative weighting values of symptoms are used to assign differential diagnoses.

In at least one embodiment, the treatment plan identifies diagnostic tests applicable to symptoms identified in the custom treatment plan.

In at least one embodiment, the treatment plan identifies emerging developments in treating a diagnosis or symptom identified in the custom treatment plan.

In at least one embodiment, the treatment plan provides facts learned in prior cases and/or research applicable to attending to a diagnosis or symptom identified in the custom treatment plan.

In at least one embodiment, the treatment plan identifies a surgical procedure applicable to a symptom or diagnosis identified in the custom treatment plan.

In at least one embodiment, the treatment plan identifies additional resources that can be accessed online to read further information applicable to an item identified in the custom treatment plan.

In at least one embodiment, the treatment plan identifies at least one medication applicable to at least one symptom identified in the custom treatment plan.

In at least one embodiment, the treatment plan identifies at least one home remedy applicable to at least one symptom identified in the custom treatment plan.

In at least one embodiment, the web-based medical treatment data is specific to an identified community of users.

In at least one embodiment, the web-based medical treatment data is specific to a zip code.

In at least one embodiment, the web-based medical treatment data is specific to the patient.

In at least one embodiment, instructions are provided, which, when executed by the mobile medical computing device, cause the device to perform a process comprising: sending or outputting the customized treatment plan to at least one of the patient and physician or other authorized care provider.

In at least one embodiment, instructions are provided, which, when executed by the mobile medical computing device, cause the device to perform a process comprising: crowd sourcing of anonymous medical treatment data; updating of the customized treatment plan based on the anonymous medical treatment data; and sending or outputting the updated, customized treatment plan to at least one of the patient and physician or other authorized care provider.

In at least one embodiment, the updating comprises real-time updating and wherein the sending or outputting occurs immediately after performing the real-time updating.

In at least one embodiment, instructions are provided, which, when executed by the mobile medical computing device, cause the device to perform a process comprising: record, for playback as a voice memo, a hospital discharge summary and follow-up care recommendations.

In at least one embodiment, instructions are provided, which, when executed by the mobile medical computing device, cause the device to automatically transcribe the hospital discharge summary and follow-up care recommendations to a text file.

In at least one embodiment, instructions are provided, which, when executed by the mobile medical computing device, cause the device to perform at least one of: automatically electronically storing the text file into the mobile medical computing device on which the voice memo is recorded; sending the text file over the internet or by wireless text transmission to another database of the patient, into the patient's electronic medical record stored in the mobile medical computing device; automatically electronically sending the text file over the internet or by wireless text transmission to the physician's or other authorized care provider's electronic medical record regarding the patient and automatically incorporating the text file into the physician's or other authorized care provider's electronic medical record regarding the patient; or automatically electronically sending the text file over the internet or by wireless text transmission to another physician's or other authorized care provider's electronic medical record regarding the patient and automatically incorporating the text file into the other physician's or other authorized care provider's electronic medical record regarding the patient.

In at least one embodiment, instructions are provided, which, when executed by the mobile medical computing device, cause the device to perform a process comprising: receiving data specific to the patient in regard to the treatment plan; analyzing the data specific to the patient relative to at least one of: the treatment plan, data specific to at least one other patient, or statistics calculated from data specific to a plurality of other patients; and sending an alert to the patient when a non-conforming treatment is determined by the analyzing.

In at least one embodiment, instructions are provided, which, when executed by the mobile medical computing device, cause the device to perform a process comprising: locating a nearby pharmacy having a needed medication and which is currently open for business.

In at least one embodiment, instructions are provided, which, when executed by the mobile medical computing device, cause the device to perform a process comprising locating an expert-approved vendor or provider.

In at least one embodiment, instructions are provided, which, when executed by the mobile medical computing device, cause the device to perform a process comprising providing a custom-designed drug database specific to the patient's needs, wherein the custom-designed drug database includes expert-curated content.

In at least one embodiment, the custom-designed drug database lists top three side effects for each of at least one drug listed in the database, wherein the top three side effects are determined by experts in a field of use for which each the at least one drug is prescribed.

In at least one embodiment, instructions are provided, which, when executed by the mobile medical computing device, cause the device to perform a process comprising calculating a pediatric dosage from an adult dosage provided to the mobile medical computing device.

In at least one embodiment, instructions are provided, which, when executed by the mobile medical computing device, cause the device to perform a process comprising: updating a patient's drug regimen by the physician or other authorized care provider; and sending the updated drug regimen to the mobile medical computing device of the patient.

In at least one embodiment, the sending includes at least one of sending a graphical image of each drug to be discontinued, or sending a graphical image of each drug to be used in an initiated drug treatment.

In at least one embodiment, instructions are provided, which, when executed by the mobile medical computing device, cause the device to perform a process comprising: accessing the profile of the user; and performing at least one of playing one or more voice memos stored in the profile; displaying at least one pop-up window; displaying at least one calendar reminder; and displaying at least one multi-dimensional graph.

In at least one embodiment, instructions are provided, which, when executed by the mobile medical computing device, cause the device to perform a process comprising providing a key checklist of items to be performed by a physician or other authorized care provider when treating a patient according to a treatment plan.

In at least one embodiment, the checklist serves as a learning tool or reminder for a medical student.

In at least one embodiment, instructions are provided, which, when executed by the mobile medical computing device, cause the device to perform a process comprising providing a key checklist of items to be performed by a patient when being treated according to a treatment plan.

In at least one embodiment, instructions are provided, which, when executed by the mobile medical computing device, cause the device to perform a process comprising: accessing negotiated reduced prices for preferred health care products from web-based information source; and displaying the negotiated reduced prices for viewing by the user.

In at least one embodiment, instructions are provided, which, when executed by the mobile medical computing device, cause the device to perform a process comprising allowing anonymous diagnosis groups to share strategies for care and/or resources.

In at least one embodiment, instructions are provided, which, executed by the mobile medical computing device, cause the device to perform a process comprising sending a secure text message to another mobile medical computing device running the computer readable medium, wherein the secure text message can be sent from a patient to the physician or other authorized care provider, from the physician or other authorized care provider to the patient, from the physician or other authorized care provider to one or more other physicians or other authorized care providers, or point-to-multipoint from any one of the patient or other authorized care provider, physician or other authorized care provider and other physicians or other authorized care providers to more than one of the patient or other authorized care provider, physician and other physicians or other authorized care providers.

In at least one embodiment, instructions are provided, which, when executed by the mobile medical computing device, cause the device to perform a process comprising identifying a nearby provider that performs a recommended procedure in-office.

In at least one embodiment, instructions are provided, which, when executed by the mobile medical computing device, cause the device to perform a process comprising: displaying a current pillbox feature including graphical displays of each pill currently being taken by a patient.

In at least one embodiment, instructions are provided, which, when executed by the mobile medical computing device, cause the device to perform a process comprising displaying an updated pillbox feature highlighting pills that have been added and/or deleted from a previously current pillbox.

In at least one embodiment, instructions are provided, which, when executed by the mobile medical computing device, cause the device to perform a process comprising: recording locations of physician or other authorized care provider and pharmacy visits, using a global positioning satellite access feature of the mobile medical computing device; and creating a centralized database regarding local care resources from the recorded locations.

In at least one embodiment, instructions are provided, which, when executed by the mobile medical computing device, cause the device to perform a process comprising: receiving inputted information from the patient regarding severity of symptoms on a repeated basis; tracking the inputted information, relative to stored parameters chosen by at least one of the patient and the physician or other authorized care provider; and identifying improvement and/or worsening of one or more of the symptoms.

In at least one embodiment, instructions are provided, which, when executed by the mobile medical computing device, cause the device to perform a process comprising displaying and/or audibly reminding the patient of at least one of: a scheduled physician's or other authorized care provider's appointment, a need to make a physician's or other authorized care provider's appointment, a time to take a medication, or a need to refill a prescription.

In at least one embodiment, instructions are provided, which, when executed by the mobile medical computing device, cause the device to perform a process comprising: logging a date and time of a telephone call between the patient and the physician or other authorized care provider; and downloading or sending the date and time to an electronic medical record of the physician or other authorized care provider for the patient.

In at least one embodiment, instructions are provided, which, when executed by the mobile medical computing device, cause the device to perform a process comprising: tracking duration of existence of one or more of the symptoms; and sending, displaying or audibly playing a reminder to make a physician's or other authorized care provider's appointment when the duration exceeds a predetermined time.

In at least one embodiment, instructions are provided, which, when executed by the mobile medical computing device, cause the device to perform a process comprising receiving updates for treatment resulting from a web-based survey tool that can be accessed by selected physicians or other authorized care providers to provide best practices data, wherein the best practices data includes one or more of: knowledge that the selected physicians or other authorized care providers have learned that can prevent misdiagnosis or poor treatment outcomes; differential diagnoses that are often linked with a diagnosis at issue; side-effects of medications observed in the selected physicians' or other authorized care providers' practices; home remedies useful in treatment of the diagnosis at issue; home remedies that improve overall quality of life; or resources for patients and families to assist in self-care.

In another aspect of the present invention, a method of providing and updating medical care information is provided, including: providing a web-based survey tool that can be accessed by selected physicians to provide best practices data, wherein the best practices data includes one or more of: knowledge that the selected physicians or other authorized care providers have learned that can prevent misdiagnosis or poor treatment outcomes; differential diagnoses that are often linked with a diagnosis at issue; side-effects of medications observed in the selected physicians' or other authorized care providers' practices; home remedies useful in treatment of the diagnosis at issue; home remedies that improve overall quality of life; or resources for patients and families to assist in self-care; downloading results received from one or more of the selected physicians or other authorized care providers having accessed the web-based survey tool and inputted the best practices data; editing the downloaded results and creating updated data; and sending the updated data to a mobile medical computing device.

In at least one embodiment, the editing includes data mining the downloaded results and the updated data includes at least one graphical representation generated using mined data resulting from the data mining.

In at least one embodiment, the sending the updated data comprises sending an application software update to the mobile medical computing device for updating application software executing on the mobile medical computing device.

In at least one embodiment, the updated data, when executed on the mobile medical computing device, displays a series of screen images and textual information and/or voice data relating to the screen images, describing a logical information flow of a standard physician's or other authorized care provider's office visit.

In another aspect of the present invention, a mobile medical care and information system is provided, including: a mobile medical computing device comprising at least one processor; and programming which, when executed by the at least one processor, performs a process including: accessing one or more web-based patient portals and downloading medical history records of a patient from the one or more web-based portals, based upon a user profile including personal information that uniquely identifies the patient; and outputting data from the downloaded medical history to at least one of the patient and a physician or other authorized care provider treating or evaluating the patient.

In another aspect of the present invention, a method of facilitating medical care and information is provided that includes: providing a mobile medical computing device; recording a conversation between a user of the device and a doctor, when the user is a patient, or between the user of the device and a patient or other medical healthcare professional when the user is a doctor, for later review by the user; and automatically transcribing the recorded conversation for outputting a transcribed version of the recorded conversation.

These and other features of the invention will become apparent to those persons skilled in the art upon reading the details of the systems, methods and computer readable media as more fully described below.

### BRIEF DESCRIPTION OF THE DRAWINGS

FIG. 1 illustrates a mobile medical care device according to an embodiment of the present invention.

FIG. 2 illustrates a display for the HealthMap tool according to an embodiment of the present invention.

FIG. 3 illustrates an editing screen for the HealthMap tool in which a user may add or delete categories, according to an embodiment of the present invention.

FIG. 4 illustrates navigation of the disease, symptom or ailment selector to select “Sinusitis”, according to an embodiment of the present invention.

FIG. 5A shows results of the HealthMap search having been executed for Doctors and Pharmacies in the zip code 94117, according to an embodiment of the present invention.

FIG. 5B shows a map view of the data from FIG. 5A.

FIG. 6A shows an initial screen of the MyProfile or Profile tool, according to an embodiment of the present invention.

FIGS. 6B-6D are screens illustrating initial set up of information in the profile tool according to an embodiment of the present invention.

FIG. 7A illustrates a screen for initial entry of medication, conditions and allergies, according to an embodiment of the present invention.

FIG. 7B shows an example of a portion of a drop down list according to an embodiment of the present invention.

FIG. 8 illustrates a Profile” or “MyProfile” screen of a user according to an embodiment of the present invention.

FIG. 9 shows an initial screen display for a “Track and Treat” tool according to an embodiment of the present invention.

FIG. 10A shows a screen that is displayed as a result of selecting on “Sinusitis” in FIG. 9.

FIG. 10B illustrates a notes section according to an embodiment of the present invention.

FIG. 10C illustrates a screen used for editing the notes section of FIG. 10B.

FIG. 10D illustrates the notes section having been edited according to an embodiment of the present invention.

FIG. 10E shows an alternative Track and Treat display that integrates relevant medical information about family members of the patient user, according to an embodiment of the present invention.

FIG. 10F illustrates a Diagnosis Details screen according to an embodiment of the present invention.

FIG. 10G illustrates a treatment details screen according to an embodiment of the present invention.

FIG. 10H illustrates a diagnosis details screen according to an embodiment of the present invention.

FIG. 10I illustrates comments and a full list of symptoms having been collapsed to a single line according to an embodiment of the present invention.

FIG. 10J illustrates a list of specific treatments that are selectable for use in a treatment plan according to an embodiment of the present invention.

FIG. 10K illustrates specific treatments having been selected in FIG. 10J.

FIGS. 10L-10O illustrate screens and a tool used to enter a physician's appointment into a device according to an embodiment of the present invention.

FIG. 11 shows a Track and Treat editing screen 190 that is displayed upon selecting on the edit button in FIG. 10 according to an embodiment of the present invention.

FIG. 12A illustrates a “New Diagnosis” display screen that can be displayed, using a Track and Treat tool according to an embodiment of the present invention.

FIGS. 12B-12D illustrate an alternative embodiment of an interface for a new diagnosis function according to an embodiment of the present invention.

FIG. 13 illustrates a detailed new diagnosis screen according to an embodiment of the present invention.

FIG. 14 shows a medication details screen according to an embodiment of the present invention.

FIG. 15A shows a “new symptom” screen according to an embodiment of the present invention.

FIGS. 15B-15C illustrate use of a device to perform a function for adding a new symptom from the diagnosis details screen for tracking according to an embodiment of the present invention.

FIGS. 15D-15F illustrate various embodiments of reminder screens that may be displayed according to the present invention.

FIGS. 16A-18B show details displayed by the Pillbox tool according to an embodiment of the present invention.

FIG. 19 shows a display screen for recommended doctors for a selected diagnosis, according to an embodiment of the present invention.

FIG. 20A illustrates a reminder display that pops up and is displayed according to an embodiment of the present invention.

FIG. 20B shows a display for use by user to input severity of a symptom or diagnosis experienced, according to an embodiment of the present invention.

FIG. 21A schematically illustrates a system according to an embodiment of the present invention.

FIG. 21B illustrates a portion of a survey that is providable to a selected physician according to an embodiment of the present invention.

FIG. 22 illustrates a data model depicting various data objects used in the software according to an embodiment of the present invention.

FIGS. 23A-23B are data models describing an example of information based on the logical information flow of a standard physician's office visit according to an embodiment of the present invention.

FIG. 24 is a flow chart illustrating events that may be carried out according to an embodiment of the present invention.

FIG. 25 illustrates a flow chart of events that may be carried out according to an embodiment of the present invention to record a conversation.

FIG. 26 is a flow chart illustrating events that may be carried out according to an embodiment of the present invention in providing a customized treatment plan.

FIGS. 27A-27F illustrate excerpts from a customized treatment plan according to an embodiment of the present invention.

FIGS. 28A-28C are exemplary screen shots of displays outputted from data contained in a database for the customized treatment plan described above with regard to FIGS. 27A-27F.

FIG. 29 illustrates a typical computer system in accordance with an embodiment of the present invention.

FIG. 30 illustrates display of a two-dimensional graph according to an embodiment of the present invention.

### DETAILED DESCRIPTION OF THE INVENTION

Before the present systems, methods and computer readable media are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a user” includes a plurality of such users and reference to “the device” includes reference to one or more devices and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Definitions

A “Custom Treatment Plan” or “Customized Treatment Plan”, both of which are synonymous with a “Smart Treatment Plan”, is generated by a data model of the present invention when a user inputs data into a profile. A “Generic Treatment Plan” provided by the data model is adjusted based on factors which may include, but are not limited to: age, gender, existing medical conditions (also known as “co-morbidities”), allergies, medication use, and/or previous surgeries.

A “Smart Treatment Plan”, synonymous with “Customized Treatment Plan” is a custom treatment plan provided to a user when a user has a diagnosis that is to be treated, and has input (or had someone else input on his/her behalf) data into a profile. When the user inputs the profile information and taps the “Generate a Smart Treatment Plan” or “Generate a Customized Treatment Plan” button, a Smart Treatment Plan/Customized Treatment Plan is generated.

A “Symptom Relief Plan” is a custom treatment plan provided to a user that has not yet obtained a diagnosis.

The term “expert-curated content”, as used herein, refers to guidelines and recommendations that are peer-reviewed by leading practitioners in the pertinent field or fields of medicine.

The term “expert”, as used herein, may refer to a board-certified medical professional who is recognized by his or her peers as a leader in treatment of a group of diagnoses.

“Black-Box Warning”, as used herein, refers to a warning required by the Food and Drug Administration (FDA) when a medication has a significant risk of morbidity or mortality. The term derives from a black box that is required to be displayed surrounding a text warning in the prescribing information for the medication.

The present invention provides mobile solutions for streamlining medical care information. In at least one embodiment, reduction of medical error is achieved by reducing complexity. Examples of reduction of complexity achieved by the present invention include, but are not limited to: recommending fewer but best choices for treatments; providing key checklists for patients and physicians; improving sensory (visual/auditory) recognition of medical care items/plans (medications, products, protocols, etc.) at the time and place of purchase/procedure and/or use.

In another aspect, the present invention can serve as an important learning tool, such as by functioning as a tool for medical students, such as a study aid and/or practice guide that provides checklists, etc.

In at least one embodiment, the present invention will facilitate the improvement of the health care economy by: reducing unnecessary visits to primary care providers and specialists with home and over-the-counter remedy guides; providing negotiated reduced prices for preferred health care products, and allowing anonymous diagnosis groups to share strategies in their community for care and resources.

In at least one embodiment, the present invention provides custom-written treatment plans that: improve medical record-keeping for both patient and provider; are informed by the best practices and positive health outcomes of patients (data/success informs practice—closes the feedback loop), collect data on the population to community, zip code and individual level, to improve compliance and refine subsequent treatment plans, perform real-time updates from crowd sourcing of anonymous data—also providing alerts to patients for non-conforming treatment recommendations by zip codes based simply on treatment plans and then, ultimately, with phone application generated data, and/or link to a custom designed drug database with expert-curated content, and patient-friendly information.

In another aspect, the present invention provides a custom-designed user-friendly graphical interface. In at least one embodiment, the present invention incorporates a custom-built drug database. Simplified lists of (which may be, but not necessarily are limited to “Top Three”) side effects of concern may be displayed, as determined by experts in the field. Concise, easy to read and understand, instructions are provided for the patient and prescribing physician. In at least one embodiment, a built-in calculator for determining pediatric dosages is provided. In at least one embodiment, the present invention provides a comparison of medication options based on cost to the patient.

In at least one embodiment, the present invention provides secure text-messaging capabilities for communication between patient and provider. In at least one embodiment, the present invention provides a function for secure text-messaging reminders for medications and other treatment recommendations to be sent to the patient to facilitate improving patient compliance with drug treatments and other treatment recommendations.

In at least one embodiment, the present invention may integrate health map features that include information such as locations of nearby expert-approved vendors and providers. Additionally, a feature may be included for finding a nearby provider that performs a recommended procedure in-office, and/or for locating a nearby pharmacy that has a needed medication in stock, and is currently open.

In at least one embodiment, the graphical interface may include a “current pillbox” and an “updated pillbox” graphical interface, each of which may include images of tablets, capsules and other dosage forms, to alleviate issues with drug reconciliation by the patient by simplifying identification of drugs and drug forms. A care provider can update a drug regimen, including a graphical depiction of which pills to discontinue and/or add. A smart photo feature may be provided where the user can take a photo of the medication in pill form, using a smartphone device configured according to an embodiment of the present invention, at which time the application searches a drug database for matching images and display a list of results; the user can select that result that matches the image of the pill, and the description of the drug on the pill bottle label, and that information, along with dosing instructions, is added to the users pillbox; a pill bottle barcode reader may be provided, and/or a feature for voice recognition of the patient reading bottle label information into the phone may be provided to record: medication name (which is incorporated into the updated pillbox feature), fill date and number of doses (this information is incorporated into calendar reminders), pharmacy (this information may optionally be used to interface with the pharmacy), prescribing physician information (this information is incorporated into the ‘My Doctors’ feature), image (preferably a picture, but alternatively, other graphical representation that looks like the picture) of the medication dosage form (preferably a color picture), image (preferably a color picture) of the dosage form (this information is incorporated into the updated pillbox feature), and/or medication bottle barcode. Any changes to the pillbox are logged in the application in summary form so that: a) a user can see what they have started/stopped taking and note any changes in doses, and b) a provider can review this information and can confirm with the user that they stopped taking a medication as instructed and/or started taking a medication as instructed.

In another aspect of the present invention, voice memo features are provided, which may optionally be included in the “My Profile” section of the application. Voice memo features that may be provided include, but are not necessarily limited to: a feature for recording a conversation between a physician and a patient so that the patient can later play back the recording to review it a feature that automatically transcribes a recorded conversation to provide a readable copy that the patient can show to other care providers, a feature that automatically transcribes a recorded conversation, that includes a voice recognition feature that highlights the chief complaint, diagnosis and treatment plan, a feature that automatically transcribes a recorded conversation and automatically incorporates the transcribed conversation record into the physician's electronic medical record (EMR) for that patient, so that the physician spends less time typing, and more time talking with the patient, a feature that automatically transcribes a recorded conversation with a “smart-editing” feature that automatically creates a detailed visit note for transmission to an insurer or another provider, and/or a feature that automatically transcribes a recorded conversation into a hospital discharge summary and follow-up care in voice memo form, that can be converted to a text file for transmission to primary care provider.

In another aspect, the present invention logs phone calls between a physician and patient and the dates and times of the phone call may be automatically or manually downloaded into the patient's electronic medical record (EMR) maintained by the physician's office/hospital as well as in the patient's mobile medical device.

In another aspect, the present invention is configured to extract patient data from web-based patient portals into the patient's mobile medical device. As a result, the patient is able to carry medical history, pulled from multiple providers, in the patient's mobile device.

In another aspect, the present invention provides the patient the capability to send data from the patient's mobile medical device to a physician's EMR for that patient, thereby enabling a rapid, accurate, transfer of full medical history and current treatments, providing a tremendous increase in simplicity for Accountable Care Organizations (ACO's).

In another aspect of the present invention, a feature may be provided that uses a global satellite positioning (UPS) function for recording doctor and pharmacy visits to facilitate accurate recording of doctor contact information, which can be particularly useful in an emergency care setting.

In another aspect, the present invention consolidates information on local care resources and creates a centralized database with graphical information regarding what sort of resources are available to physicians and patients.

Reminder and tracking features are provided in at least one embodiment of the present invention, and may include, but are not limited to: a symptom tracking feature (“Track & Treat”), wherein a user is prompted to input the severity of his/her symptoms on a regular basis, so that this data can then be tracked relative to other parameters, as chosen by the doctor and patient, to identify what factors improve or worsen symptoms; providing automated reminders to schedule physician's appointments; providing automated reminders of physician's appointments that have already been scheduled; reminders, synched with pillbox data, to take medication; reminders, synched with pillbox data, that prescriptions need to be refilled; tracking of symptom duration, and/or reminders to see a physician after a predetermined time has passed during which a symptom persists.

In at least one embodiment, events created within the mobile device of the present invention are automatically synched with a calendar within the device.

In at least one embodiment, a survey feature is incorporated into a database of the invention. A web-based survey tool can be accessed by selected physicians to obtain their ‘best-practices’ data. For example, the survey may be designed to solicit: knowledge that physicians have learned that could prevent misdiagnosis or poor treatment outcomes; differential diagnoses that are often linked with the diagnosis in question; side-effects of medications observed in their practice; home remedies useful in the treatment of the diagnosis in question; home remedies that improve overall quality of life; and/or resources for patients and families to help them participate in their own care, but the survey is not limited to these items.

In one aspect of the present invention, survey results are automatically downloaded into an intermediate server, which can be accessed by administrators for updates, queries and editing. Upgrades to the intermediate database can be rolled-out in the form of application updates for the application running on the mobile device according to an embodiment of the present invention.

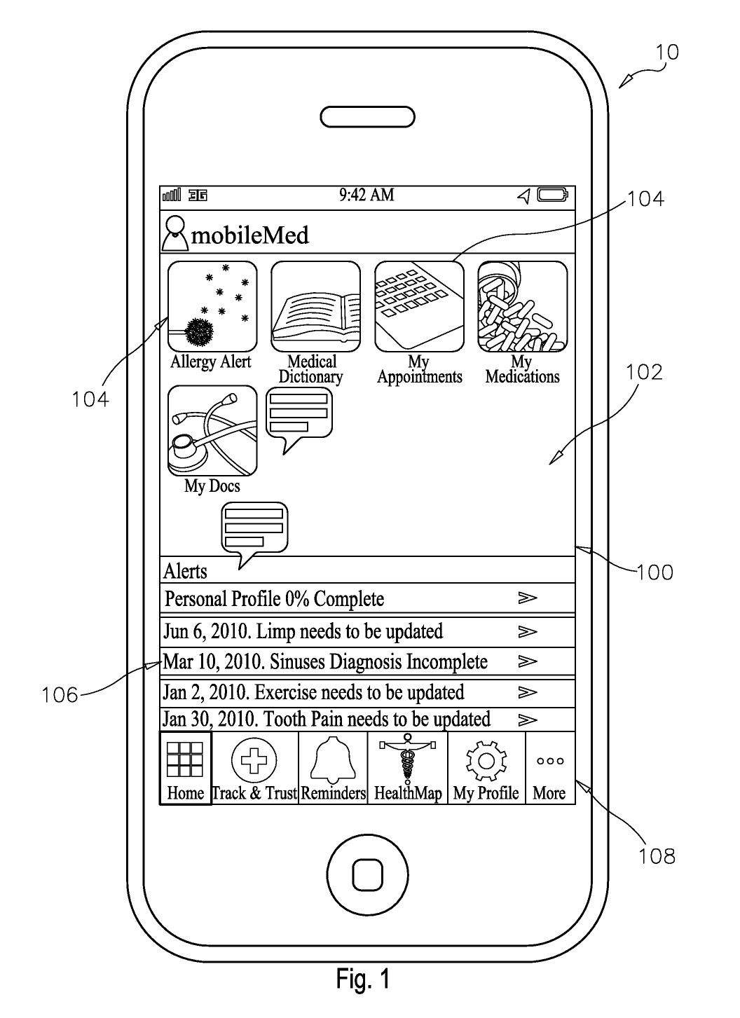

Referring now to FIG. 1, a mobile medical care device 10 according to an embodiment of the present invention is illustrated. Device 10 is provided with and configured to execute mobile medical care applications according to the present invention. Device 10 is preferably a smartphone, such as an APPLE IPHONE, smartphone operating ANDROID (Google, Inc.) operating system, BLACKBERRY smartphone, PALM (Hewlett Packard) smartphone or any other of the numerous smartphones available that are capable of not only placing and receiving telephone calls wirelessly, but are also web-enabled (capable of accessing the Internet) and capable of functioning as a portable computer. It is further noted that the present invention can be operated on other handheld computing devices, such as APPLE IPAD or other tablet computer, APPLE ITOUCH, personal digital assistants (PDA's), although some of the functions requiring wireless telephone functions may not be possible to be executed, unless the PDA is provided with software allowing it to place and receive telephone calls over the Internet (e.g., SKYPE, or the like). Likewise, a laptop or table computer may be configured to function, similarly to a PDA as described above, although it would be much more to cumbersome and therefore less likely to be omnipresent with the user when needed for the various functions described herein. Still further, even a non-mobile computer such as a desktop computer or the like may be configured to function similarly to the PDA or laptop, except that all the advantages of mobility would be lost and therefore the functionality would be extremely curtailed. For example, it would simply not be practical for a patient to take his/her desktop computer to a physician's office to record a conversation during an office visit. An advantage to using a desktop computer would be in situations where mobility is not a necessity ad then a full-size keyboard can be provided for easier data entry, especially for those who might have difficulty inputting information into a smartphone-sized device.

Device 10 is provided with a display screen 100 configured to display text and images. Device 10 is further provided with an input mechanism, such as a touch screen, keyboard, keypad, stylus, pen, or the like, so that a user can input information into the device 10 to be processed. Any and all of the other features provided in an IPHONE or other smartphone may also be provided in device 10. Device 10 is provided with application programming according to the present invention, that, when executed by device 10 enables device 10 to access one or more web-based patient portals (over the internet and/or wirelessly using WAP, CDMA or other cell phone platform) and download medical history records of a patient from the one or more web-based portals, based upon a user profile including personal information that uniquely identifies the patient. Thus, a patient, or an authorized physician or other health care provider can operate device 10 to gather all, or a select portion that the user has not flagged as “private”, of a patient's medical records and have them available and consolidated within device 10. Additional methods for downloading medical information include, but are not limited to: a “bump” application may be provided that allows sharing of selected information between smartphones that are in close proximity to each other; email selected from the application of the present invention; and/or physical docking and synchronizing a device 10 storing medical data with another device 10, laptop computer, desktop computer, etc.

Once downloaded, the medical records can be displayed on display screen 100 and/or transmitted to another health care provider or the patient. Additionally, the medical records can be relied upon for other functions described herein and/or edited according to other functions described herein.

FIG. 1 illustrates a home screen display 102 being displayed on display screen 100 of device 10. The home screen display shows icons 104 for various functions that can be performed by the application. Examples of such icons 104, as shown in FIG. 1, include, but are not limited to Allergy Alert (where a user can set a threshold value of pollen count, for example, that triggers a pop-up message when that threshold value has been exceeded, as the application can poll a source over the Internet to keep a relatively current pollen count value in the device 10), Medical Dictionary (provides direct access to one or more of a medical dictionary stored in memory of device 10 and/or one or more web-based medical dictionaries), My Appointments (described in more detail below), My Medications (described in more detail below), and My Doctors (described in more detail below.

Additionally, an Alerts section 106 of the display 102 provides dates and text messages regarding upcoming tasks that need to be completed by the user of device 10 and by what dates those tasks are scheduled to be completed.

Another section of the display 102 provides a tool tray 108 from which the user can navigate to various other displays dedicated to different functions of the application. Such functions include, but are not limited to those shown in FIG. 1, as the user can scroll to display additional functions.

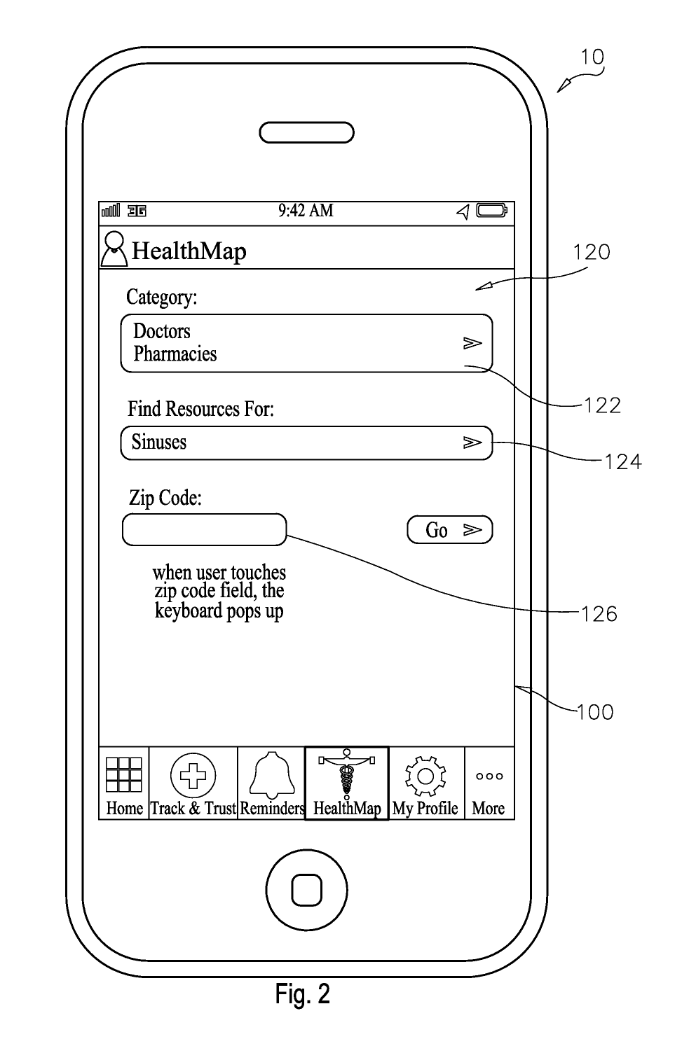

By selecting on the Healthmap icon in the tool tray 108 of FIG. 1, the HealthMap display 120 is displayed on the screen 100 as shown in FIG. 2. The HealthMap tool provides the user of device 10 with the ability to locate nearby pharmacies, physicians, hospitals, and other care providers and facilities, including, but not limited to emergency rooms, care nurses, medical supplies/equipment providers, support group locations, etc. The HealthMap data and resulting displays of locations and descriptions of those locations can be filtered by category (e.g., type of health care provider, such as physician, pharmacy, etc.), disease, symptom or ailment, and localized by zip code. Thus, for example, in FIG. 2 the user has selected both Doctors (physicians) and pharmacies in the category selector 122 and “sinusitis” in the disease, symptom or ailment selector 124. The zip code can be entered in by the user. In the example shown in FIG. 2, when the user touches the zip code selector 126, a keyboard pops up to allow the user to enter the zip code. Alternatively, a hard key pad or other interface may be provided for entry of the zip code numbers. Accordingly, the HealthMap tool can be used, for example to locate a nearby pharmacy having a medication that is needed by the user. The tool may include information as to operating hours of the pharmacy(ies) located. By comparing these times to the clock function of device 10, HealthMap tool can filter out those facilities that are not currently open. Alternatively, since device 10 is web-enabled, HealthMap tool can access web pages of the facilities identified to determine whether or not they are currently open. As another non-limiting example, HealthMap tool can be used to locate a particular vendor or health care provider. Additionally, the database used by HealthMap tool may be provided with metadata indicating which providers and vendors are expert-approved and the HealthMap tool can be operated to filter out those that are not expert-approved, to thereby display results of only expert-approved vendors and/or providers. As another non-limiting example, a nearby provider that performs a recommended procedure in-office may be identified using the HealthMap tool.

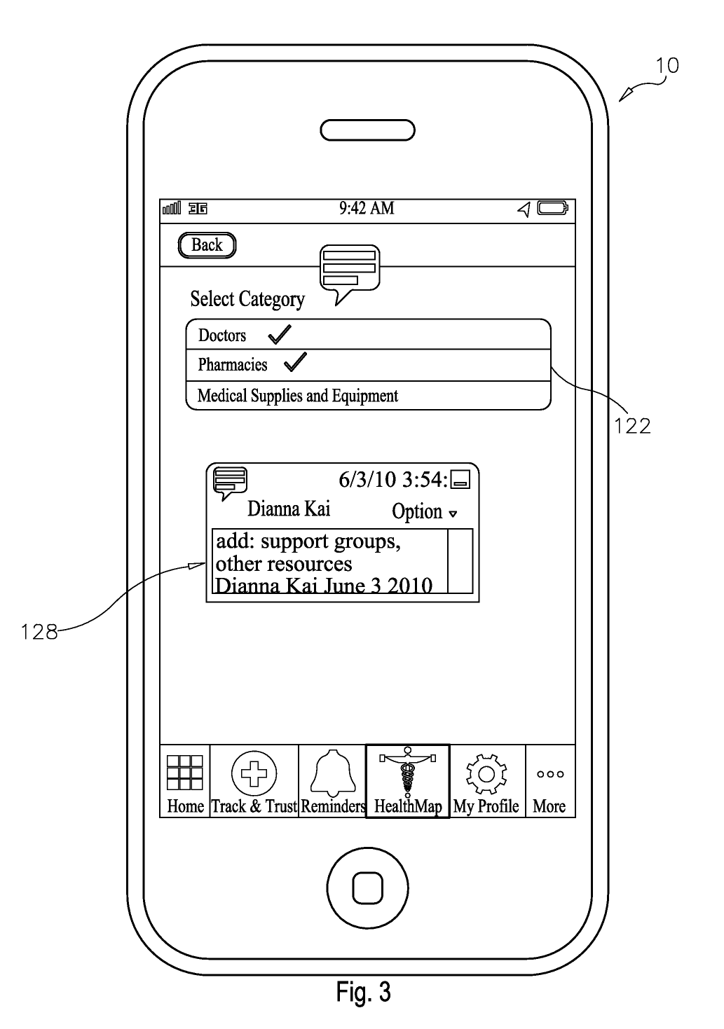

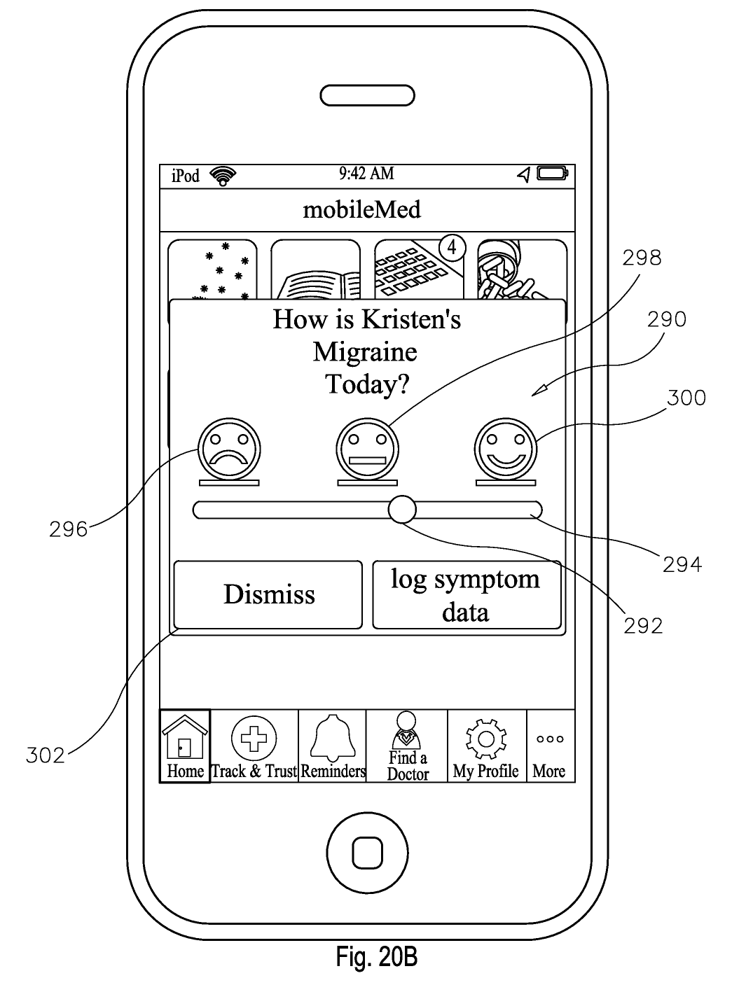

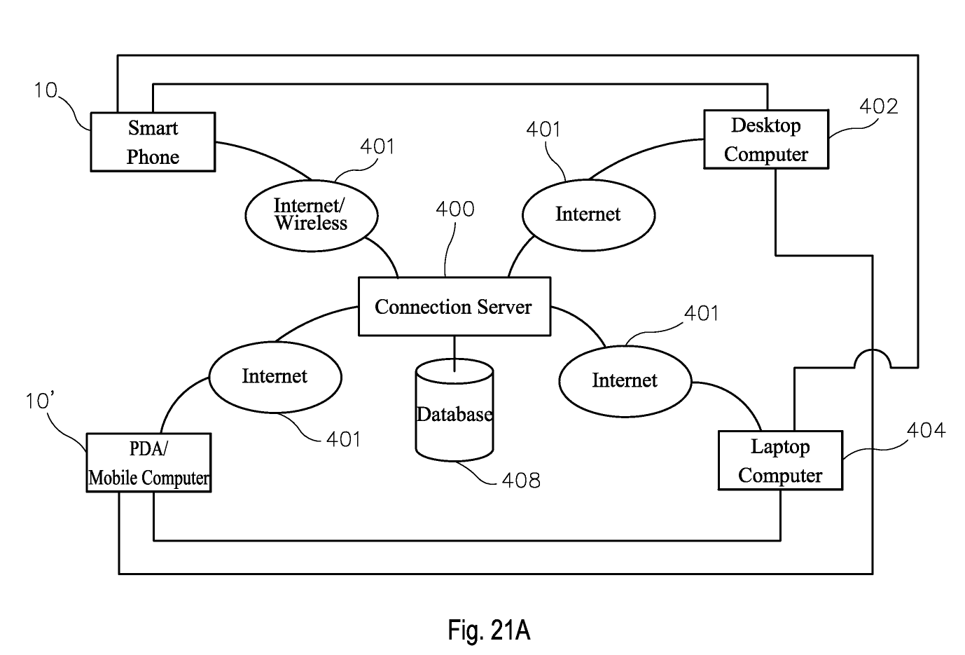

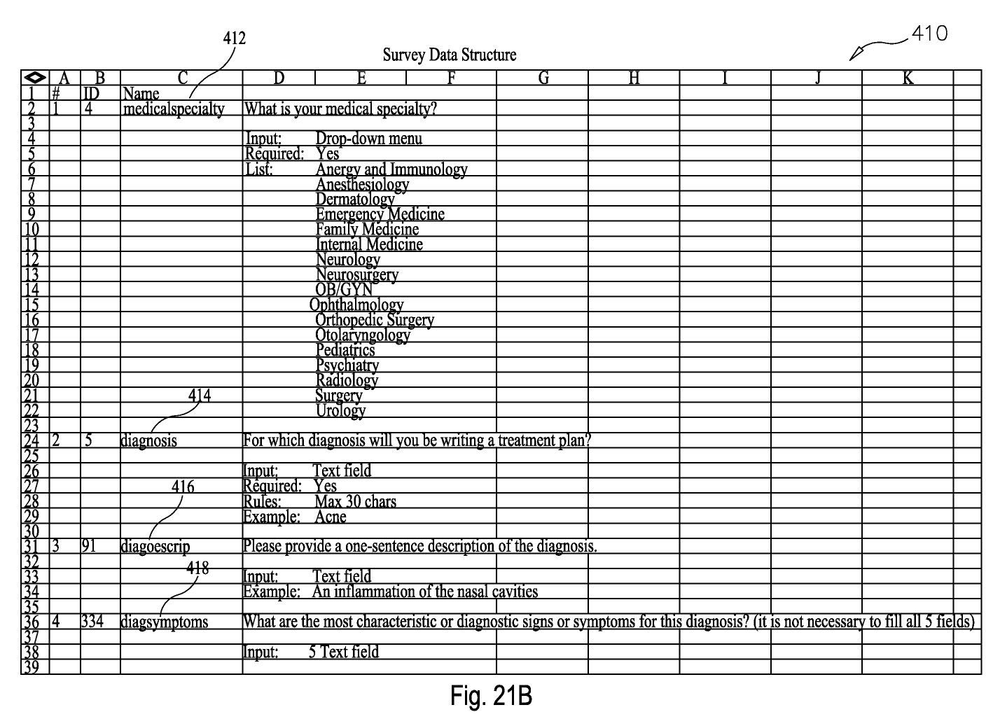

FIG. 3 illustrates an editing screen for the HealthMap tool in which a user may add or delete categories into the category selector 122. Likewise, the user may add or delete entries from the “Selected Diagnosis or Symptoms” 124 in order to find resources for an entry selected from this feature. Further in this regard, in cases where device 10 is provided with a global positioning satellite (UPS) locator, a user can use the GPS locator function in connection with the HealthMap tool to record a location of a physician or other healthcare provider that the user happens to be visiting, by operating these tools when at that location. As a result, the location of this provider is automatically added to the HealthMap under the appropriate category. The name of the particular healthcare provider may be automatically populated if that provider is already registered in the mobile medical care system of the present invention. Alternatively, the user can manually enter the name of the provider for the location that is automatically populated into the HealthMap. However, data added by the user is flagged as such by the present invention, and is separated from system approved content. In this way, the present invention can add to (or create from scratch) a centralized database regarding local care resources from the recorded locations. Additionally, a server may be provided that communicates with devices 10. Server 400 (e.g., see FIG. 21A) can combine the local care resources recorded by individual users on device 10 using the GPS and HealthMap tools, and combine this data to form a centralized database 408 that can be accessed by any user of a device 10 searching for providers in a particular zip code.

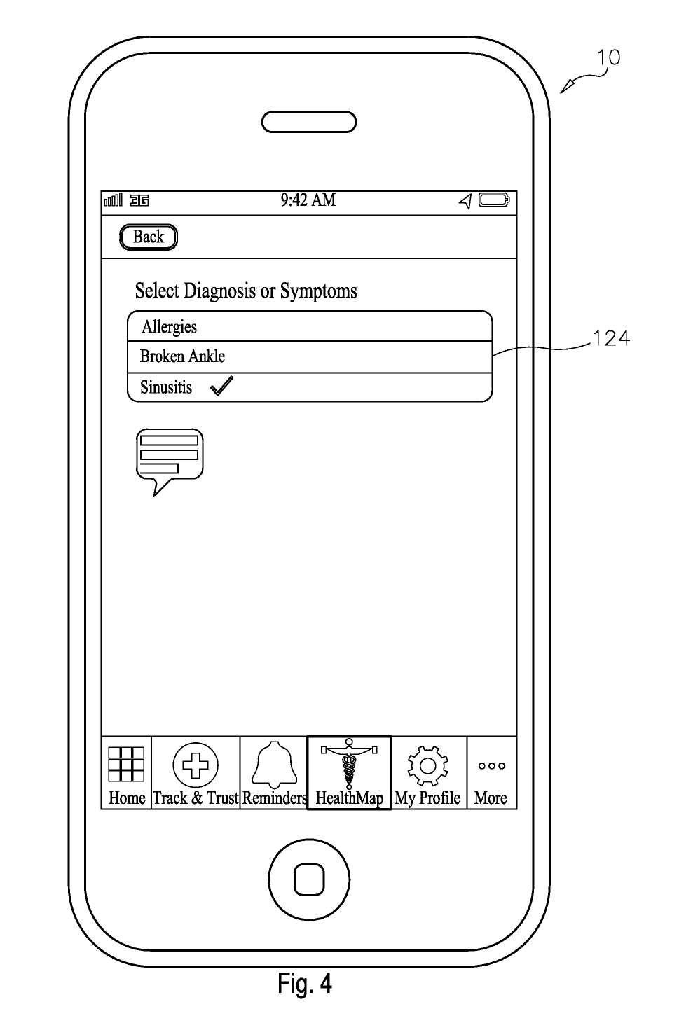

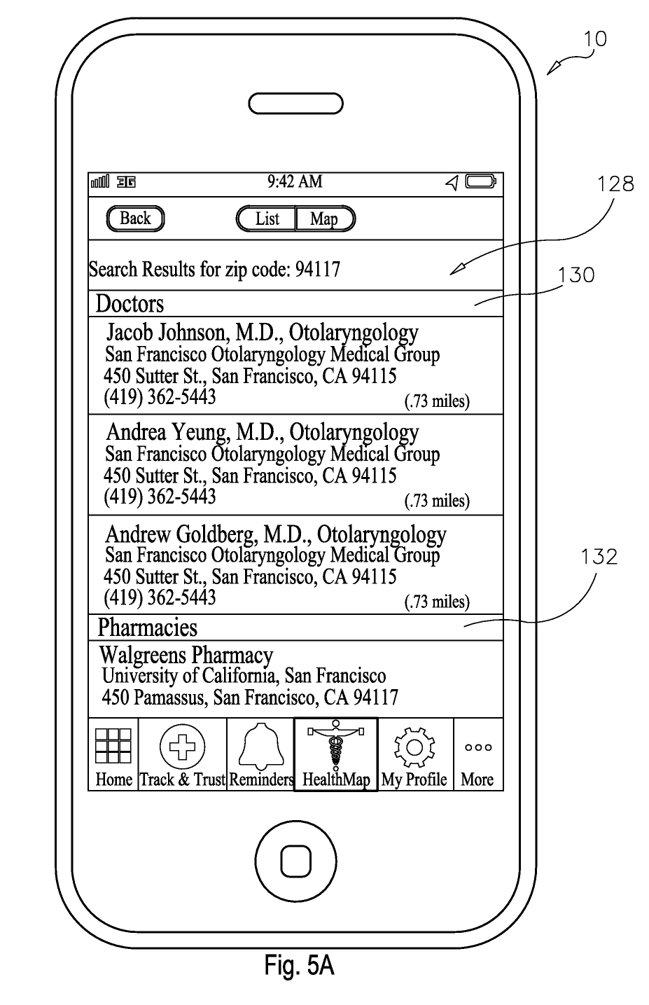

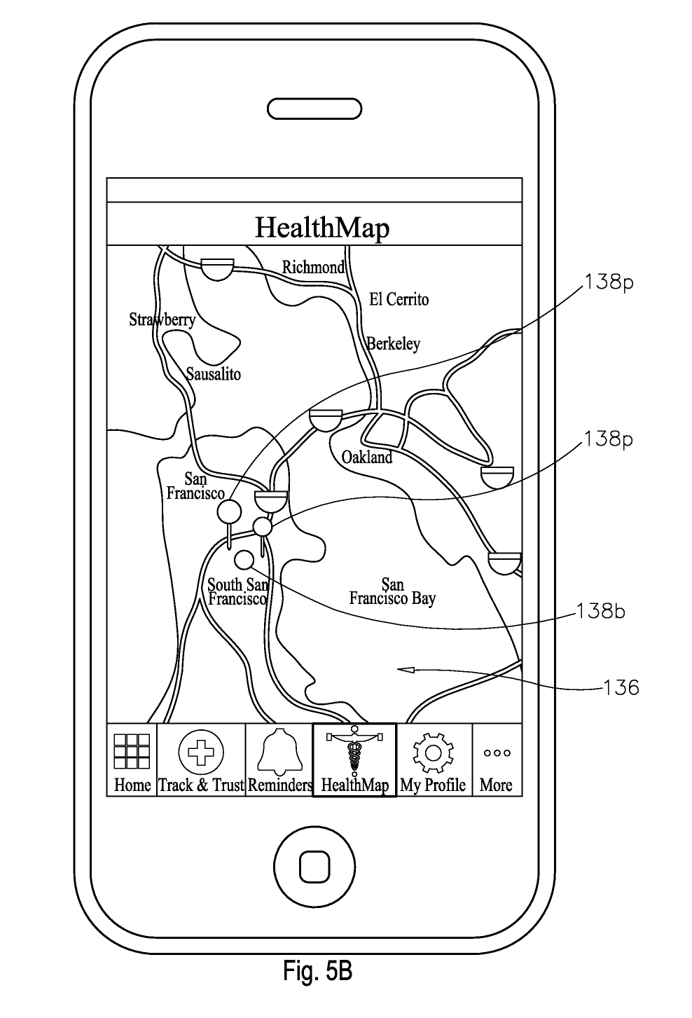

FIG. 4 illustrates navigation of the disease, symptom or ailment selector 124 to select “Sinusitis”. FIG. 5A shows results of the HealthMap search having been executed for Doctors and Pharmacies in the zip code 94117. Note that the headers 130 and 132 can be color coded to differentiate categories. Likewise, in a map view 136 of the data (see FIG. 5B), the pin locators for each location can be color-coded by category. Thus, for example, the pin locators 138p for the “Doctors” category of FIG. 5A can be color coded purple in FIG. 5B and the pin locators 138b for the “Pharmacies” category of FIG. 5A can be color coded blue in FIG. 5B. Note that the information shown in FIG. 5A can be scrolled to display additional results when not all results will fit on a single screen 100.

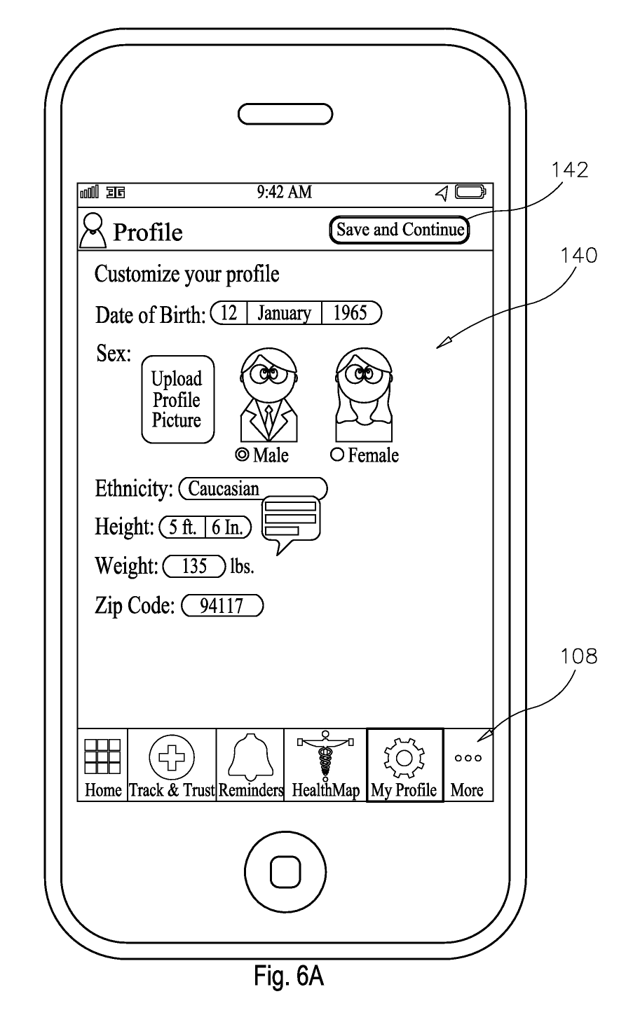

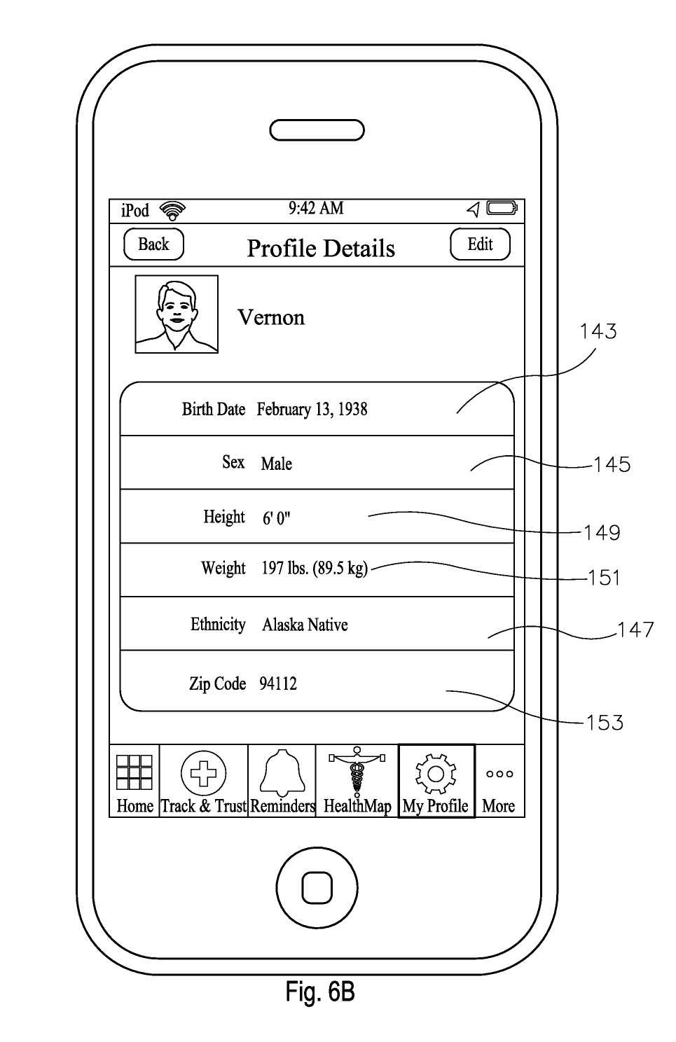

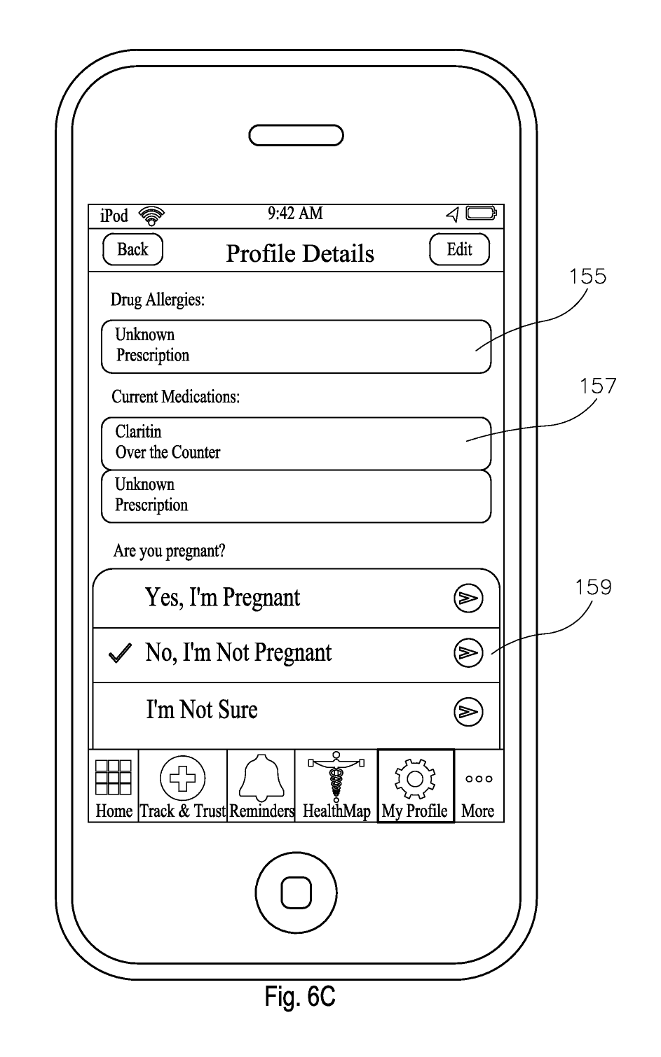

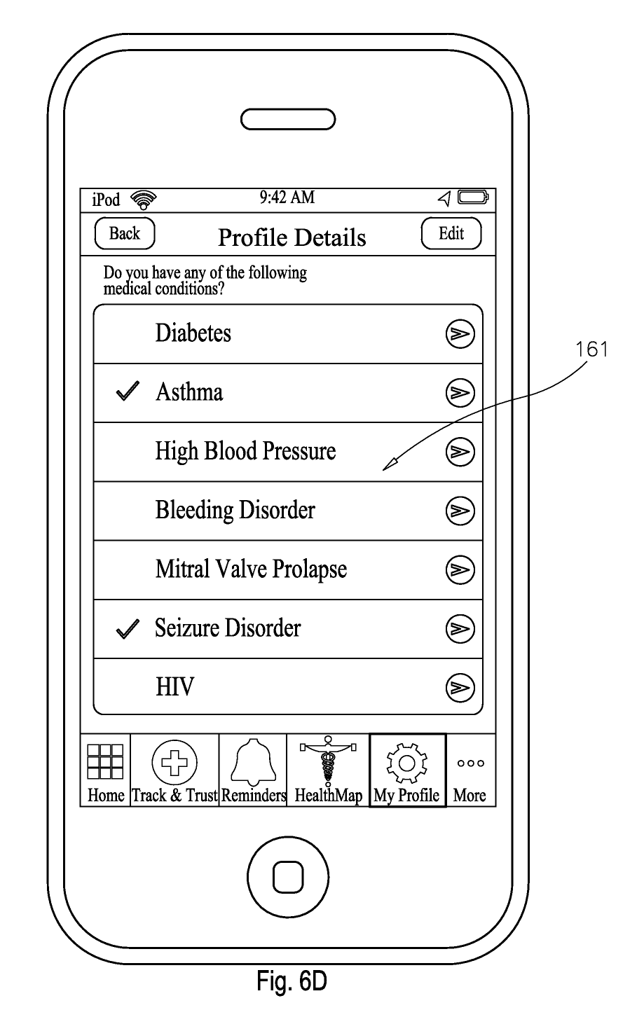

FIG. 6A shows an initial screen of the MyProfile or Profile tool 140, the icon for MyProfile having been selected in the tool tray 108. The initial access to the profile tool 140 by a first time user (see FIG. 6B) prompts the user to enter personal data into the profile so as to customize it personally to that user. The initial screen in FIG. 6B prompts the user to enter date of birth 143, sex 145, ethnicity 147, height 149, weight 151 and zip code of residence 153. By scrolling down on this screen (see FIG. 6C), the initial screen additionally prompts the user to enter drug allergies 155, current medications 157 (medications that the patient is currently taking), and whether or not the patient is pregnant or is unsure about the answer to this question 159. By further scrolling downwardly, the initial screen (see FIG. 6D) additionally prompts inputs regarding medical conditions that the patient has. Additionally, although not shown, the initial screen may prompt input of details of the patient's insurance provider(s).

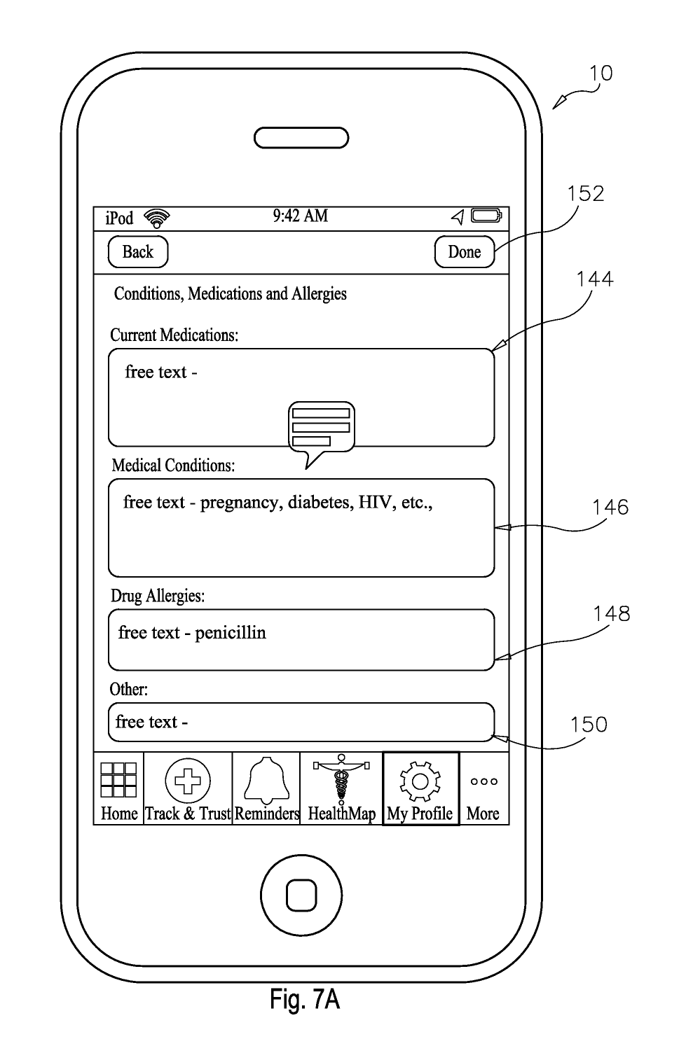

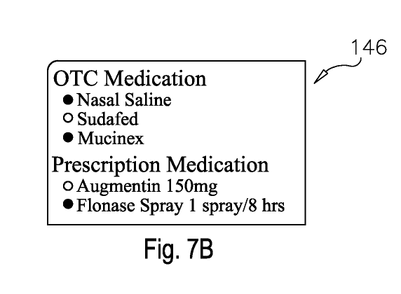

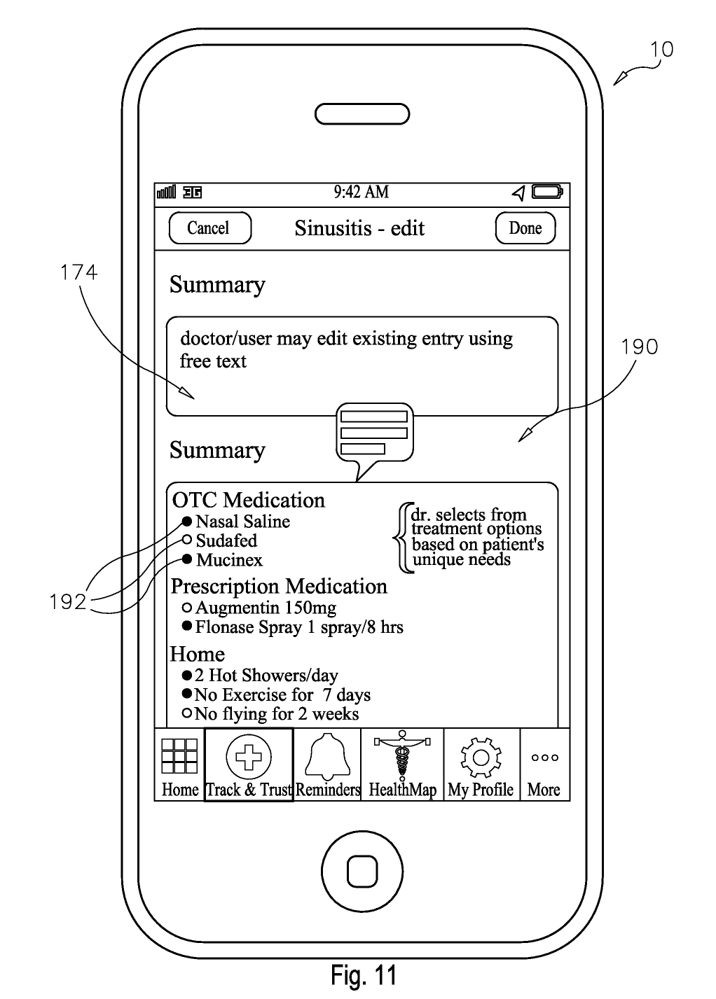

Alternative to the above embodiment where the initial screen is scrolled to fill in further information, after filling in the request information prompted by the initial screen of FIG. 6A, the user selects on the save and continue feature 142 which causes the display of the next screen, an example of which is shown in FIG. 7A. At box 144, the user is prompted to enter the current medications that the user is taking. This can be accomplished by entering in the medication as free text, as illustrated in FIG. 7A, or, alternatively, by selecting from a drop down list 192 (e.g., see FIG. 11). Another example of a portion of a drop down list 192 is illustrated in FIG. 7B. At box 141, the user is prompted to enter all medical conditions that the user has. Like box 144, the user can enter medical conditions as free text, or select medical conditions from a drop down list (analogous to 161 in FIG. 6D). At box 148, the user is prompted to enter all drug allergies that the user has. Like box 144, the user can enter drug allergies as free text, or select drug allergies from a drop down list (see 155, FIG. 6C). Box 150 is provided to allow the user to enter any other information that the user believes may be pertinent to the user's medical conditions, medications and allergies. Box 150 is set up for free text entry.

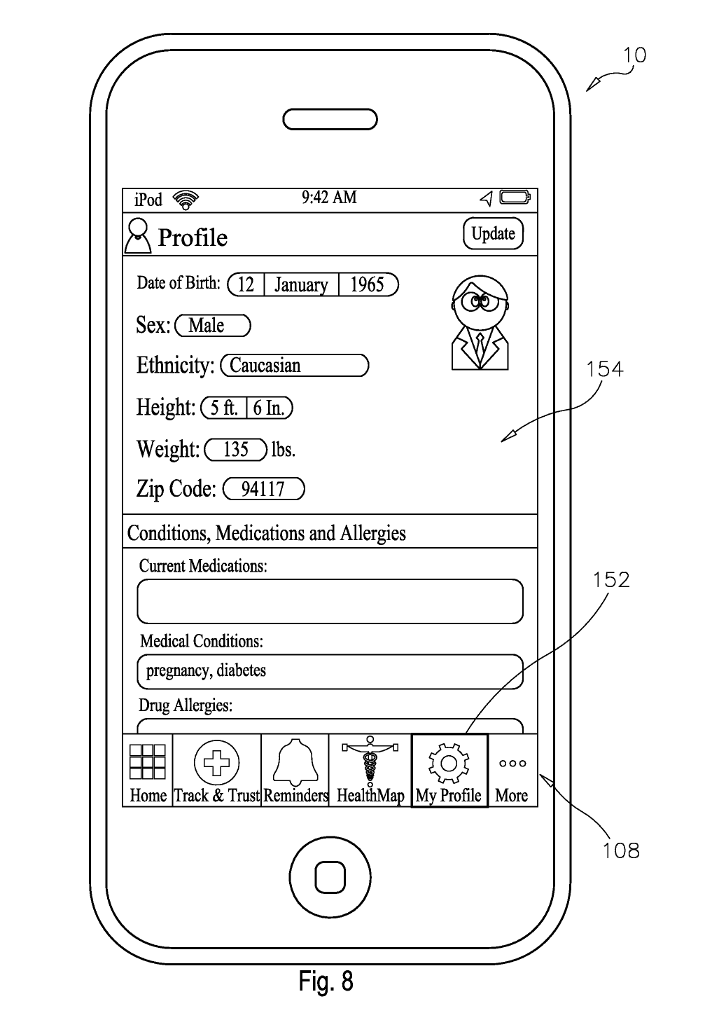

Upon completing the information regarding medical conditions, medications and allergies, the user selects the “done” button 152, which causes the system to display the profile of the user as the “Profile” or “MyProfile” screen 154 shown in FIG. 8. This is also the screen that returning users will see when the “My Profile” icon 152 is selected from the tool tray 108.

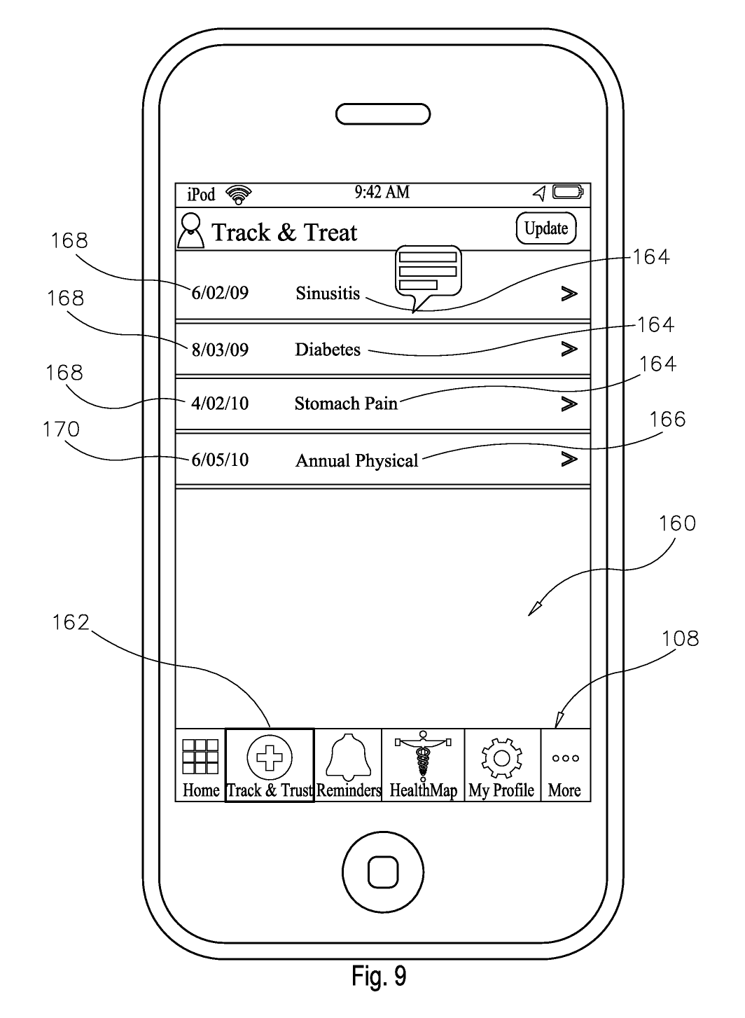

FIG. 9 shows an initial screen display 160 for the “Track and Treat” tool of the present invention that is initiated upon selection of the “Track and Treat” icon 162 in tool tray 108. Screen 160 displays the medical conditions 164 and scheduled physician's appointments 166, preventative care dates, treatments and symptom tracking, as well as the dates 168 that the respective diagnoses 164 were first made ad registered into the application of the present invention, and dates 170 that the appointments should be scheduled for.

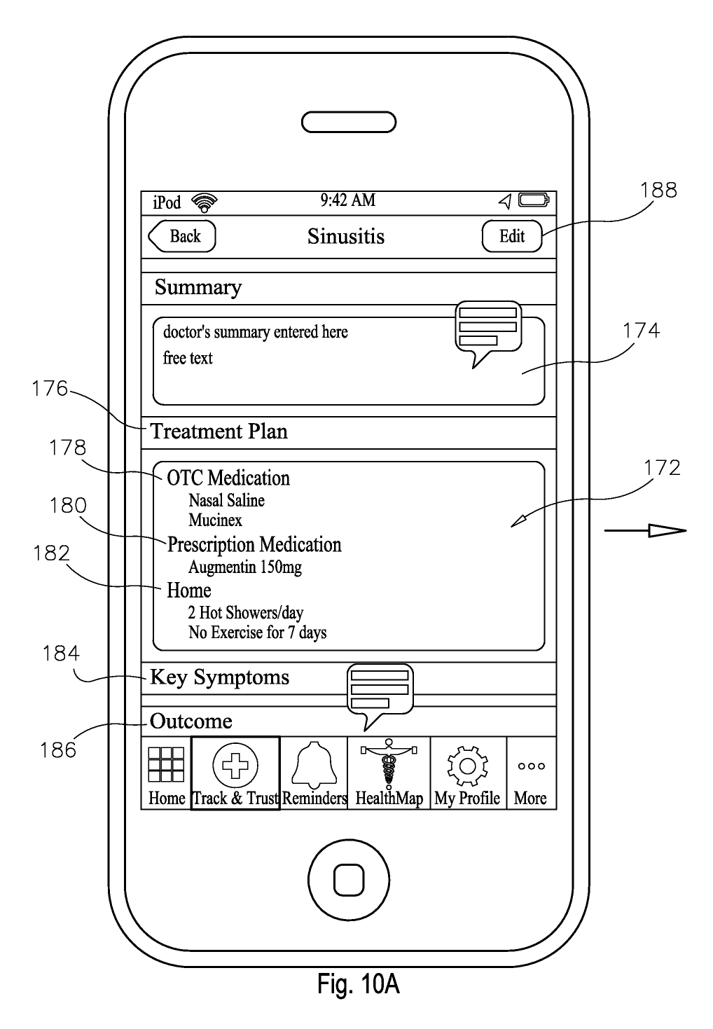

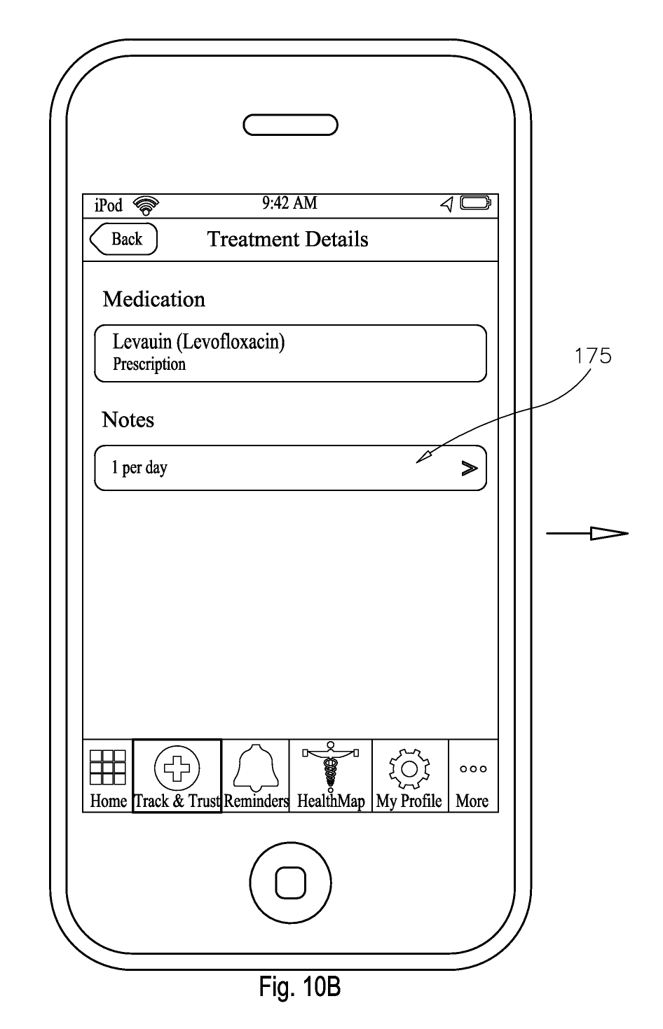

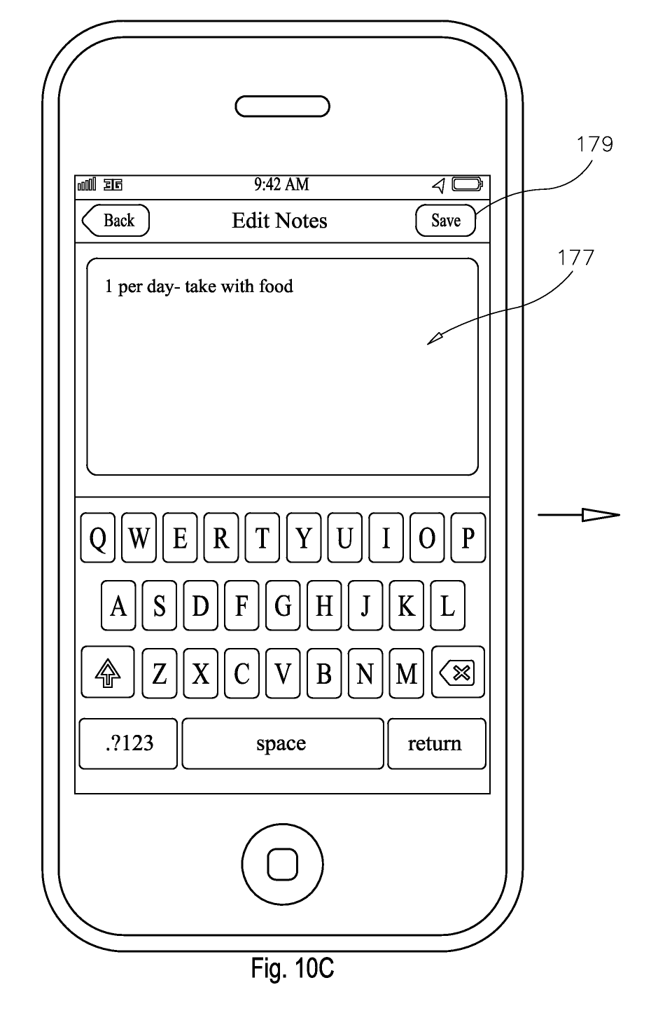

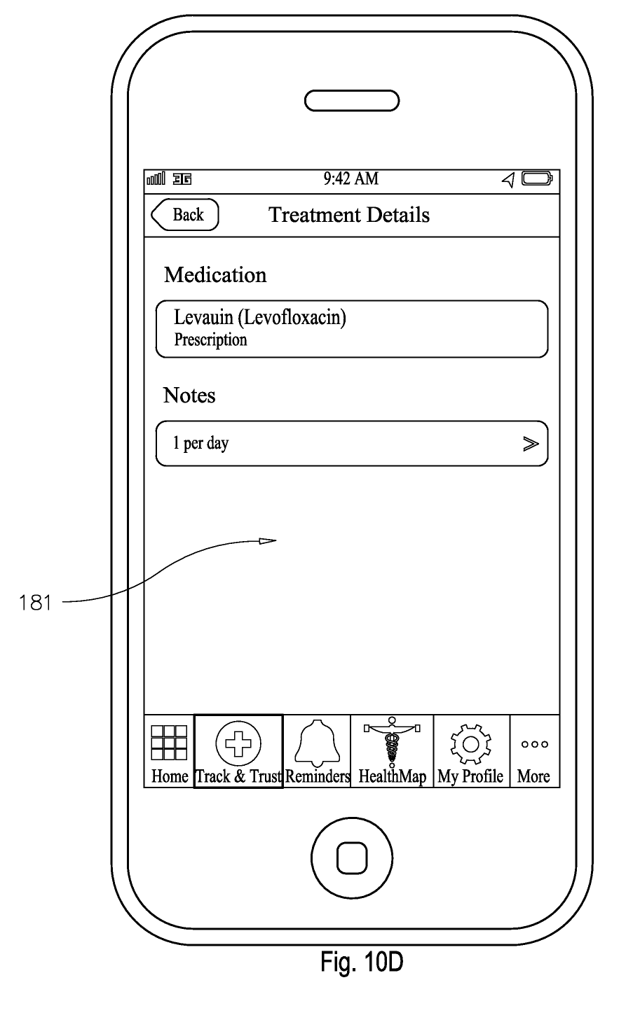

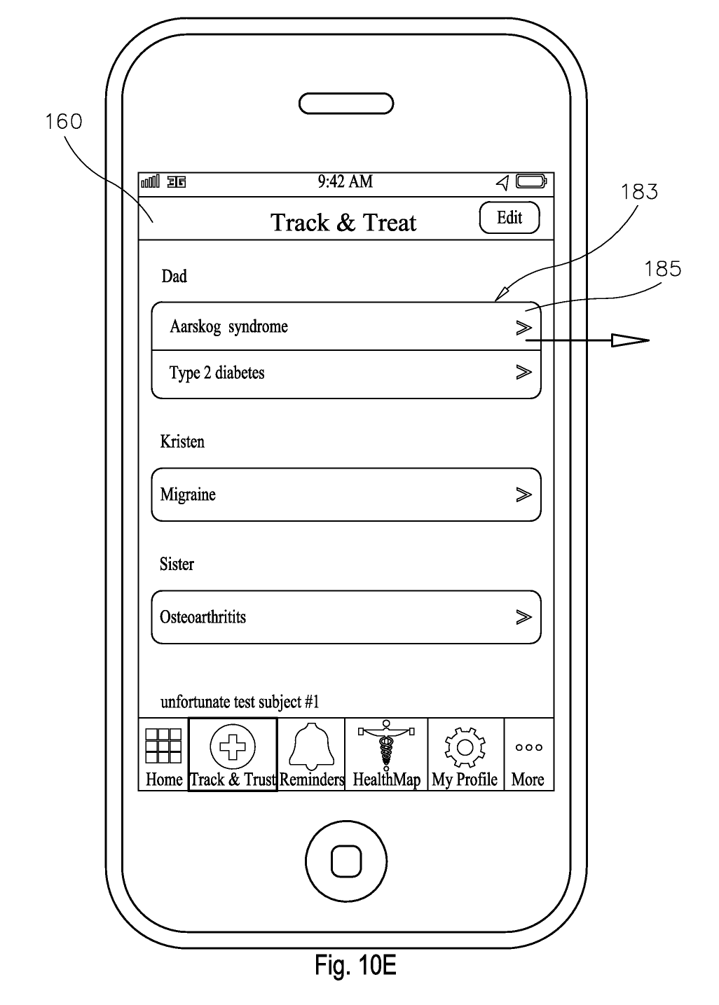

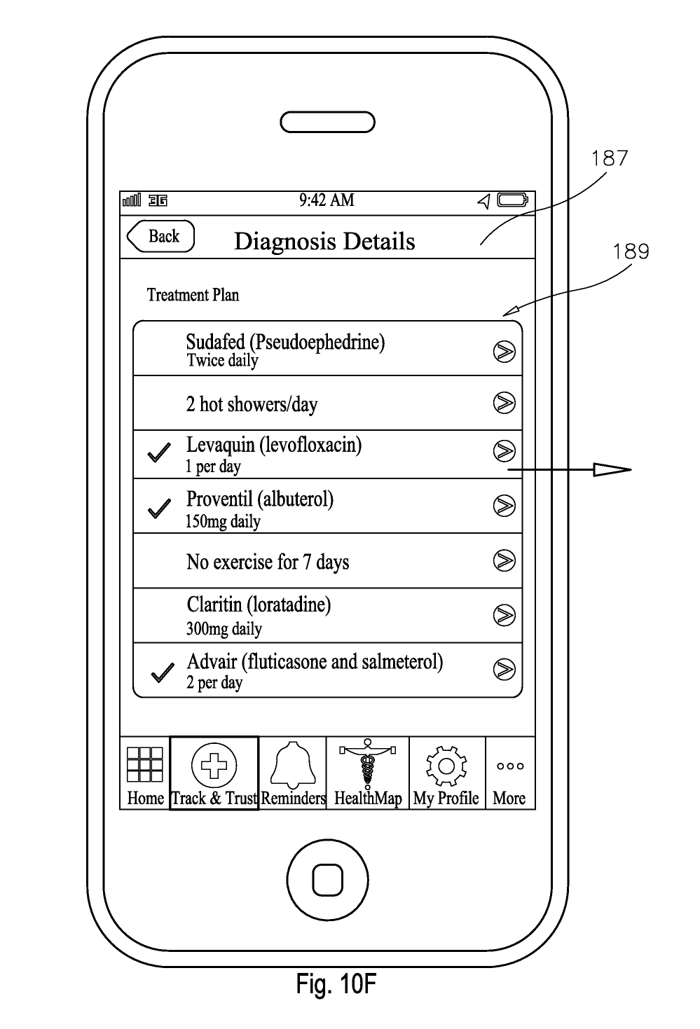

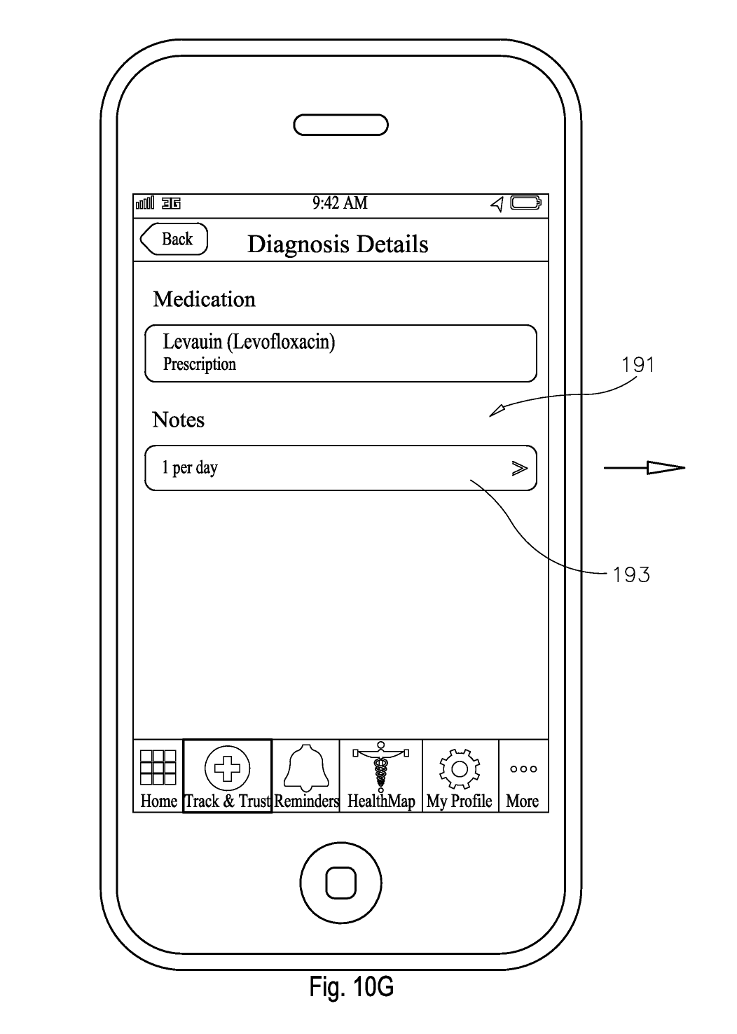

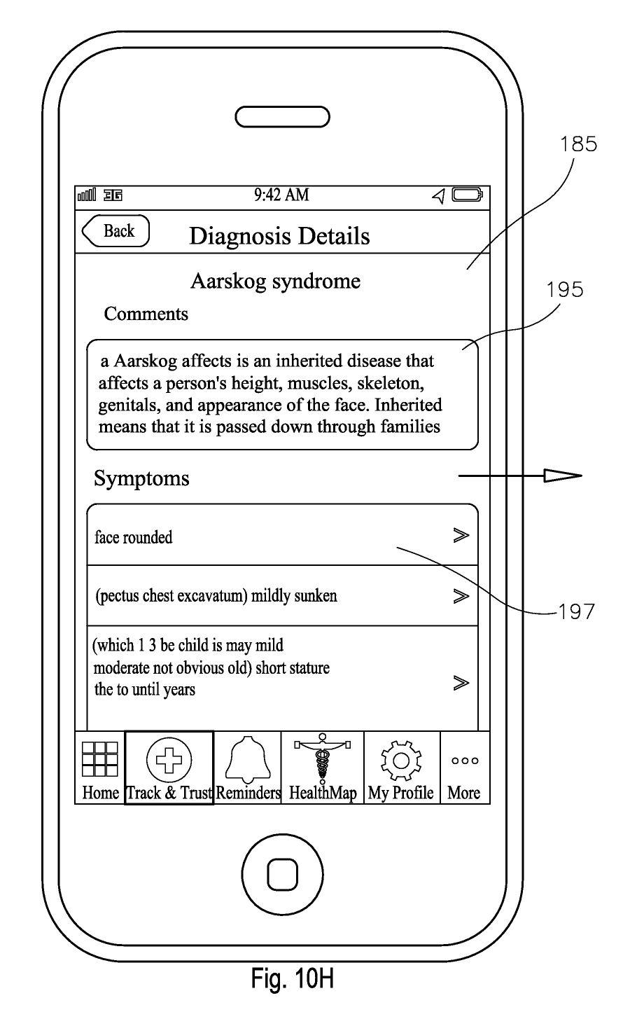

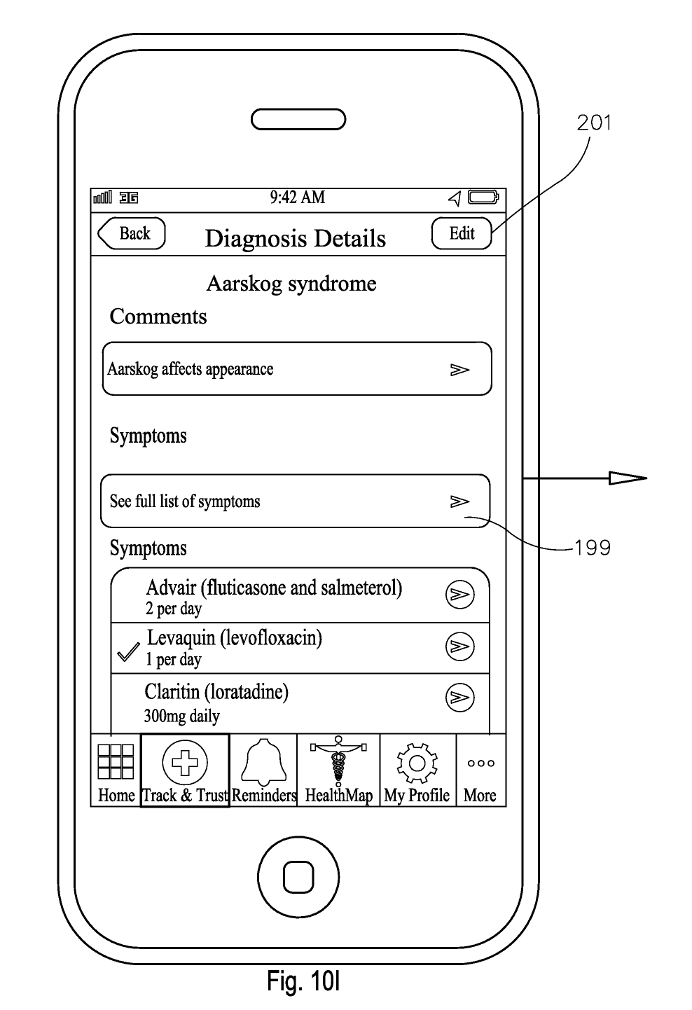

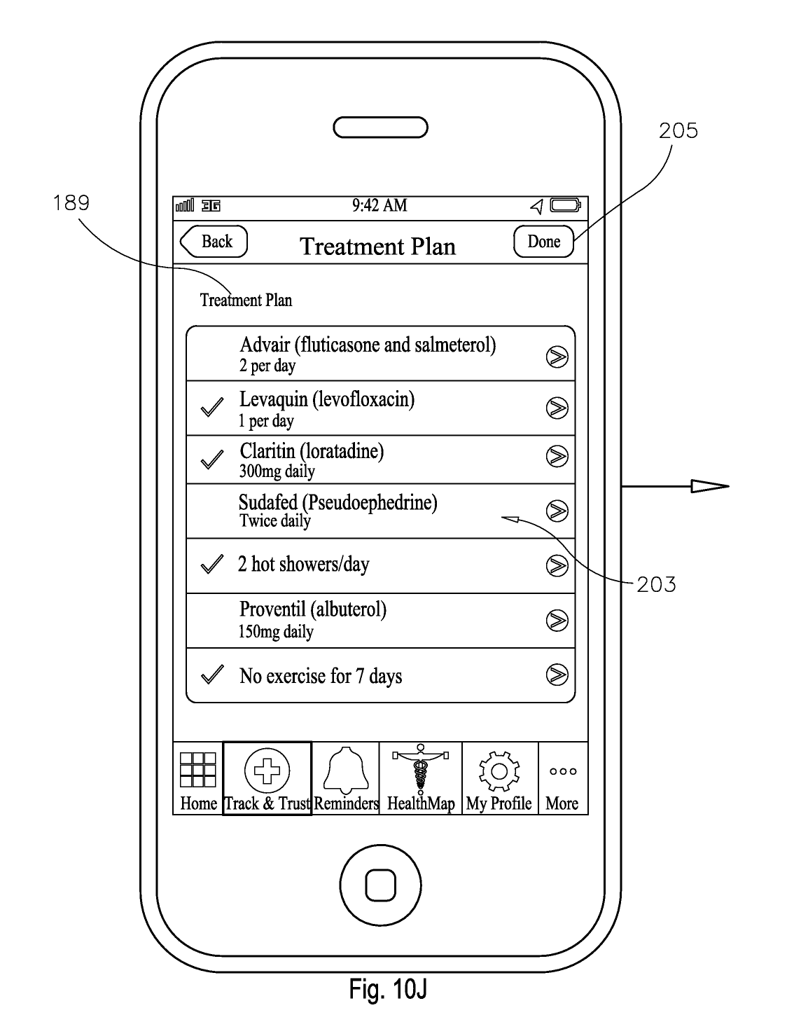

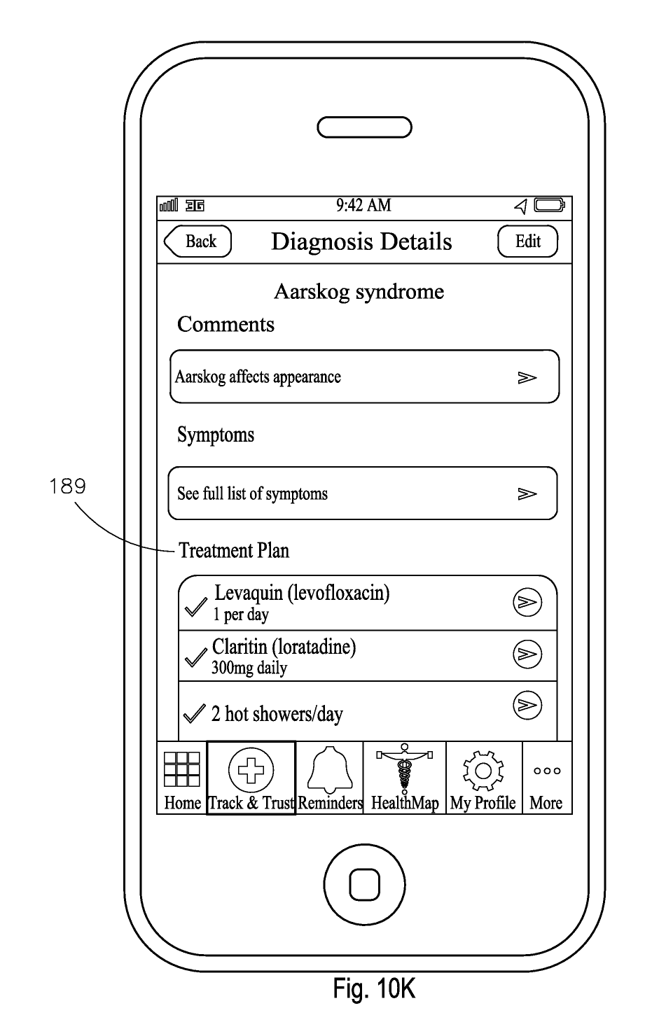

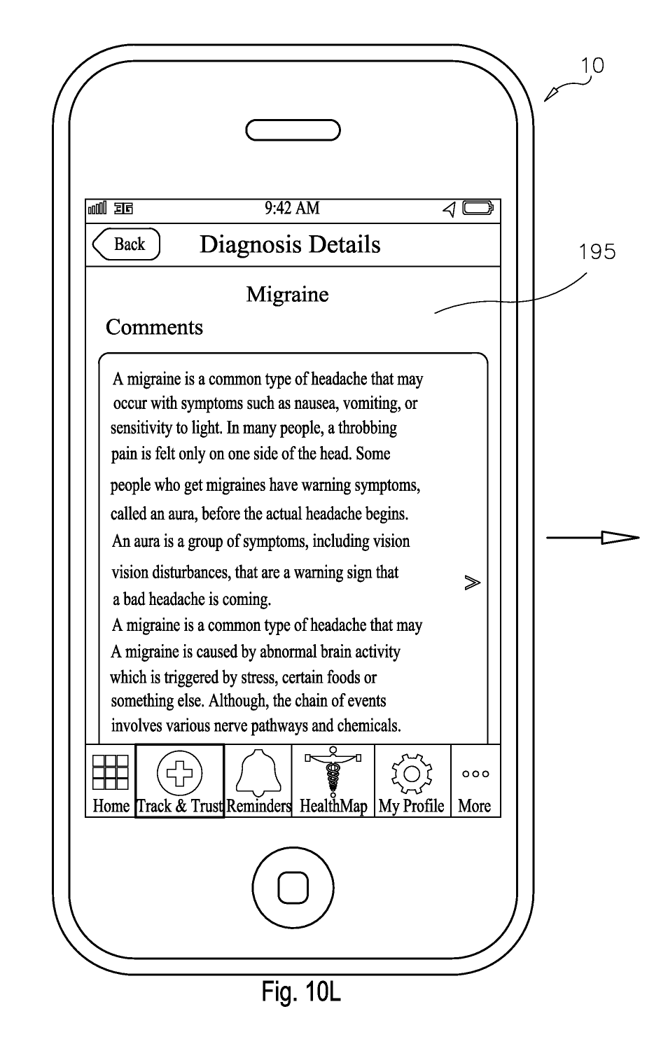

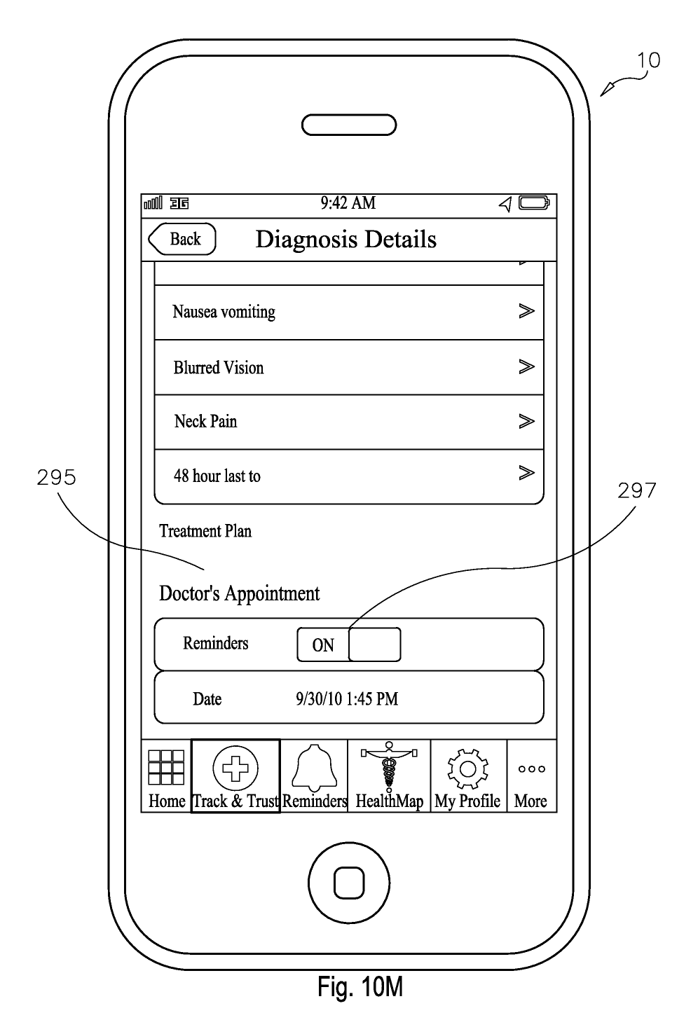

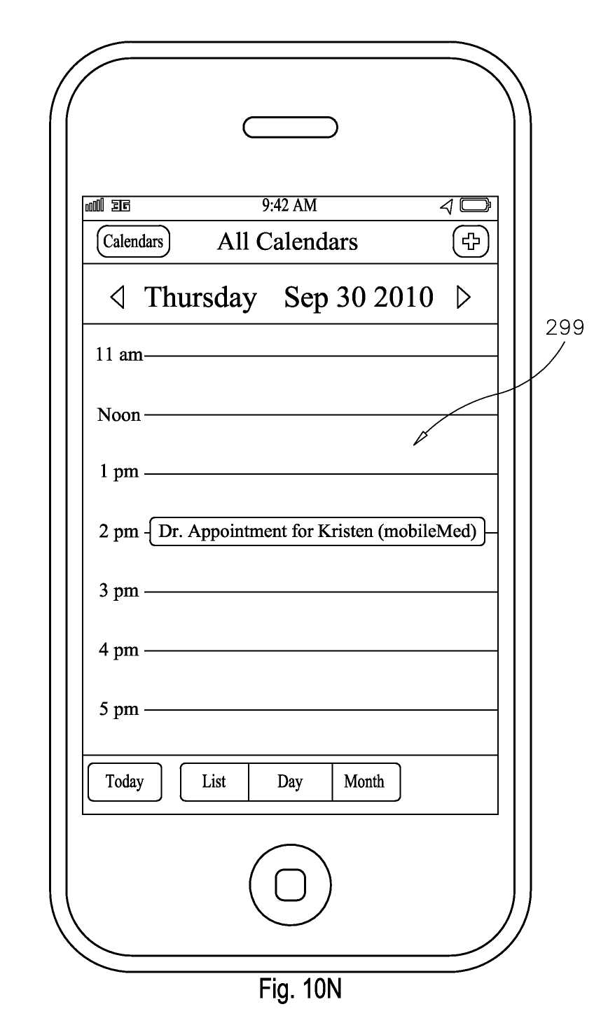

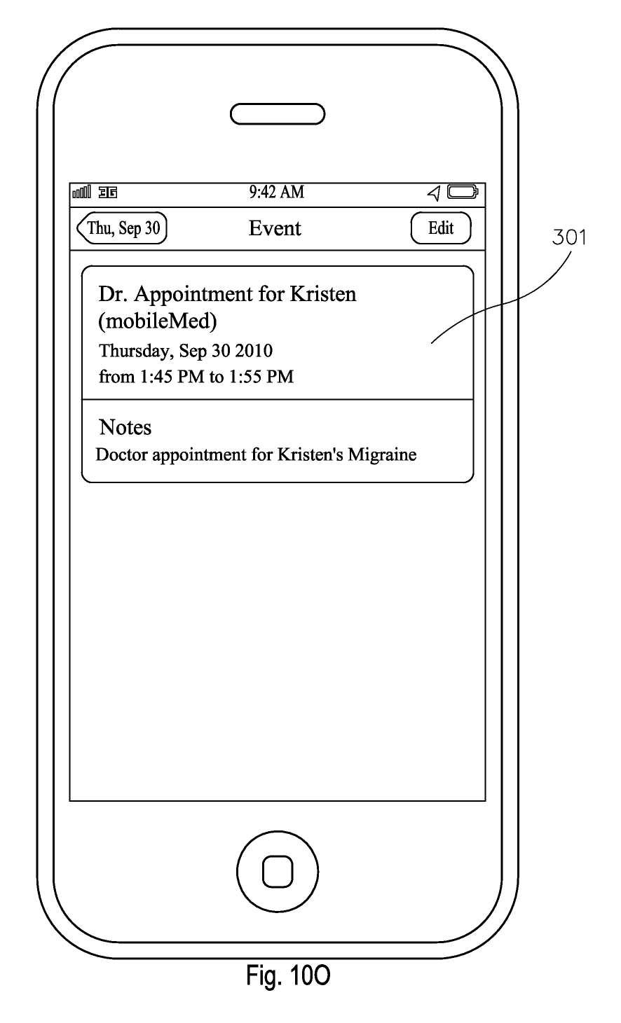

By selecting on one of the listed items 164, 166, this causes a detailed display 172 that further characterizes the medical condition 164 or appointment 166 that was selected. FIG. 10A shows a screen 172 that is displayed as a result of selecting on “Sinusitis” 164 in FIG. 9. The detailed display shows a Summary 174 that is pre-populated by the treatment plan, or modified by the physician or other health care provider treating this condition. The summary 174 may be entered as free text. In an alternative embodiment, a “Notes” section 175 (FIG. 10B) is displayed in the treatment details screen when a condition is selected in the screen of FIG. 9. By selecting (e.g., tapping) on the chevron associated with the entry in the Notes section 175, the Notes section can be edited 177 as illustrated in FIG. 10C. By then selecting on the save button 179, the treatment details screen is again displayed (FIG. 10D), this time including the edits made in FIG. 10C. FIG. 10E shows an alternative Track and Treat display 183 that integrates relevant medical information about family members of the patient user. By tapping on (or otherwise selecting) a specific diagnosis 185 (“Aarskog syndrome”, in the example shown), a Diagnosis Details screen 187 (FIG. 10F) is displayed showing a list of treatments 189. Upon selecting a treatment, a treatment details screen 191 is displayed (FIG. 100) which can be edited in the Notes section 193 by the provider to present customized, detailed instructions to the patient, thereby offering treatment options to the patient. Referring back to FIG. 10A, a treatment plan 176 is displayed, including any over the counter medications 178 that are recommended, prescription medications 180 having been prescribed, and other doctors' orders (Home) 182 to be carried out by the patient. As noted above, a Generic Treatment Plan is provided as the treatment plan offered when the patient has selected a specific diagnosis to be treated. A Smart Treatment Plan is provided as the treatment plan offered when the patient has selected a specific diagnosis to be treated, and has input (or had someone else input on his/her behalf) profile information, whereas a Symptom Relief Plan is offered as the treatment plan when the patient has selected only symptoms, but not a specific diagnosis. Key symptoms 184 experienced by the patient user are displayed under the Key Symptoms header bar (need to scroll down or select on the Key Symptoms header bar to expand this category to display the specific symptoms listed). An Outcome bar 186, when selected on, displays an outcome that is pre-populated by the treatment plan, or modified by a care provider (e.g., patient's physician) to indicate a date when the symptoms should resolve. A list of traced items and reminders that may be displayed may include, but is not limited to: preventative dates, appointment dates, treatments and symptom tracking.

FIG. 11 shows a Track and Treat editing screen 190 that is displayed upon selecting on the edit button 188 in FIG. 10. This editing function can be used by the patient's physician or other authorized care provider, as well as by the patient. The patient can choose to hide a treatment, but the original treatment plan indicated by the patient's physician is still saved, logged in the medical record, and viewable. For example, In FIG. 10H, once the user adds a diagnosis 185, the comments 195 and full list of symptoms 197 displayed are collapsed to a single line (199, FIG. 10I), making the Treatment Plan more visible. By selecting on edit 201, the user (e.g., patient's physician) can select specific treatments 203 for the patient. Once the appropriate selections have been made, the user selects done 205 after which the diagnosis details screen 185shows only the selected treatments in the treatment plan section 189, see FIG. 10K.

FIGS. 10L-10O illustrate screens and a tool used to enter a physician's appointment into device 10. At FIG. 10L, the user scrolls down past the comments section 195 of the Diagnosis Details screen to display the Doctor's Appointment section 295, see FIG. 10M. The reminders button 297 can be selected on to turn reminders on or off. In FIG. 10M, reminders have been turned on. This causes display of a calendar 299 (FIG. 10N) where the user can select the date and time of an appointment. The appointment is then automatically displayed in the phone calendar of device 10N as shown in FIG. 10N and is flagged as a system event as illustrated at 301 in FIG. 10O.

In the editing screen of the embodiment shown in FIG. 11, a physician user of device 10 that is treating the patient user 10 of a device or by another authorized health care provider user of a device 10 that is authorized to access the patient's profile and for providing care to the patient and thus has access to the user's profile, can access the user's profile and edit the Track and Treat data. For example, the physician can edit the entry in the Summary 174 using free text. In the Treatment Plan box 172 (FIG. 10A), the editing feature provides radio buttons, check boxes, or other selectable features that can be selected or deselected to display or remove any of the listed over-the-counter medications, prescription medications and home instructions.

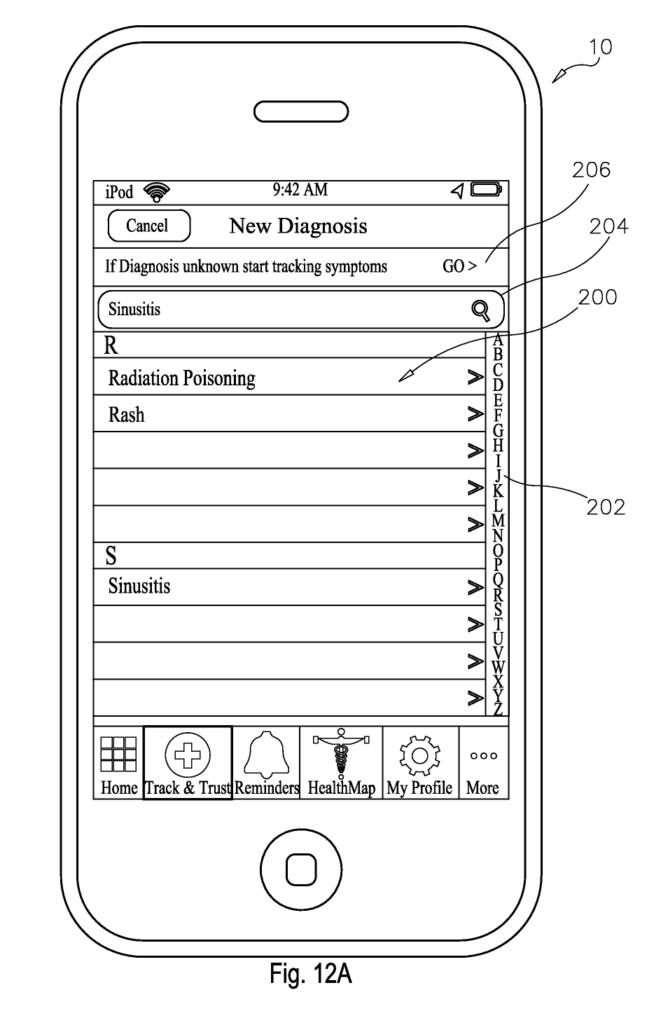

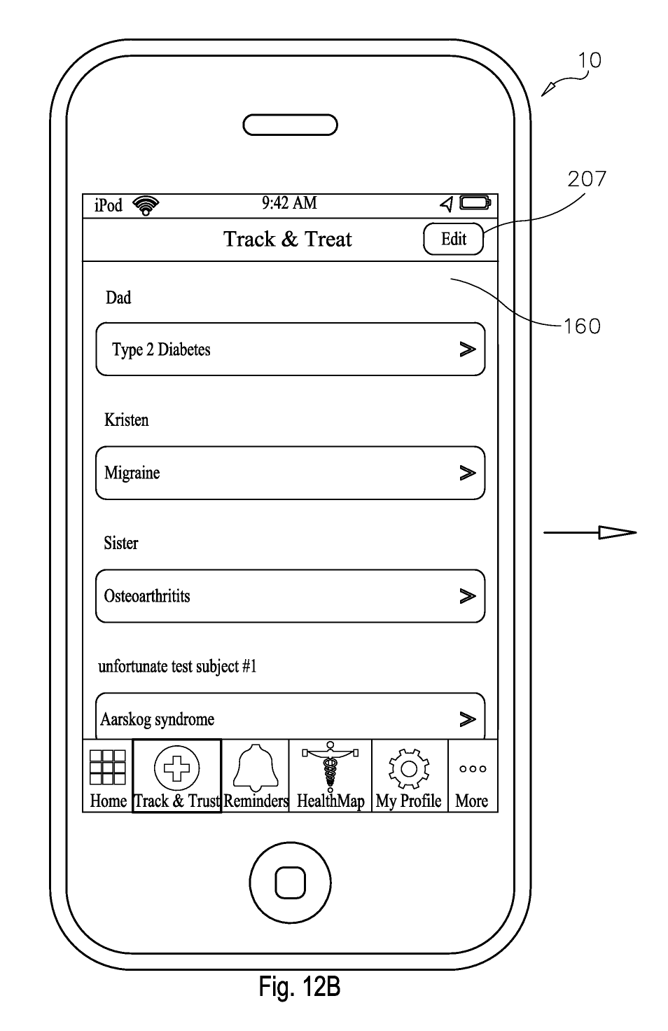

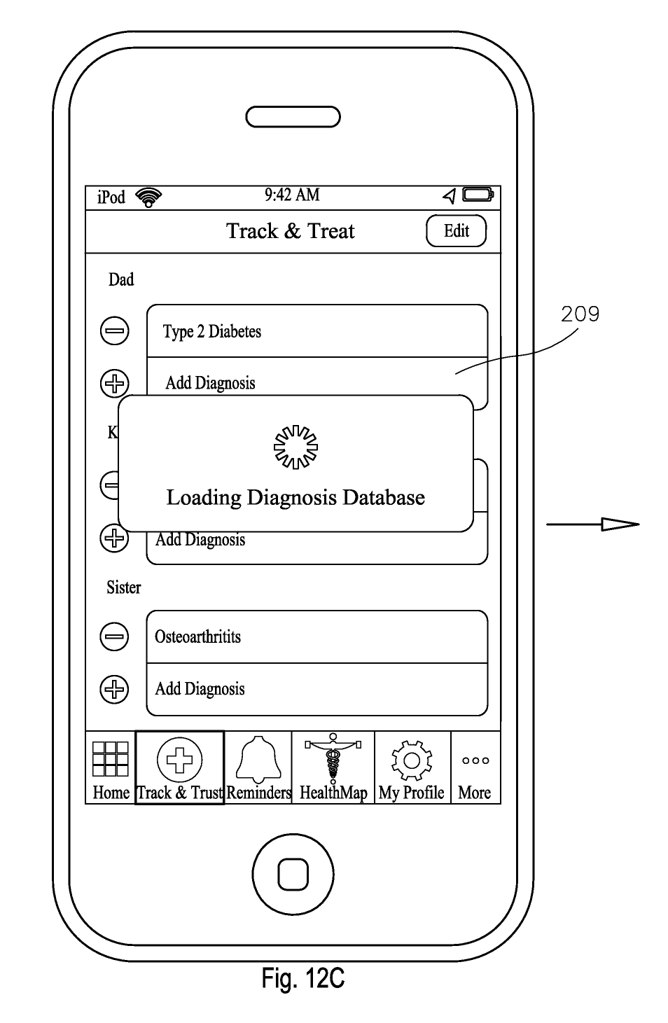

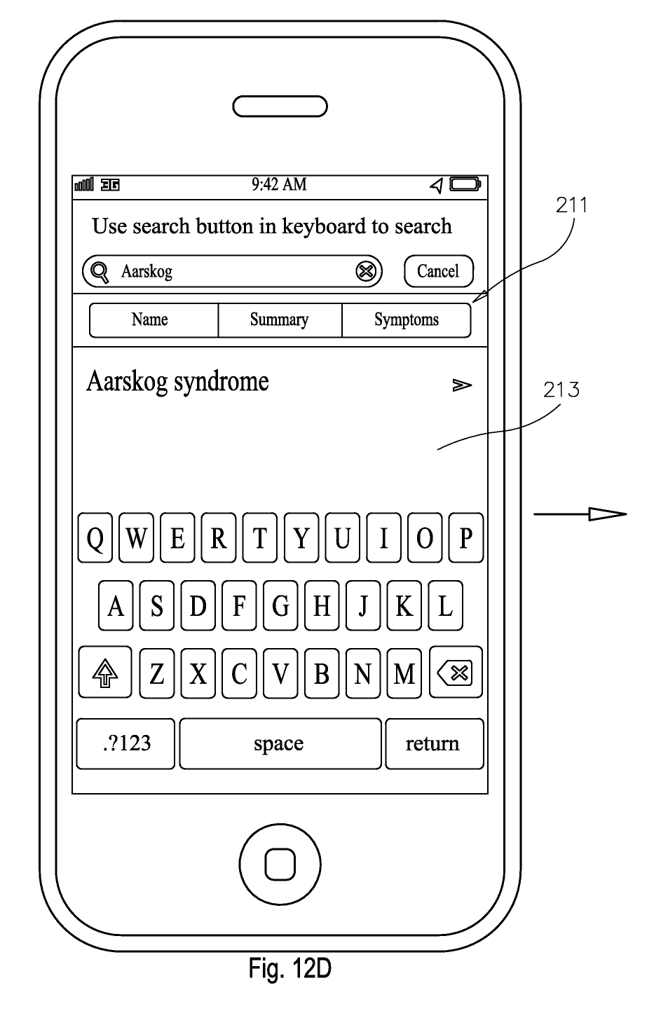

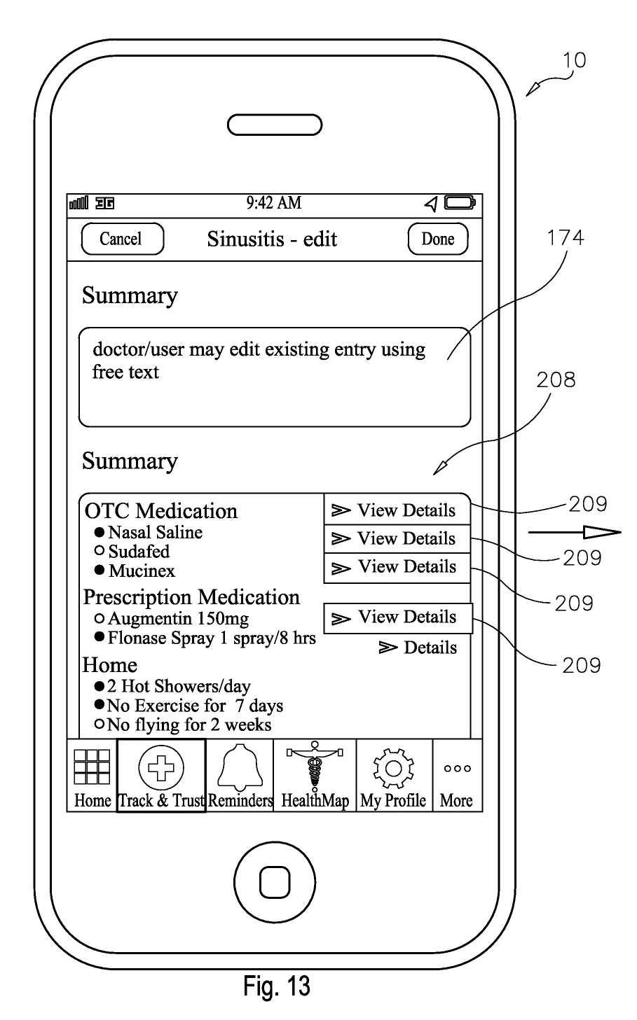

FIG. 12A illustrates a “New Diagnosis” display screen 200 that can be displayed, using the Track and Treat tool, by a physician user of a device 10 that is treating the patient user of another device 10 or by another authorized health care provider user of a device 10 that is authorized to access the patient's profile and for providing care to the patient and thus has access to the user's profile. Typically the user will be a physician, physician's assistant or nurse practitioner that will use the “New Diagnosis” screen. An alphabetical listing 202 of potential diagnoses is displayed and can be scrolled through to selected a diagnosis by browsing, or can be searched on to locate a letter section of the list, or all or part of a name of a diagnosis. Typically, the diagnosis list 202 will include known diagnoses (preferably all diagnoses) and corresponding codes from at least one well-known diagnostic coding system, including, but not limited to: International Statistical Classification of Diseases and Related Health Problems (ICD), International Classification of Primary Care (ICPC), International Classification of Sleep Disorders (ICSD), North American Nursing Diagnosis Association (NANDA) International, Diagnostic and Statistical Manual of Mental Disorders (DSM), Mendelian Inheritance in Man, Read codes, Current Procedural Terminology Codes (CPT) or Systematized Nomenclature of Medicine (SNOMED) In box 204, the user (physician or other authorized health care provider) can begin typing in the new diagnosis until it autopopulates. Alternatively, the user may browse the screen 202 until finding the correct diagnosis and select on it to autopopulate it into box 204. Thereafter, upon selecting on the “go” box 206, a detailed new diagnosis screen 208 is displayed, as shown in FIG. 13. Note that optionally, the user can leave box 204 blank if the diagnosis is unknown, and then select go 206 to begin tracking symptoms.

FIGS. 12B-12D illustrate an alternative embodiment of the interface for the new diagnosis function. From the track and treat screen 160, when the edit button/function 207 is selected, a screen 109 an “add diagnosis” 209 function is selectable in FIG. 12C to display a search screen 211, see FIG. 12D. The user then types a symptom name or disease name into the search box 213 and selects the search button 215 to perform a search to locate data for the inputted symptom or disease name. From the results, the user can select a disease to be added as a new diagnosis to the track and treat program and be displayed in the track and treat screen.

FIG. 13 shows a new diagnosis detail screen 208 displayed after entering a new diagnosis of “sinusitis” in the new diagnosis screen 200 as shown in FIG. 12. The physician (or other healthcare provider) user may be provided with a standard summary of the diagnosis of “sinusitis” in box in summary box 174. If this is the case, the user may edit the standard summary. Even if the box 174 is initially blank, the user can enter a description into the summary box 174. Under the treatment plan, the user can select over the counter medications, prescription medications and/or home instructions just as described with regard to the editing screen of FIG. 11 and FIGS. 10B-10G.

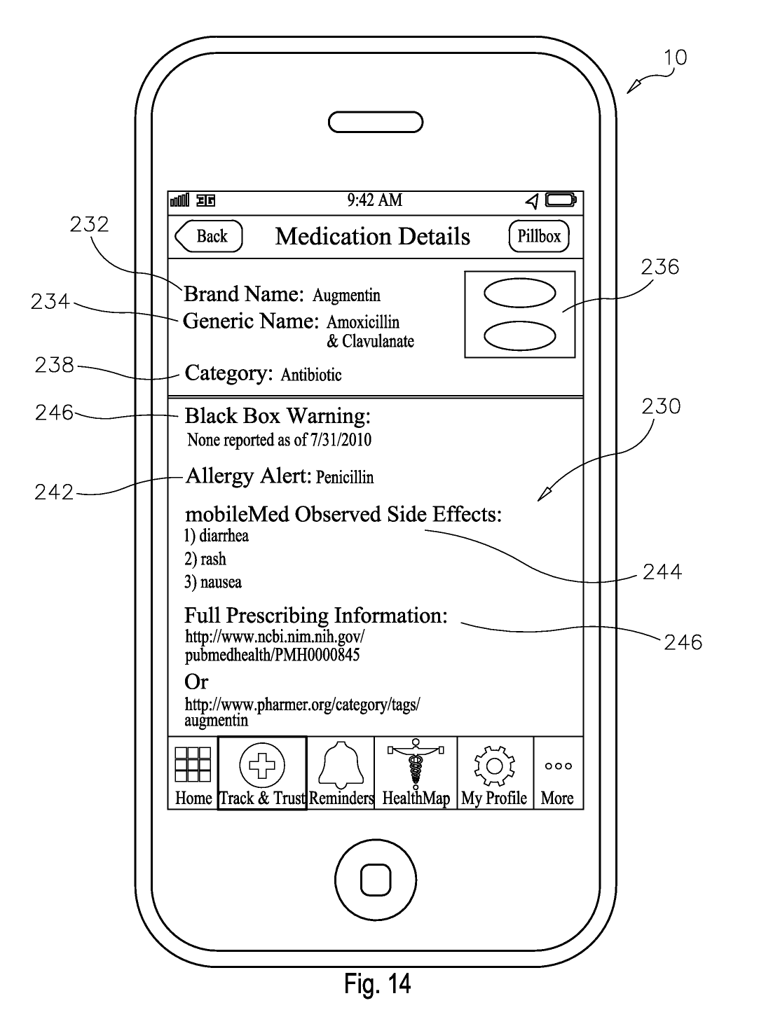

For each of the medications, a “view details” button 209 may be provided that, when selected generates a medication details screen 230 for that specific medication. FIG. 14 shows a medication details screen 230 for “Augmentin 500 mg, the view details 209 function for that medication having been selected in FIG. 13. The medication details screen 230 is a display from the current Pillbox tool, which contains all the details of the medications that the patient is currently prescribed/recommended to take. The medication details screen 230 of the Pillbox tool lists the brand name 232 of the selected medication, the generic name 234 of the selected medication and displays an image (preferably a photo) 236 of the specific medication that is listed in the treatment plan. The category 238 of the medication is also displayed. A black box warning section 240 lists any black box warning that is associated with that particular medication. If there are no black box warnings current for the selected medication, then that message is conveyed in the black box warning section 240, as shown in the example of FIG. 14. The Allergy Alert section 242 lists any generic allergy categories that the selected medication may fall under. In the example shown, Augmentin 500 mg generates an allergy alert for Penicillin. Accordingly, if the patient is allergic to penicillin, then he/she should not take Augmentin 500 mg as it may cause an allergic reaction. Additionally, if a user has “penicillin” listed in the drug allergies section of his/her profile, then any medication containing penicillin is greyed out in the treatment plan, and thus rendered unselectable, due to the potential for allergic reaction. Under the Observed Side Effects section 244, side effects having been determined by peer-review to be of the greatest concern, or with potential for significant discomfort to the patient, are listed. Every side effect ever observed can be accessed in the links to the full prescribing information. Thus, the side effects listed may be limited to the top three or some predetermined number of the most frequently reported side effects, or the side effects of greatest concern to the physician, for simplicity. At location 246 are one or more hyperlinks provided so that the user can access the full prescribing information for the selected drug from a website that lists the full content. Optionally, the user can download this information to device 10 if desired.

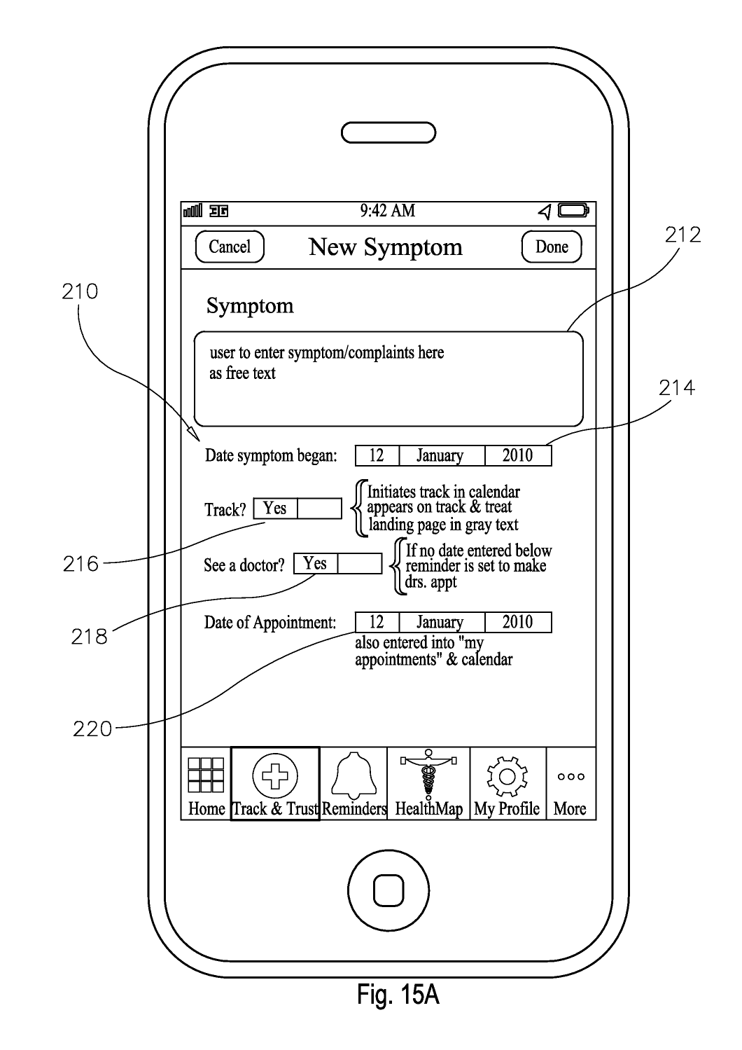

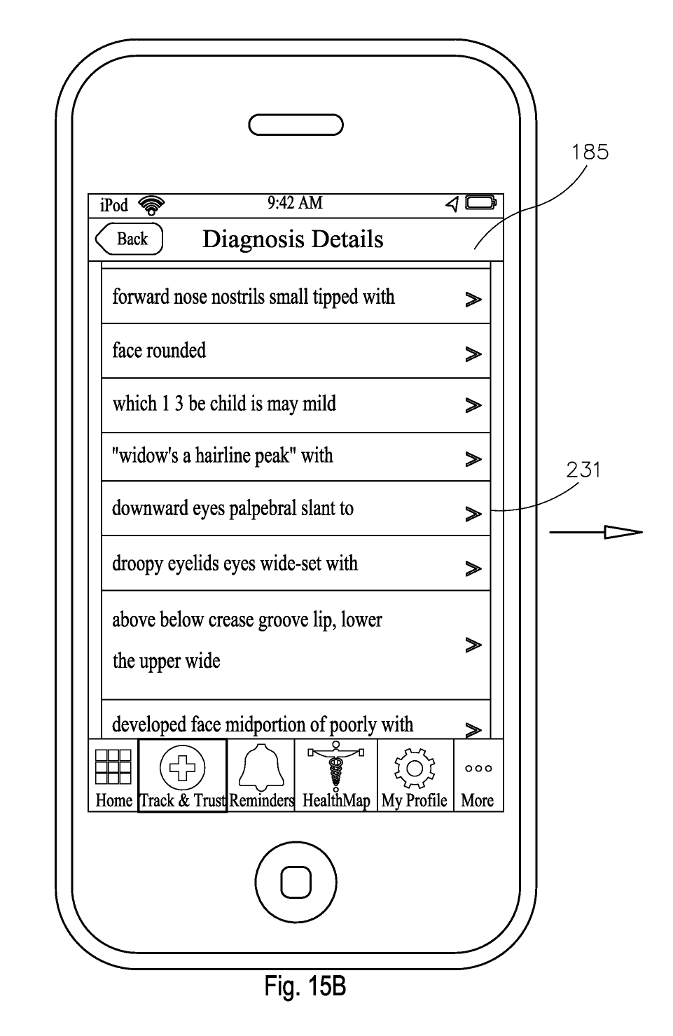

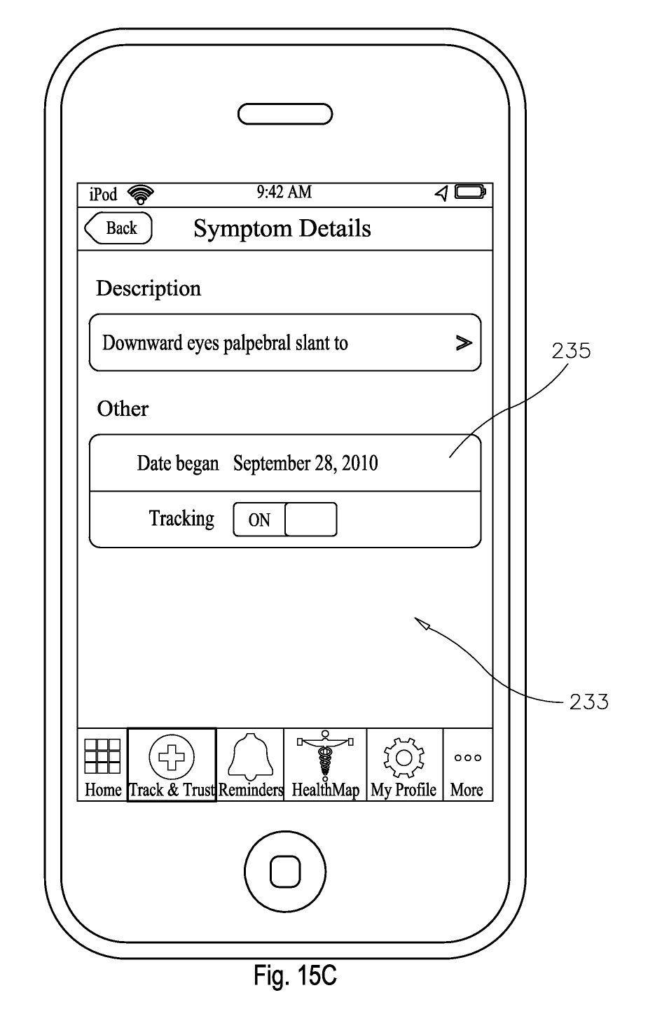

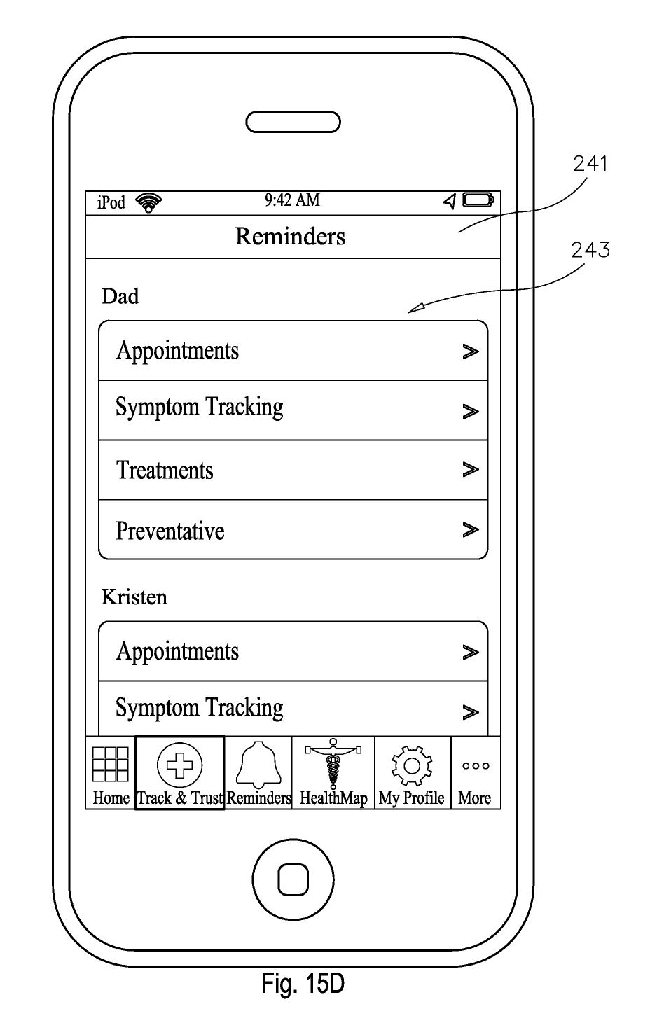

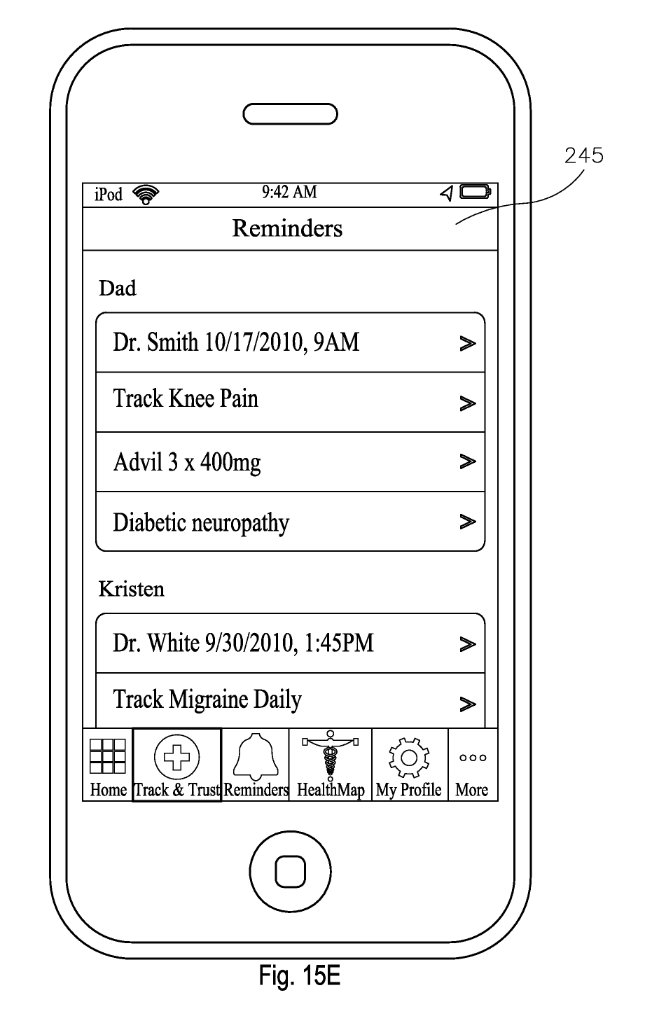

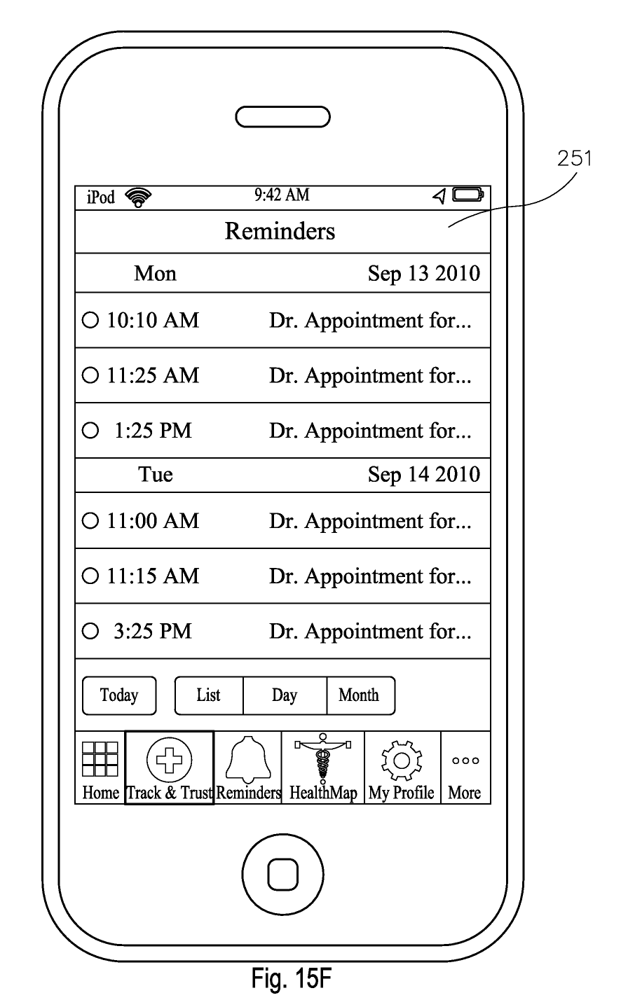

Upon completing the new diagnosis detail screen 208 to the satisfaction of the physician (or other healthcare provider) user, or when a diagnosis is not entered in 204 in FIG. 12, or by selecting “add diagnosis” in a manner as described above, or by selecting a symptom from within an existing diagnosis (as described in more detail below with regard to FIGS. 15B-15C) a new symptom can be entered. In FIG. 15A, a “new symptom” screen 210 is displayed, The new symptom screen 210 prompts the user to describe the new symptom/complaint using free text in box 212. Additionally, the user inputs the date that the new symptom began in boxes 214. At box 216 the user can instruct the new symptom to be tracked by the Track and Treat tool by entering yes, or not to track by entering no or leaving blank. Alternatively a check box can be provided, wherein tracking is initiated if the box is checked, but is not initiated if the box is left unchecked. Box 218 is provided to indicate whether a physician's appointment is needed to discuss the new symptom. By entering yes and entering a desired dated of appointment in boxes 220, the device 10 records a reminder to make an appointment in the calendar of the device. Likewise, when an appointment is actually scheduled, this is incorporated into the calendar. If the requested date is not available, and error message (such as a pop-up message) can be displayed to the user to let he/she know to input a different date and/or time.

FIGS. 15B-15C illustrate a function for adding a new symptom from the diagnosis details screen. The diagnosis details screen 185 provide a list of potential symptoms associated with the selected diagnosis. The user can select on the chevron 231 associated with a symptom that is desired to be added for tracking. A symptom details screen 233 for the selected symptom is then displayed, see FIG. 15C. The user is prompted to enter the date 235 that the selected symptom began, which date is then used by the track and treat program. If “no” is entered in box 218, then no action is taken in regard to setting up a physician's (doctor's) appointment. If “yes” is entered in box 218, but no date is entered into box 220, then a reminder is created (and displayed when home screen 102 is displayed) to schedule a doctor's appointment to address this symptom.

FIGS. 15D-15F show various embodiments of reminder screens that may be displayed according to the present invention. In FIG. 15D, reminders screen 241 lists categories 243 of reminders for each patient. A specific category can be selected to display more specific information, including dates and times for entries within that category. FIG. 15E shows a reminder screen 245 that list specific reminders, organized by patient and then by times that they are reminding for. FIG. 15F shows a reminder screen 251 that lists specific reminders order by times of occurrence that the reminders are provided for.

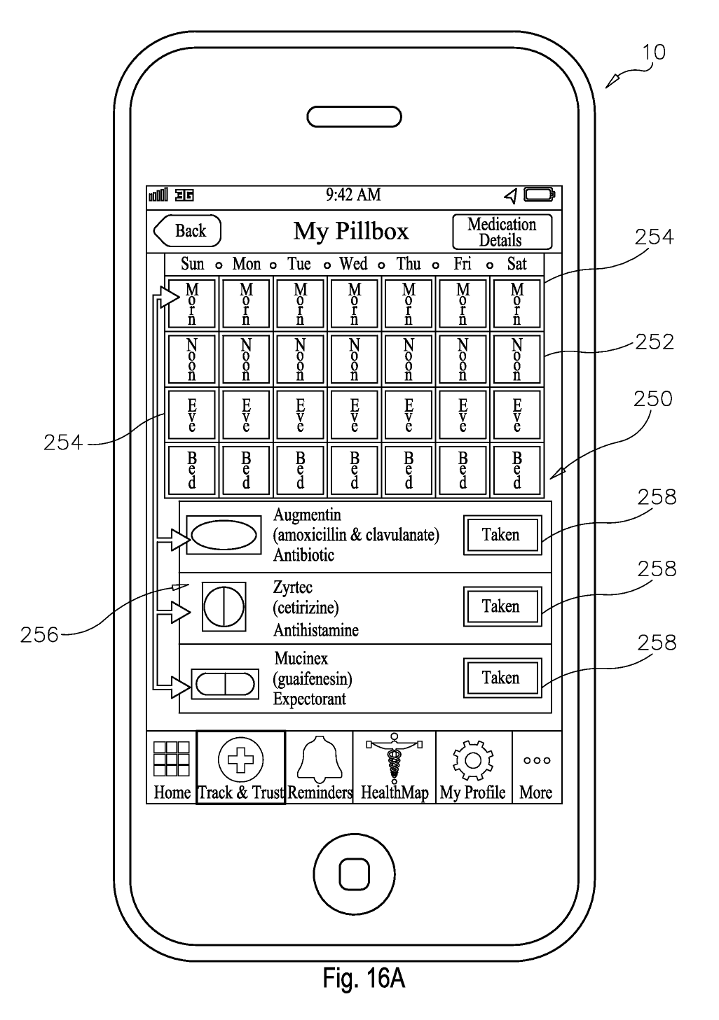

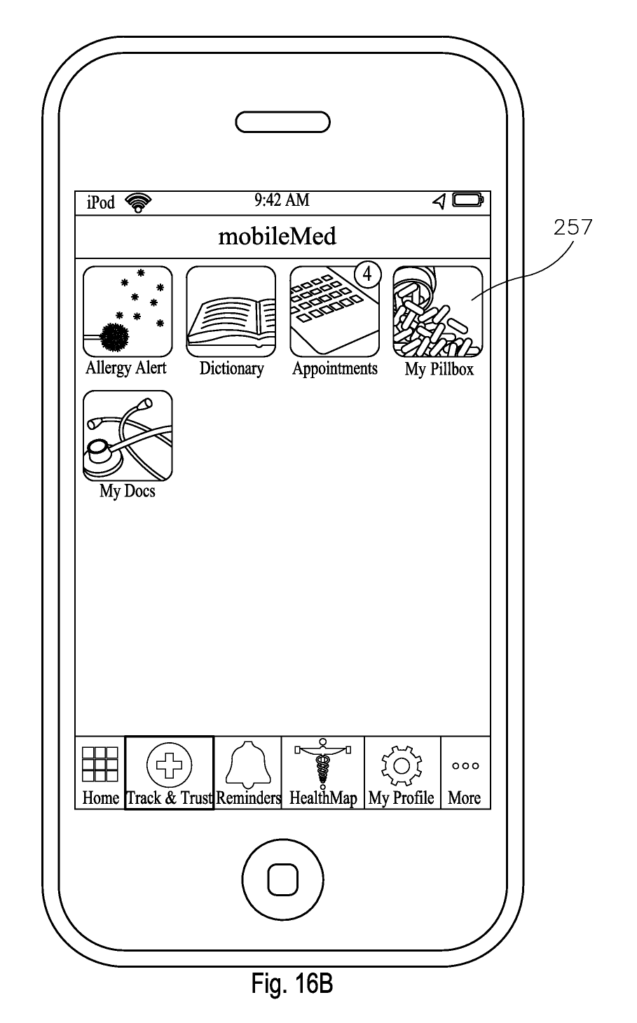

FIGS. 16A-18B show details displayed by the Pillbox tool of the present invention. Access to the pillbox tool can be made by selecting on an icon 257 provided on a home screen of the application, e.g., like that shown in FIG. 16B or provided in the tool tray 108 (not shown).

FIG. 16A is the initial screen 250 that appears when the Pillbox tool is invoked. The “My Pillbox” section 252 of the display is configured like an actual physical pillbox constructed to contain the medications. In this regard, compartments are displayed for each day of the week and one for each of a predefined number of different times of the day. In the example shown, there is a pill compartment 254 for each of four different times of day (morning, noon, evening and bedtime) for each of seven days of the week. It is noted however, that that My Pillbox section 252 is not limited to this configuration, as it can be customized by a physician or patient user to create compartments for any time of any day. Thus, each day of the week does not have to have identical compartments at identical times. If there is a medication to be taken only once a week at a specific time and the time does not match up with other times/compartments that medications are to be taken, a compartment 254 can be programmed for that particular day and time, for that medication specifically. Thus, the My Pillbox section is totally flexible in this regard and is not limited to any number of compartments or times of day, and the number/times can vary from day to day.

By selecting (tapping, when using a touchscreen, or selecting by some other input mechanism for the user) on a compartment, a list 256 is displayed that shows medications that are supposed to be taken at that time on that day, and a check box 258 is provided for each of the displayed medications. Upon selecting on the checkbox, the display in the checkbox can either show a checkmark, or can indicate “Taken” as shown in FIG. 16, or can display some other indicator that the user has checked the box 258 off to indicate that the medication was taken. In the example shown in FIG. 16, the compartment 254 for Sunday morning has been selected, resulting in a display of Augmentin, Zyrtec and Mucinex, and boxes 256 indicate that all of these doses have been taken by the patient.

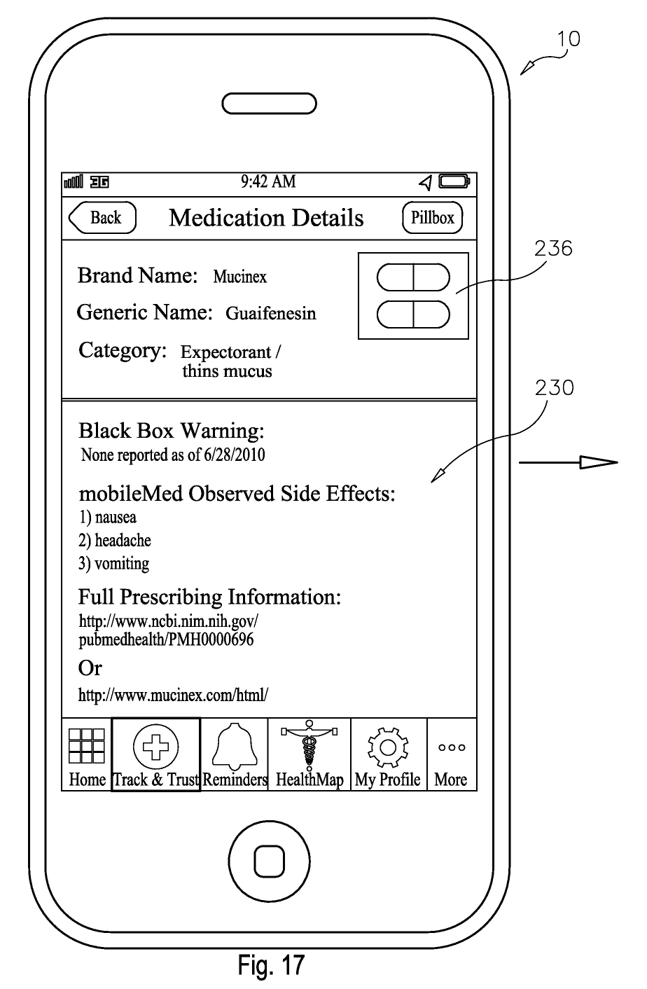

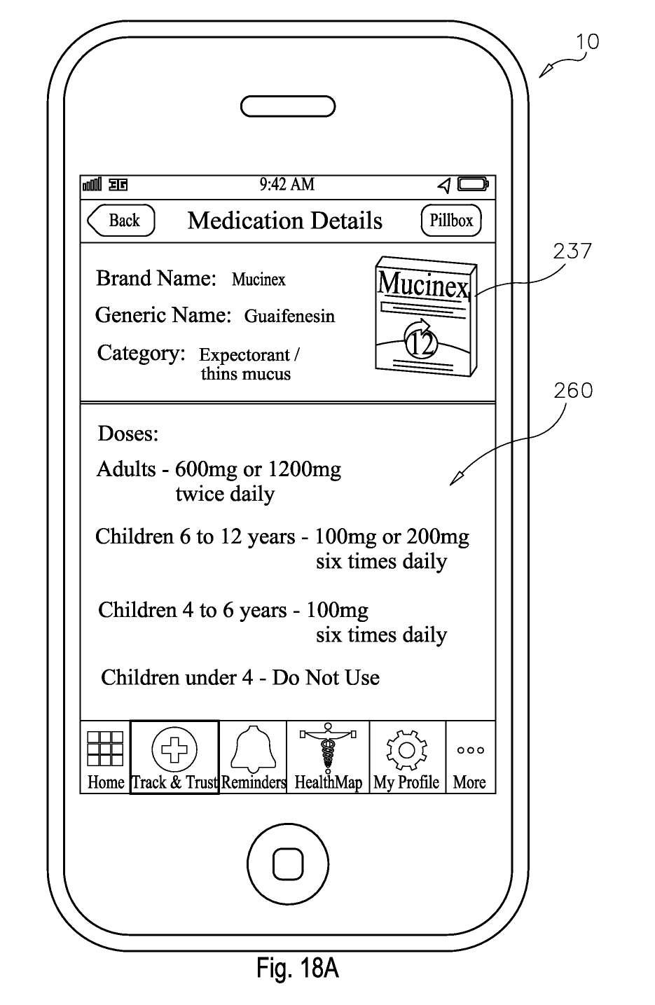

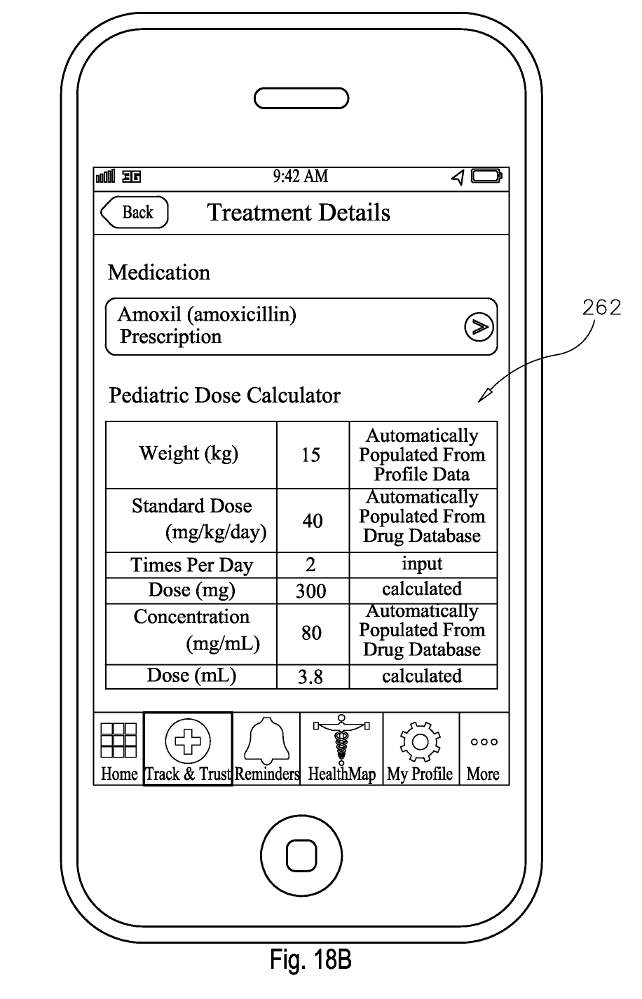

By selecting on a specific medication (e.g., Mucinex, in the example shown in FIGS. 16A-18B), the medication details screen 230 is displayed for that specific medication, as shown in FIG. 17. Note that the display of FIG. 17 is the same as that shown and described in FIG. 14, except that it displays the details for Mucinex rather than Augmentin. By rolling over the image 236 of the dosage form for the displayed medication, the image changes from an image of dosage form 236 to an image of the medication package 237 as shown in FIG. 18. By scrolling down on the display in FIG. 17, additional information, such as recommended doses 260 are displayed, see FIG. 18. For those medications that do not list pediatric doses, a pediatric calculator (FIG. 18B) 262 may be provided in device 10. When medicines are prescribed for children, the system may use the child's weight from the profile data, retrieve the standard adult dose and concentration data for the medication from a drug database, and then calculate the child's dose based on this information. The number of doses per day is inputted by the child's care provider (physician).

FIG. 14 shows a medication details screen 230 for “Augmentin 500 mg, the view details 209 function for that medication having been selected in FIG. 13. The medication details screen 230 is a display from the current Pillbox tool, which contains all the details of the medications that the patient is currently prescribed/recommended to take. The medication details screen 230 of the Pillbox tool lists the brand name 232 of the selected medication, the generic name 234 of the selected medication and displays an image (preferably a photo) 236 of the specific medication that is listed in the treatment plan. The category 238 of the medication is also displayed. A black box warning section 240 lists any black box warnings that have been published for the selected medication. If there are no black box warnings current for the selected medication, then that message is conveyed in the black box warning section 240, as shown in the example of FIG. 14. The Allergy Alert section 242 lists any generic allergy categories that the selected medication may fall under.

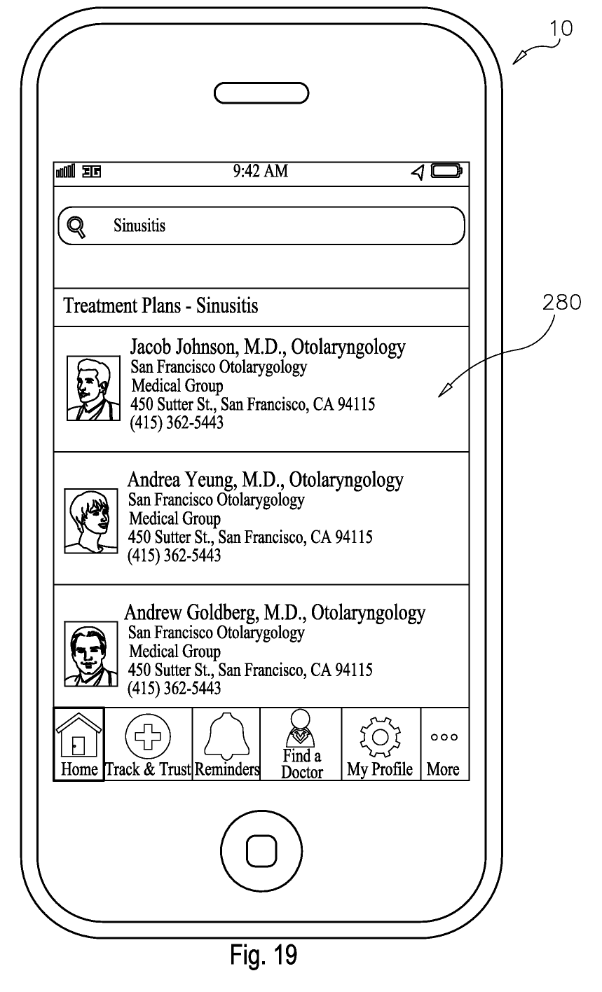

FIG. 19 shows a display screen 280 for recommended doctors for a selected diagnosis. Also, the present invention provides a “My Doctors” tool that contains providers that the patient has visited in office, or had a virtual office visit with or similar treatment experience. “Find a Doctor” is a HealthMap feature that identifies providers that are approved by the system and which the user can choose to interact with.

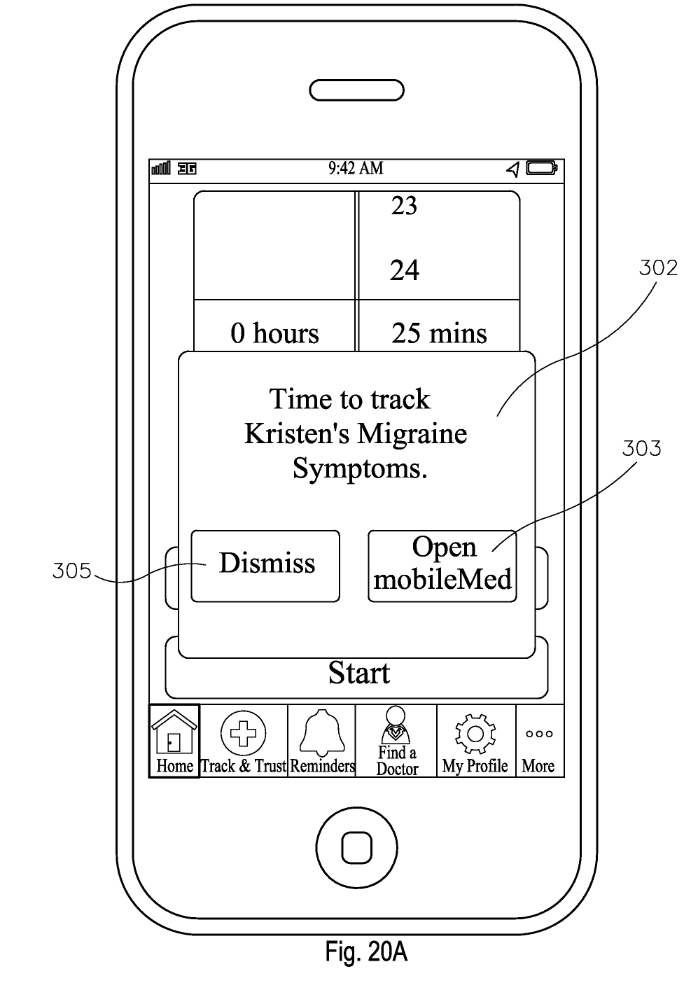

The Track and Treat tool of the present invention includes a symptom tracking feature that prompts the user to input the severity of symptoms being tracked (e.g., see FIGS. 15A-15C) on a regular basis. The default period for “regular basis” is one day, but this can be edited to shorten or lengthen it. The regularly entered data is then tracked by the track and treat tool relative to other parameters, which may include, but are not limited to: medication use, home remedy use, time since a surgical procedure, diet, exercise, sleep, exposure to allergens, and/or adherence to treatment plans, that may be selected by the doctor and patient, to identify factors that improve or worsen the symptoms being tracked. FIG. 20A illustrates a reminder display 301 that pops up and is displayed each time the regularly occurring period ends to prompt the patient user to enter data concerning a diagnosis or a specific symptom. Note that this reminder function operates even when the application is not actively open on device 10. Therefore, the display 301 provides a selector 303 to open the application for data entry if the application is not already open. Alternatively, the user can choose to dismiss the reminder by selecting on the dismiss button 305. In cases where the application is already open, the open button 303 opens the same display that the application automatically navigates to upon selecting button 303 when the application is not open. In either case, a display 290 is provided as shown in FIG. 20B. By adjusting the slider 292 along slider bar 294, the patient user can indicate on a continuously adjustable basis, whether the patient is feeling much worse 296, neutral 298 or much better 300 (or somewhere in between the icons 296 and 298 or between 298 and 300) about the symptom (or how the patient is feeling overall about the diagnosis, when a diagnosis is selected rather than a specific symptom). The patient user can close the display 290 by selecting on the button “Dismiss” 302 if he/she wishes to delay entering his/her data into the application. After entry of the data about how the user is feeling for the symptom or diagnosis, the patient will typically select 304 to log the symptom/diagnosis data that was just entered. As noted above with regard to FIG. 1, the Track and Treat tool further provides automated reminders of scheduled and needed physician's (doctor's) appointments. The Track and Treat tool is also synched with the Pillbox tool and data of the Pillbox tool to provide automated reminders to take medication and to provide automated reminders when prescriptions need to be refilled, e.g. see FIG. 1. The Track and Treat tool can be further configured (by a physician or other healthcare provider user that is treating the patient user) to track duration of the existence of one or more symptoms; and to send, display or audibly playing a reminder to make a physician's appointment when the duration of one or more of the symptoms exceeds a predetermined time. Different predetermined time periods may be set for different symptoms, or, alternatively, all symptoms may be tracked against the same predetermined time period. Further, automated synching of events in the application of the present invention with the calendar of the device 10 in this case causes a reminder to make a physician's appointment to appear in the patient user's main phone calendar to remind the patient to make a physician's appointment.

The present system may optionally include a web-based survey tool that can be accessed by selected physicians. Ultimately, the selected physicians will be experts, defined as most often, but not limited to, board-certified medical professionals who are recognized by their peers as leaders in cuffing-edge treatment of a group of diagnoses. FIG. 21A is a schematic illustration of a connection server 400 of the present invention that can be accessed by the selected physicians in order to participate in the web-based survey tool. Access to the connection server 400 may be over the Internet 401, wherein any web-enabled type of computer can be used to access the connection server, including, but not limited to a desktop computer 402, laptop computer 404, smartphone 10, or PDA or other web-enabled mobile computing device (tablet, etc.) 10′. Additionally, access may be by telephone, including any wireless telephone protocols that a device 10 or 10′ may be operating under. Users will have the option of setting a personal identification number (PIN) to facilitate security. Encryption may also be used to further enhance security of text messaging, emails, synchronizing to another computer (such as laptop or desk top), logging into any web-based portals, and information sharing between phones.

Upon accessing the connection server 400 each selected physician can access a survey from a web-based survey tool provided to connection server 400. FIG. 21B illustrates an embodiment of a survey 410 that is providable from connection server to a selected physician. The selected physician inputs data in response to items requested regarding their best practices, which may include, but are not limited to: medical specialty 412, diagnosis 414 for which the selected physician will be writing a treatment plan, diagnosis description 416 and diagnosis symptoms 418. The survey 410 is designed to solicit knowledge (including unique knowledge or knowledge “pearls”) that the selected physicians have learned that could prevent misdiagnosis or poor treatment outcomes, to provide differential diagnoses that are often linked with the diagnosis in question, to identify side-effects of medications observed in the selected physicians' practices, to identify home remedies that improve overall quality of life, and/or to provide resources for patients and patients' families to help them participate in their own health care.

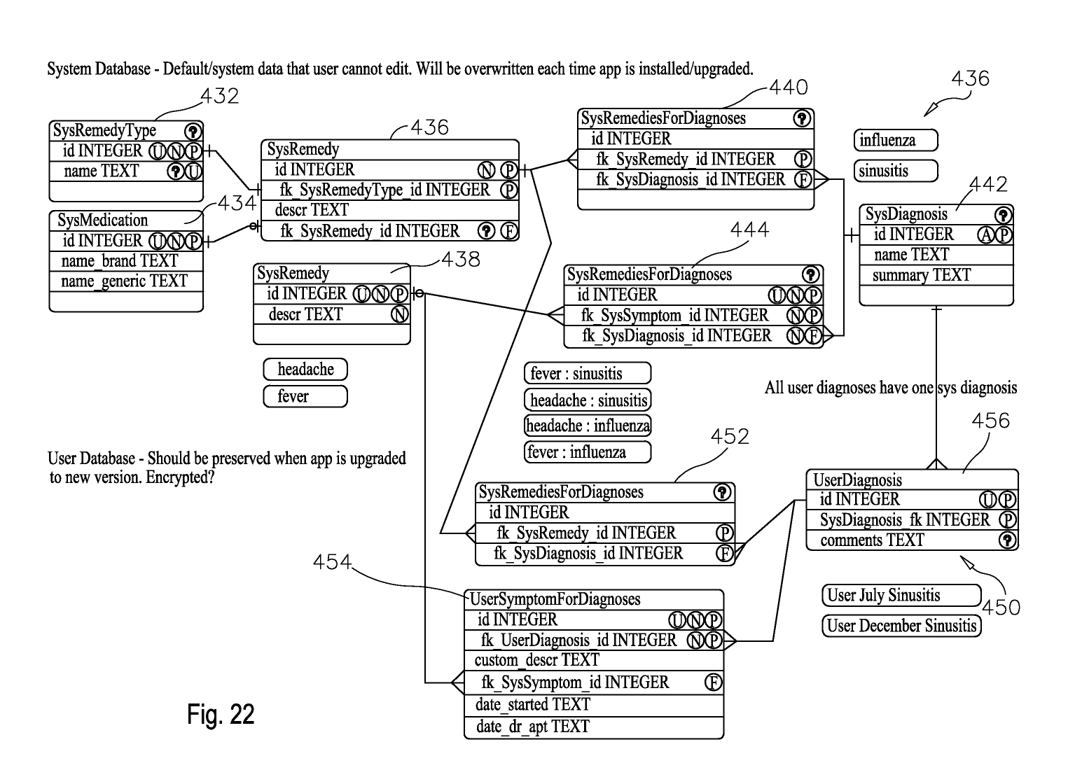

The data inputted to survey 410 are automatically downloaded into database 408 (FIG. 21A). This database 408 can be accessed by administrators for updates, queries and editing. FIG. 22 illustrates a data model depicting the various data objects used in the software according to an embodiment of the present invention. The boxes represent objection the software and the lines connecting the boxes represent relationships between the objects.

Data model 450 illustrates a scheme of the system database 408, which contains the default/system data that a user cannot edit. Only an administrator can edit data in the system database 408. This data will be overwritten each time the application of the invention is installed or upgraded in a device 10. Scheme 450 illustrates a scheme of the user database that is contained within a device 10 miming the application of the present invention. The data in the user database is preserved when the application miming on the user's device is upgraded or reinstalled. The data of the user database may optionally be encrypted for privacy. Upgrades to the database 408, such as by the addition of data from additional selected physicians, or any other upgrades that are made to the application of the invention, are provided to all users and can be sent via the Internet, over a wireless phone transmission, physically by mail, etc.

Reference numeral 430 represents objects used to store and retrieve system data that the user is not allowed to modify. Reference numeral 450 represents objects for the user's own personal data and information that the user is allowed to edit, delete etc. This data also persists when system data is upgraded and/or overwritten. System remedy type data 432 and System medication data are integrated into System remedy data and sent to user databases 450 to upgrade User remedies for diagnosis 452. System symptom data 438 is sent to the user databases 450 to upgrade the User symptoms for diagnosis data 454. System remedy data 436 is incorporated into System remedies for diagnosis 440 and into System diagnosis data 442. System symptom data 438 is incorporated into System symptoms for diagnoses data 444 and into System diagnosis data 442. All user diagnoses have one system diagnosis. The System diagnosis data 442 is sent to user databases 450 to upgrade the User diagnosis data 456. As noted above, devices 10, 10′ may be synchronized with a desktop computer 402 or laptop computer 404 such as by docking therewith and performing a synchronization function.

The system database 408 can be data mined by an administrator or through use of an automated data mining tool programmed to identify and obtain predefined data, data types, other predefined data categories or specific data. The data resulting from the data mining can then be used to update the user databases 450. Data resulting from data mining is not limited to text data, but may include graphical data. Additionally data resulting from data mining may be used to generate at least one graphical representation of the mined data.

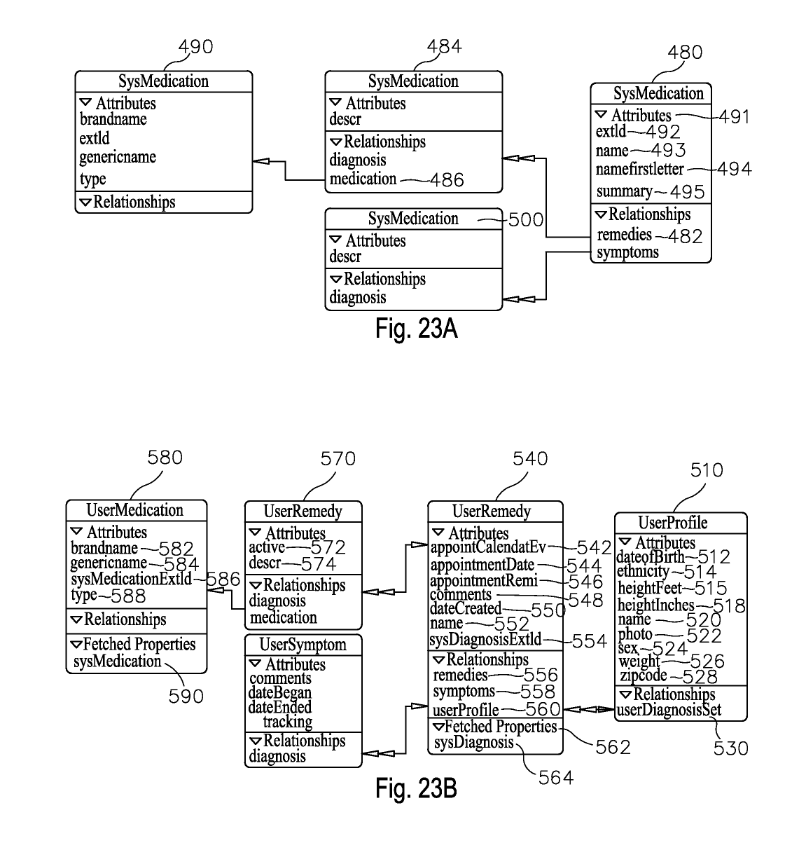

FIGS. 23A-23B are data models describing an example of information based on the logical information flow of a standard physician's office visit according to an embodiment of the present invention. At the system diagnosis screen, which may be accessed by the physician from a device 10, or other web-enabled computer (e.g., 402, 404, 10′) 480, the physician may select a diagnosis of the patient that the physician has decided upon. A diagnosis may be searched for by selecting one or more attributes 481 of the patient's condition, inputting or selecting on an extid (external identification code, which is unique for each user) 492, inputting or selecting a diagnosis name 493, or inputting a first letter 494 of a diagnosis to navigate to the first letter of the diagnosis in an alphabetical listing of diagnoses, and then scrolling to the desired diagnosis. A summary description of the diagnoses is provided at 495. By selecting remedies 482, the system remedy screen 484 is displayed and the physician is provided with various remedies that may be used for the patient's diagnosis, including medications (prescription and/or over the counter) and home remedies. By selecting medication 486, the system medication screen 490 is displayed. From the system medication screen, the physician can research medications that are recommended for prescribing to treat the selected diagnosis. Such information includes attributes 491 of each identified medication, brand name 492, extension ID 494, generic name of the identified medication and type of medication.

By selecting symptoms 484 in screen display 480, the System symptom screen 500 is displayed. From screen 500 symptoms that have been associated with the selected diagnosis are listed. For each symptom, attributes 502 of the symptom are described in relation to the selected diagnosis. The physician can select the appropriate medications from screen 490 and symptoms from screen 486 to be incorporated into the diagnosis screen for the patient user.

In FIG. 23B, the user profile data 510 which may be displayed in the profile screen 140 may include, under attributes, date of birth 512 of the user patient, ethnicity 514, height 516, 518, name 520, photo 522, weight 526 and zip code 528 of residence of the user patient. The user profile is lined in relation to the User Diagnosis dataset.

The User Diagnosis tool includes attributes of an appointment calendar event identifier 542, appointment date 544, appointment reminder enablement tool 546, comments 548 (which can be entered by the physician as well as the patient user, date 550 that the diagnosis was created, name 552 of the diagnosis, and systemDiagnosisExtId 554. The “Fetched Properties” category 562 contains data that has been downloaded from the System database 408 as a result of the physician's entries into the system database in regard to the patient during the physician's visit, as contained as sysDiagnosis 564.

In relationship with the particular diagnosis described in the User Diagnosis 540 tool are User remedies 556 , User symptoms 558 and the User profile 560. The User remedy tool may display attributes of each remedy that is associated with the selected diagnosis, and which has been prescribed by the physician. The User remedy tool/screen 570 lists attributes of the remedy that has been prescribed by the physician for the selected diagnosis, including active 572 (meaning that it is an ongoing medical issue, as opposed to an “inactive” or “past” diagnosis that may: a) affect the treatment plan for an unrelated diagnosis, or b) remains in the patient's medical history for reference) and a description 574 of the remedy. In addition to being linked to User diagnosis 540, User remedy is also linked to the User medication tool/screen 580. For each medication having been prescribed by the physician for the selected diagnosis, the brand name 582, generic name 584, system medication identifier 586 and medication type 588 are provided. Fetched properties 590 are data received from System Medication tool 490 as indicated at 590.

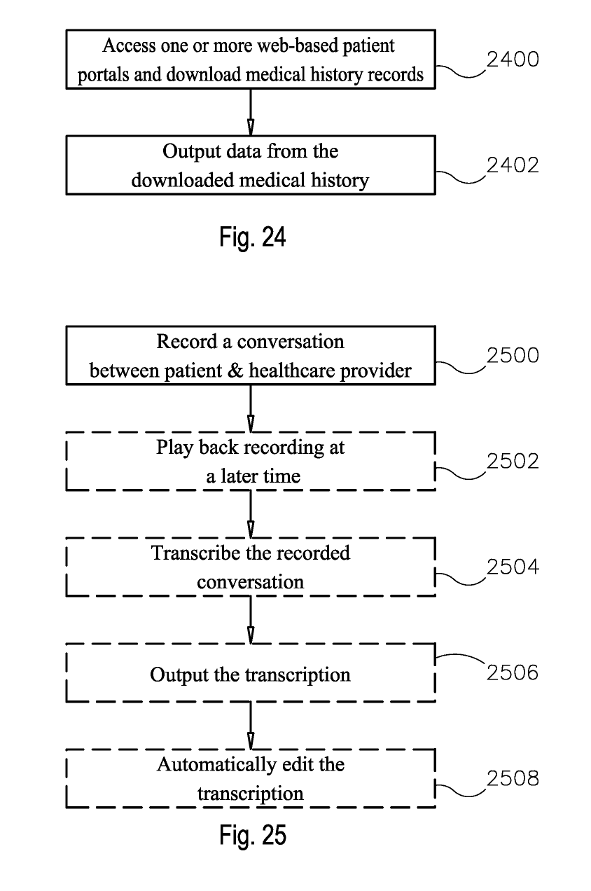

FIG. 24 is a flow chart illustrating events that may be carried out according to an embodiment of the present invention. At event 2400, device 10 accesses one or more web-based patient portals and download medical history records of the patient user from the one or more web-based portals, based upon a user profile including personal information that uniquely identifies the patient, Note that this action is not limited to a patient user, as a physician or other health care professional treating the patient and/or which is authorized to access the user's profile and medical records may perform this action with device 10 and any passwords or other identification data need to access that particular patient's profile. Examples of web-based patient portals that may be accessed include, but are not limited to Google Health, Mudfusion/Intuit Health, NextGen and AthenaHealth. The user can select a PIN to ensure security regarding who is accessing the information. Also, when transmitting personal health information (PHI) between devices, computers, etc. the PHI transmissions may be encrypted, and one or more firewalls may be employed where appropriate. At event 2402, the data from the downloaded medical history of the patient can be outputted to at least one of the patient user of device 10 and a physician having access to the patient's medical records, such as the treating physician.

FIG. 25 illustrates a flow chart of events that may be carried out according to an embodiment of the present invention to record a conversation between a patient user of device 10 and a health care provider, or between a health care provider user of a device 10 and the patient. Further, such conversation may be recorded at both ends of the conversation when both parties are using the present invention, such as both using devices 10. At event 2500 a conversation between the patient and healthcare provider (such as the patient's physician or other healthcare provider) is recorded. The recording may optionally be later played back 2502 by the recording party. Thus, for example, a patient user may optionally use device 10 to play back the physician's instructions once the patient has returned home. Additionally, or alternatively, the recording (voice memo) may contain a hospital discharge summary and/or follow-up care recommendations.

Further optionally, the present invention may be manually instructed, by the user, or may be configured to automatically transcribe the recorded conversation for outputting a transcribed version of the recorded conversation. Further optionally, the invention may be programmed to automatically perform, or may be manually selected by a user to perform outputting of the transcribed recording 2506. Such outputting may include, but is not limited to one or more of: printing the transcribed recording; providing voice recognition highlight of a chief complaint by the patient during the conversation; automatically incorporating the transcribed recording into the physician's electronic medical record regarding the patient; automatically incorporating the transcribed recording into the patients electronic medical record stored in the mobile medical computing device; automatically electronically sending the transcribed recording over the Internet or by wireless text transmission to another database of the patient, into the patient's electronic medical record stored in the mobile medical computing device; automatically electronically sending the transcribed recording over the Internet or by wireless text transmission to another physician's electronic medical record regarding the patient and/or automatically incorporating the transcribed recording into the other physician's electronic medical record regarding the patient.

Further optionally, the present invention may be programmed to automatically edit the transcription, thereby creating a detailed visit note meeting requirements for transmitting to an insurer or another provider. Optionally, the detailed visit note may be automatically transmitted to an insurer or another provider.

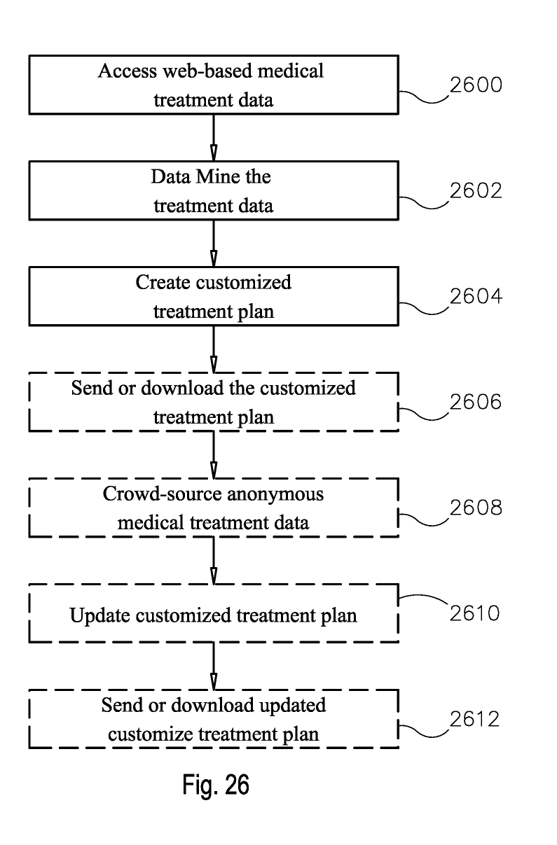

FIG. 26 is a flow chart illustrating events that may be carried out according to an embodiment of the present invention in providing a customized treatment plan relative to a locality of the patient. In general, a treatment plan, whether it be a Generic Treatment Plan offering treatment options for treatment of a specific diagnosis, a Smart Treatment Plan offering treatment options for treatment of a specific diagnosis when a patient profile has been inputted by a user inputting personal data, or a Symptom Relief Plan offering treatment options for treatment of one or more identified symptoms, where a diagnosis has not yet been given, can be generated with the aid of specific data and weighting contained in the database 408 and/or other location connectable to the connection server 400, regardless of whether or not the treatment plan is being customized relative to the locality of the patient.

Symptoms that apply to the user (typically as identified by the user or user's physician, as noted above) are relatively weighted according to the likelihood that they contribute to a given diagnosis. Weighting of “1” represent key symptoms associated with a given diagnosis. For example, a key symptom for a diagnosis of “sinusitis” is “colored mucus”. Accordingly, if a user inputs “sore throat” and “sneezing” the system would no list sinusitis as a diagnosis. However, if the user then added “colored mucus” as a symptom, the system would add sinusitis to the list of possible diagnoses. In the example, for the diagnosis of “sinusitis”, the symptom “colored mucus” is assigned a weight of “1”, the symptom “facial pain” is assigned a weight of “2”, the symptom “sore throat” is assigned a weight of “3”, the symptom “tiredness” is assigned a weight of “2”, the symptom “cough” is assigned a weight of “2”, the symptom “sneezing” is assigned a weight of “3” and the symptom “headache” is assigned a weight of “2”. Additionally information is provided as to differential diagnoses (alternate diagnoses) that could share one or more of the same symptoms. For example, for the diagnosis of “sinusitis”, differential diagnoses are listed as Acid Reflux, Esophageal Reflux, GERD, Allergic Rhinitis. Asthma, common cold, dental condition, migraine, mononucleosis, pneumonia, Temporomandibular Joint Disorder (TMJ), tension headache, walking pneumonia, atypical pneumonia, mycoplasma pneumonia, ear infection, post nasal drip, upper airway cough syndrome, vasomotor rhinitis or flu. All of these differential diagnoses are associated with sinusitis in that they share common symptoms. Identification of The severity of the various individual symptoms helps weed out less relevant potential diagnoses in the list of differential diagnoses, and ultimately determine a single diagnosis that best fits the list of symptoms and relative severities of the various individual symptoms.

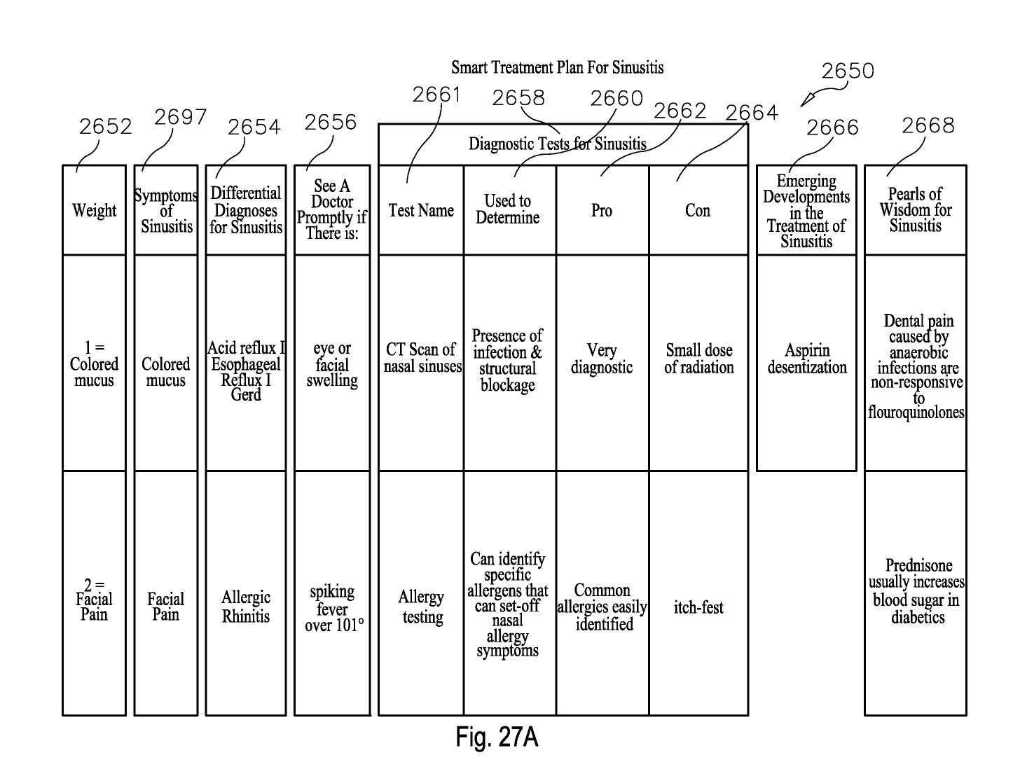

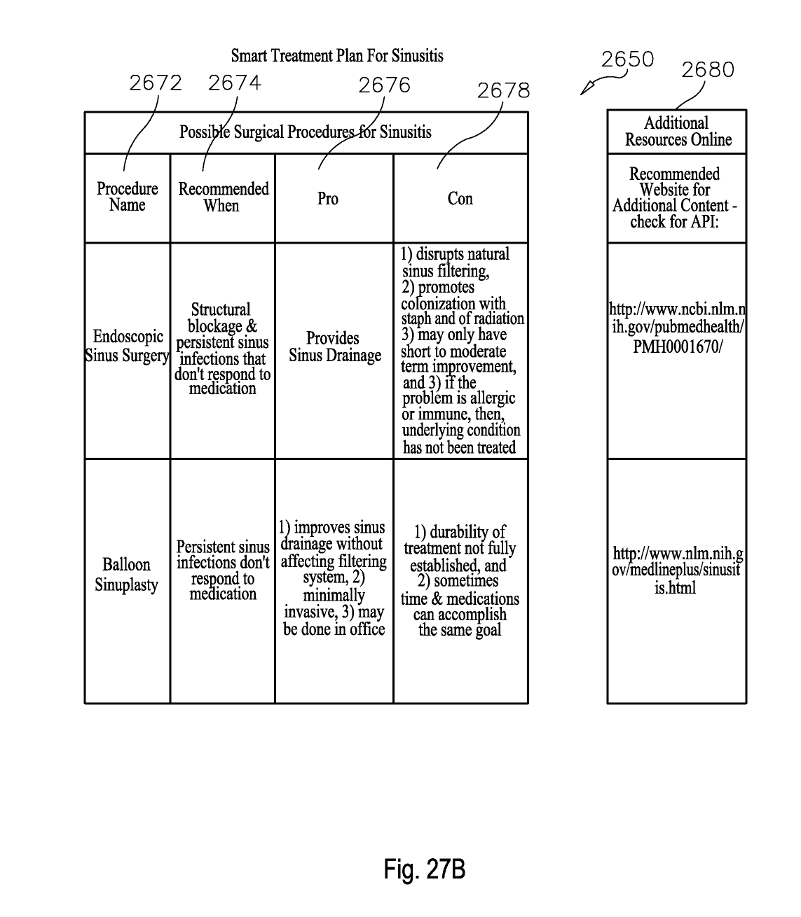

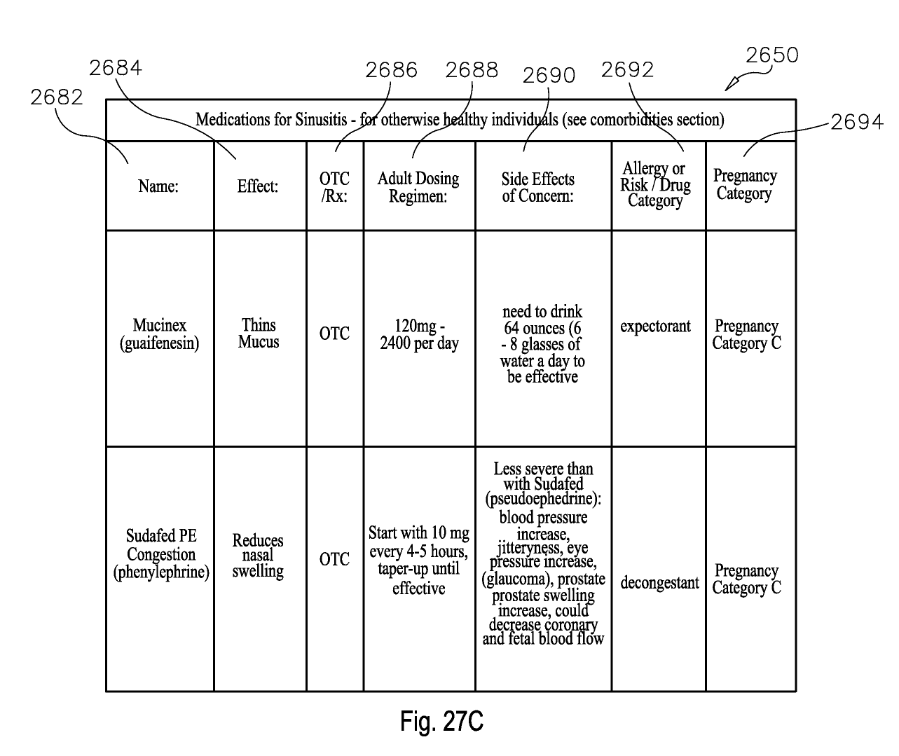

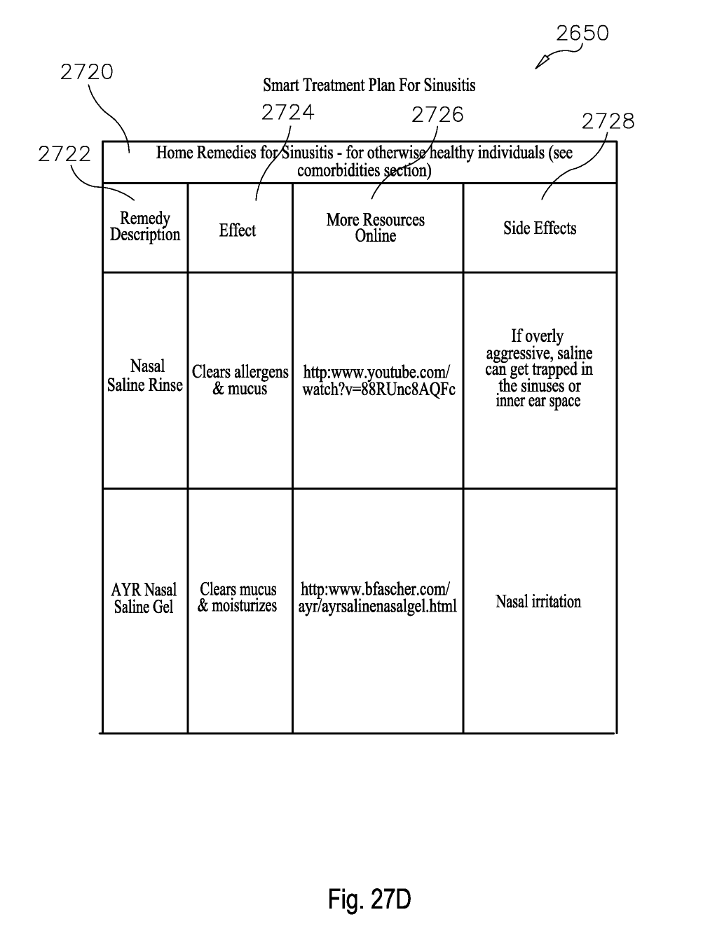

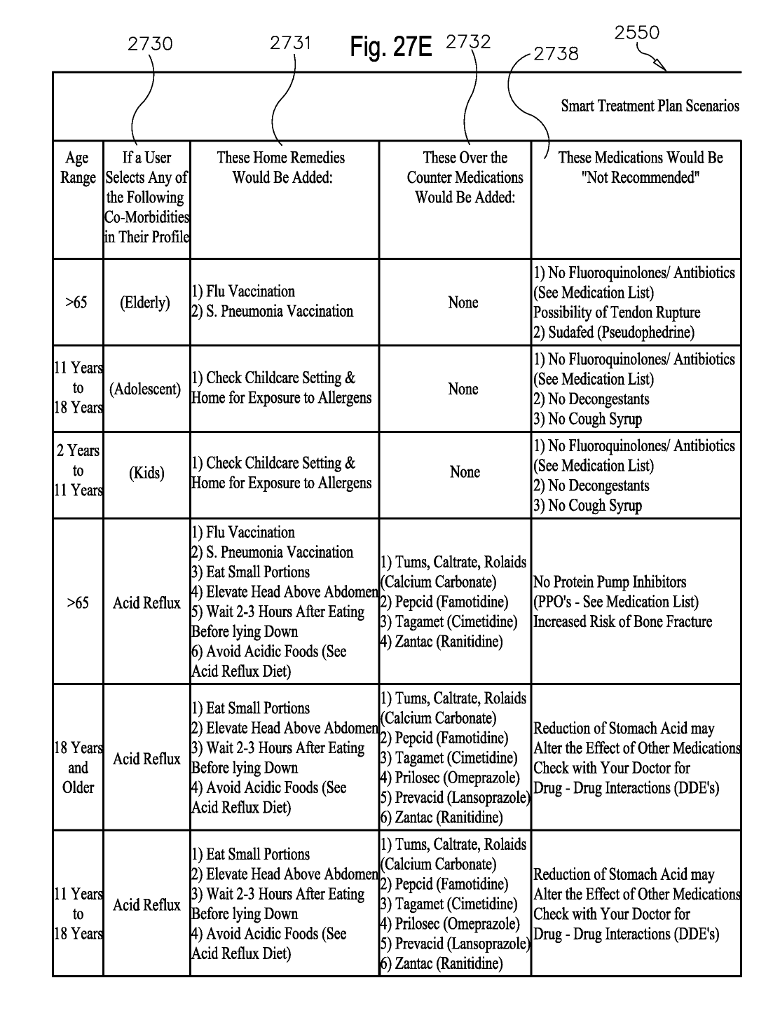

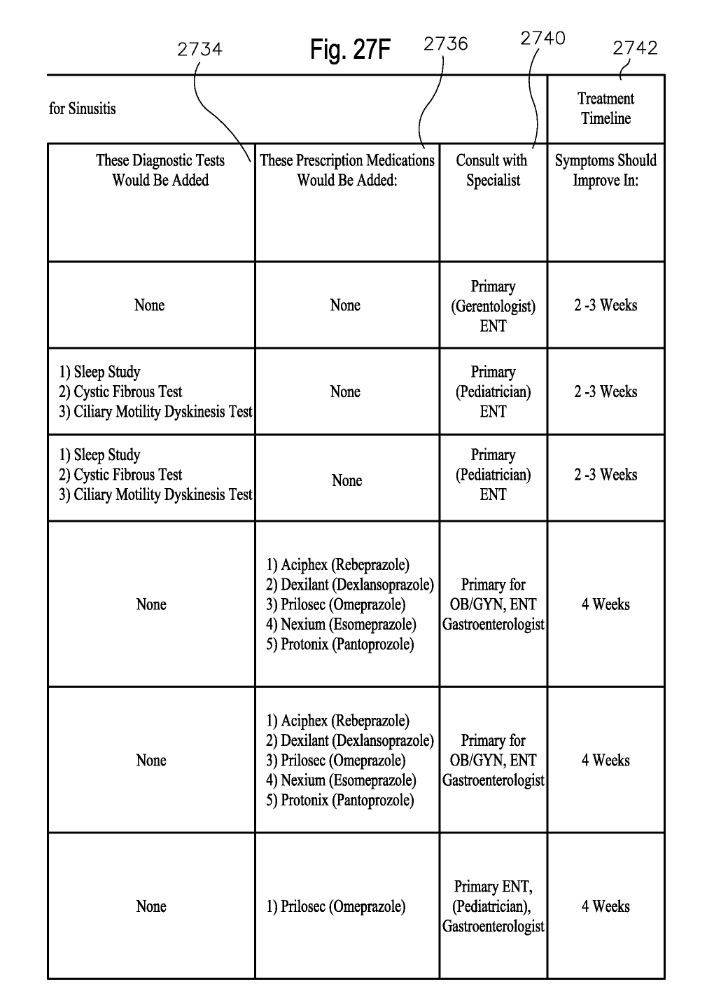

FIG. 27A illustrates an excerpt 2650 of the information described above that is accessible by the system, such as from a database, such as database 408 for example. It should be noted, that an excerpt is provided for clarity, and that the available information is much greater than that which is shown, that which is shown being only exemplary. As noted above, a weight 2652 is assigned to each of the listed symptoms 2697. Likewise a list of differential diagnoses 2654 are provided. Differential diagnoses 2654 are the possible diagnoses associated with a given set of symptoms, as noted above. Warnings 2656 to see a doctor are provided to the user which list specific symptoms, that, if experienced, indicate that the user/patient should see a doctor to be treated. Diagnostic tests 2658 are provided, along with indications 2660 of what each test is used to determine, so as to help arrive at a diagnosis. The pros 2662 and cons 2664 of each diagnostic test 2661 are provided to help the doctor and patient in determining appropriate tests to use. Emerging developments 2666 in the treatment of the diagnosis being considered are also listed for consideration and possible inclusion in the customized treatment plan, or for discussion topics between the patient and treating doctor. Also, “pearls of wisdom” 2668 are provided, which are further valuable facts learned in prior cases and/or research which may be useful in attending to the diagnosis being considered.

Further considerations for the preparation of a customized treatment plan include possible surgical procedures and medications for treatment. FIG. 27B illustrates an excerpt of the information described above data used to create a Smart Treatment Plan for sinusitis offered for a specific patient based upon that patient's inputs to the system. The data is typically password-protected by the user, accessible by the user or persons the user chooses to share the data with. The data is used to create the Smart Treatment Plan as displayed on a computer, such as mobile device 10, or other computer, as described in more detail below. It should be noted, that an excerpt is provided for clarity, and that the available data/information is much greater than that which is shown, that which is shown being only exemplary. As noted above, possible procedures 2672 for treatment of the diagnosis are provided, as well as indications 2674 as to when each treatment is recommended, and the pros 2676 and cons 2678 of using the procedures. Additional online resources 2680 are identified for access by the patient user and/or doctor user.

In the excerpt of the Smart Treatment Plan for Sinusitis data continued in FIG. 27C, medications for treating the diagnosis are also listed, including medication name 2682, medication effect 2684, whether the medication is available over-the-counter or by prescription only 2686, the recommended adult dosing regimen 2688, and side effects of concern 2690. Allergies or risks, if any, as well as drug category are listed at 2692, and pregnancy category is listed at 2694. Pregnancy categories are assigned by the Food and Drug Administration (FDA) as a guide to the potential risk to the fetus when medication is used by a pregnant woman. Category A is assigned to a medication where adequate, well-controlled studies in pregnant women have not shown an increased risk of fetal abnormalities in any trimester of pregnancy. Category B is assigned to a medication where animal studies have revealed no evidence of harm to the fetus, but where there are inadequate, well-controlled studies in pregnant women; or in cases where animal studies have shown an adverse effect, but adequate and well-controlled studies in pregnant women have failed to demonstrate a significant risk to the fetus in any trimester. Category C is assigned to a medication when animal studies have shown an adverse effect and there are no adequate and well-controlled studies in pregnant women; or in cases where no animal studies have been conducted and there are no adequate and well-controlled studies in pregnant women. Category D is assigned to a medication when adequate well-controlled or observational studies in pregnant women have demonstrated a risk to the fetus, but when the benefits of therapy may outweigh the potential risk. For example, the drug may be acceptable if needed in a life-threatening situation or serious disease for which safer drugs cannot be used or are ineffective. Category X is assigned to a medication when adequate well-controlled or observational studies in animals or pregnant women have demonstrated positive evidence of fetal abnormalities or risks. The use of the product is contraindicated in women who are or may become pregnant.

In the excerpt of the Smart Treatment Plan for Sinusitis data 2650 continued in FIG. 27D, home remedies for treating the diagnosis 2720 are also listed, including remedy description 2722, effect 2724 produced by taking the remedy, online resources 2726 to access for more information about the particular remedy 2722, and side effects 2728 that may occur by taking the remedy. Both the Medications section (FIG. 27C) and the home remedies section 2720 of the data 2650 refer to the co-morbidities section for further guidance. The co-morbidities section 2730 is shown in the excerpt of the Smart Treatment Plan for Sinusitis data 2650 continued in FIGS. 27E-27F Based upon co-morbidities 2730 (FIG. 27E) that exist along with the diagnosis (in this example, sinusitis), data is provided as to additional home remedies 2731 (FIG. 27E), if any; over the counter medications 2732 (FIG. 27E), if any; diagnostic tests 2734 (FIG. 27F), if any; and/or prescription medications 2736 (FIG. 27F), if any; can be added to also treat the co-morbidity(ies). Additionally identified are medications that would be “Not recommended” 2738 when a particular co-morbidity exits. An indication 2740 is provided if a visit to a specialist physician is recommended, in view of the diagnosis and co-morbidity(ies), or alternatively, an indication that a primary physician is sufficient, is given. A treatment timeline 2742 is also provided in which an estimated time is provided after which symptoms should improve once the treatment plan has been started and followed.

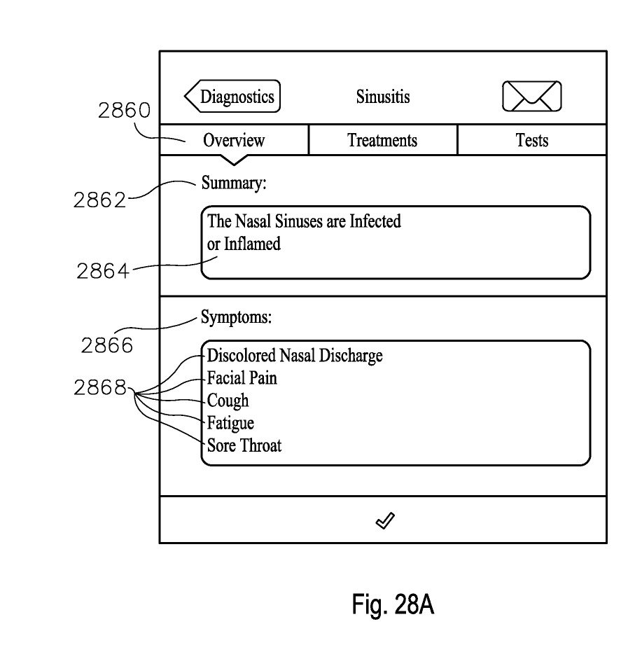

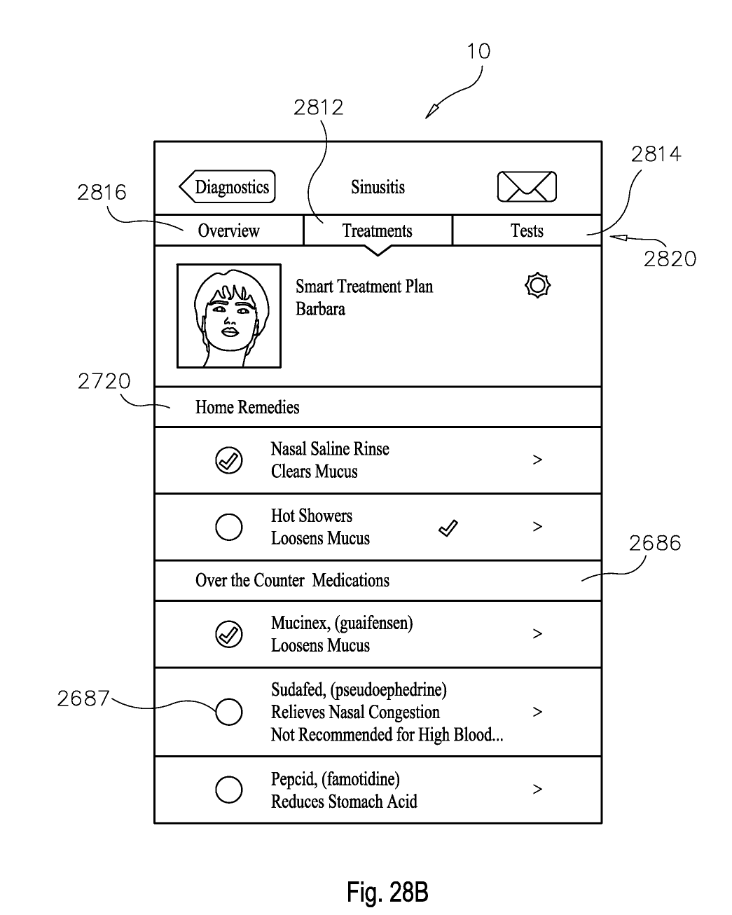

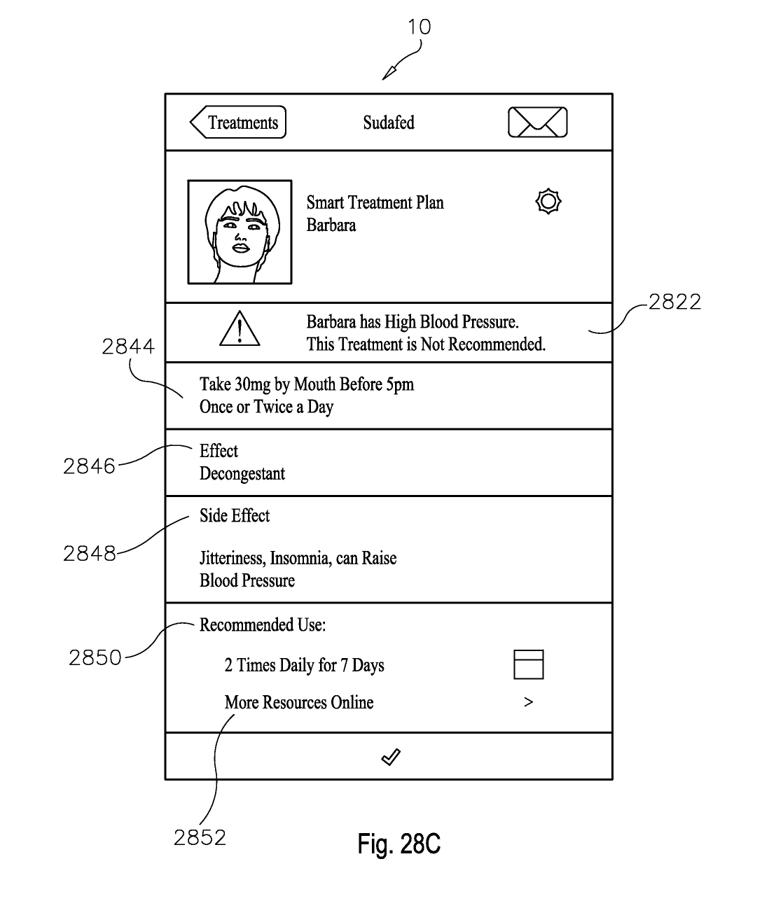

FIGS. 28A-28C are exemplary screen shots of displays outputted from the data 2650 contained in the database for the “Smart Treatment Plan for Sinusitis” described above with regard to FIGS. 27A-27F. In the example of FIGS. 28A-28C the screen shots are from Smart Treatment Plan data displayed on a smart phone 10. Additionally or alternatively, the Smart Treatment Plan can be displayed on any of the other devices 10 and computers 2700 described herein, and may be electronically transmitted, printed out, or otherwise outputted for use by a user in addition or alternative to viewing the screen shots. FIG. 28A shows a display of the overview 2860 information regarding the diagnosis, the user having selected the overview button 2860 on the display. Included in the overview is the summary 2862 that includes a brief description that summarizes the description of the diagnosis. Also displayed are symptoms 2866 where specific symptoms 2868 experienced by the patient user are displayed. Upon selection of the Treatments button 2812, treatments recommended by the Smart Treatment Plan are displayed, as in FIG. 28B. By selecting on the “Tests” button 2814 the recommended diagnostic tests would be displayed.

Upon selecting “Treatments” 2812 the screen shows Home Remedies 2720 and Over the Counter Medications 2686. If any prescription medications are recommended, they are also shown in this display. In FIG. 28B, upon selection 2687 of the over the counter medication “Sudafed”, additional information about “Sudafed” is displayed, see FIG. 28C. Note that because this is a Smart Treatment Plan as opposed to a Generic Treatment Plan, the system has information that the patient has high blood pressure. Therefore a warning 2822 is displayed that the patient should not take Sudafed since she has high blood pressure. The standard treatment schedule 2844, effects 2846, side-effects 2848 and recommended usage 2850 are also displayed, as well as a button 2852 that can be selected to access more resources online.

It is noted there that a “Symptom Relief Plan” offers home remedies and over-the-counter treatments for users who want to alleviate a symptom without going through the process of identifying a diagnosis. A Generic Treatment Plan is viewable by any user for a given diagnosis. A Smart Treatment Plan is generated when a user inputs data into a profile—the generic treatment plan is then adjusted based on age, gender, pregnancy, comorbidities, allergies and medication use.

Returning to providing a customized treatment plan relative to a locality of the patient, FIG. 26, at event 2600, a user of device 10 (or physician using other computing device to access the system) accesses web-based medical treatment data pertaining to a patient being treated. This data is accessed from database 408 through connection server 400. The web-based medical treatment data accessed may be specific to one of a community that the patient lives in, zip code that the patient lives in or to the individual patient. An agreement to have the patient's data appear anonymously in the community data will be provided to each user, to agree to such display, prior to displaying it. From the web-based treatment data, data may be data mined 2602 using an algorithm or by a user browsing and selecting data therefrom. The data obtained by the data mining can then be used to create a customized treatment plan, according to the web-based medical treatment data accessed, data mined and downloaded, for example, to provide information such as that described above with regard to FIGS. 27A-27E. The customized treatment plan may be created by multiple practitioners, identified by the system as experts in the treatment of a given diagnosis, who write guidelines describing how they treat specific diagnoses. These guidelines are then peer-reviewed and edited. Once created 2604 at the level of the centralized database 408, the customized treatment plan, in this case, a Smart Treatment Plan, can be sent to or downloaded 2606 by the patient user and/or other health care provider users having access to the patient's profile.

To further customize the treatment plan, the system may crowd source 2608 anonymous medical treatment data. For example, the user may have the option of choosing to include the user's selected information in crowd-sourcing data, which would then enable it to be polled by the system for community-based data as described. The customized treatment plan is updated 2610 based on the anonymous medical treatment data, based on data from the Symptom Tracker, the database analyzes responses of users following the same treatment plans to identify, for example similar results, side effects, etc., and/or outlying results, side effects, etc. For example, analysis of results for a specific treatment plan for a specific diagnosis may show that a majority of patients on such treatment plan for such diagnosis are feeling worse. This would then alert the system administrator and or one or more of the patients' physicians or other authorized users of this information to make adjustments to that treatment plan for treating that diagnosis, and to update all users of that treatment plan for that diagnosis accordingly. The updated customized treatment plan can be sent to or downloaded 2612 by at least one of the patient and the patient's physician or other health care provider to the patient.

The updates to the customized treatment plan can be performed in real-time and the update can be sent or downloaded immediately after performing the real-time updating. Alternatively, updates may be sent out at regular intervals, such as every twenty-four hours or after passage of some other predetermined time interval. For example, the server 400 may poll devices 10 at midnight, compile data, note any changes in user responses outside of a typical, predetermined range, and trigger a message that a treatment plan need to be reviewed when any (or a predetermined number or percentage of responses) such changes are noted.

The system, via connection server 400 may receive receiving data specific to a patient user in regard to a treatment plan and analyze the data specific to the patient relative to at least one of: the treatment plan, data specific to at least one other patient, or statistics calculated from data specific to a plurality of other patients. As a result of this analysis, the system may send an alert to the patient's device 10 when a non-conforming treatment is determined by the analysis.

Using the HealthMap tool (see FIG. 2), a user may locate a nearby pharmacy (cased on an inputted zip code, for example) having a needed medication and which is currently open for business. Likewise, the same tool can be used to locate a nearby vendor or provider, based on an inputted zip code. Also, the same tool can be used to identify a nearby provider that performs a recommended procedure in-office. Lists of vendors or providers may be limited to only those that have been approved by administrators of the system, such as, for example, board-certified physicians and other practitioners recognized as experts.

The Pillbox tool provides a custom-designed drug database specific to the patient's needs. The custom-designed drug database may include expert-curated content (e.g., “The main side effect of concern for patients taking Levaquin is tendon rupture”, or, as another example “The differential diagnoses for sinusitis are: headache, acid reflux, Temporomandibular Joint Disorder, asthma and allergic rhinitis'). For simplicity, the custom-designed drug database may be limited to listing the top three (or some other small, predetermined number of) side effects for each drug listed in the database, an example of which is shown in FIG. 14. The listed top side effects may be determined by experts in a field of use for which each drug is prescribed.

Optionally, the Pillbox tool of the present invention may include a pediatric dosage calculator 262 as described with regard to FIG. 18B, programmed to calculate a pediatric dosage from an adult dosage provided to device 10.

The patient's drug regimen in the Pillbox tool may be updated by the patient's physician, via the physician's device 10 or other computer accessing the central database 408. Initial sharing may be performed using the office visit using the “bump” application as described above. The central database may be updated by synching the device 10 with a computer, or directly from the device to the central database. After editing the patient's drug regimen, the updated drug regimen is sent to the mobile medical computing device 10 of the patient user. Such updates may include, for example, sending at least one graphical image of each drug to be discontinued, and/or sending a graphical image of each drug to be used in an initiated drug treatment and/or descriptions and other related data regarding each drug to be initiated and/or discontinued.

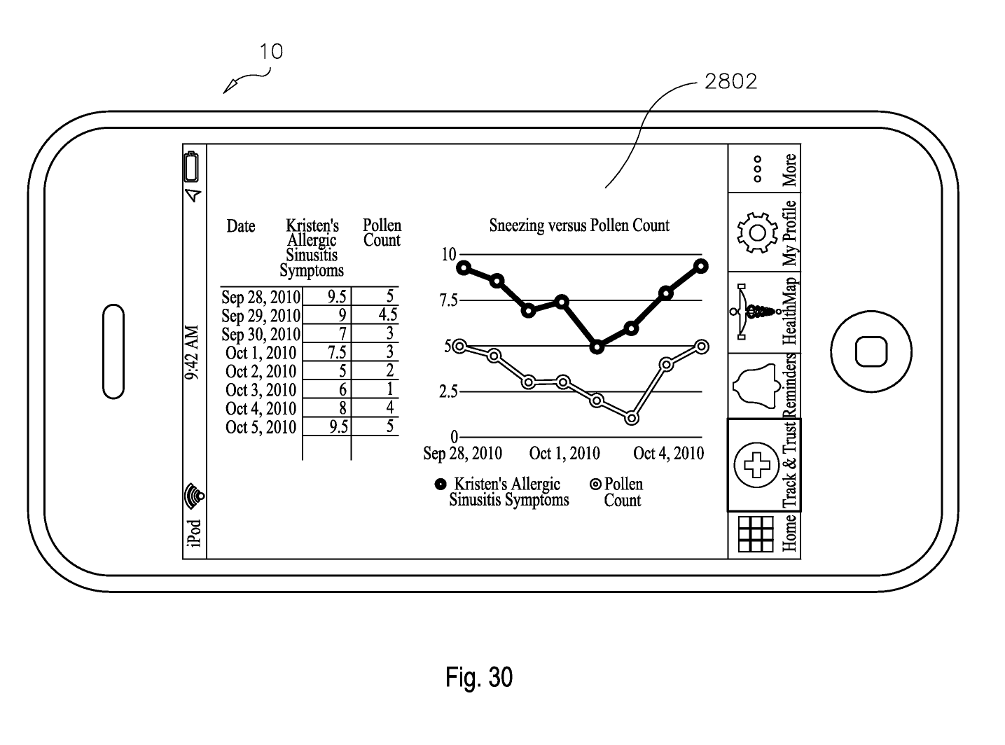

Upon accessing the profile display 140, the user may operate the invention to perform at least one of: playing one or more voice memos stored in the profile; displaying at least one pop-up window having a message and/or graphic displayed therein; displaying at least one calendar reminder, and/or displaying at least one graphical memo, such as a multidimensional graph 2802, an example of which is shown in FIG. 30. It is noted that the present invention is not limited to two-dimensional graphs, as three- or other multiple dimensional graphs may be displayed.

When the user is a physician, the device 10 may be configured to display a key checklist of items to be performed by a physician when treating a patient according to a treatment plan. Similar or the same checklists may be provided in devices 10 used by medical students, to serve as learning tools or reminders.

Likewise, when the user is a patient, the device 10 may be configured to display a key checklist of items to be performed by the patient when being treated according to a treatment plan.

Accessing negotiated reduced prices for preferred health care products from web-based information source, in which the system provides a link to the vendor so that the user can access the vendor by Internet or telephone. The negotiated price may optionally be provided to the user as reference data. In either case, the system will have pre-negotiated a price such that any user that accesses the provider via the provided link receives a discount on the recommended product(s).

The system may further provide, via the connection server 400 and database 408, anonymous diagnosis groups, such as chat rooms to share strategies for care and/or resources. Access to these chat rooms may be limited to only those patients that are being treated for a particular diagnosis or symptom and/or physicians and other care providers providing treatment to such patients.

The present system provides for secure text messaging among users. For example a secure text message may be sent from one user of a mobile medical computing device 10 (or other computer with texting capabilities) to another mobile medical computing device 10 running the application of the present invention. Thus a secure text message can be sent from a patient to the patient's physician, from the physician to the patient, from the physician to one or more other physicians, or point-to-multipoint from any one of the patient, physician and other physicians or other health care providers to more than one of the patient, physician and other physicians or other health care providers.

The Pillbox tool includes a display that shows graphical displays of each pill currently being taken by a patient user. Upon updating the pillbox such as in a manner described above, the Pillbox tool displays an updated pillbox feature highlighting pills that have been added and/or deleted from a previously current pillbox and generate a text-format log in the user's medical history indicating when the changes were implemented.

Device 10 can be used to record locations of physician, pharmacy and other health care provider visits, using a global positioning satellite access feature of the mobile medical computing device 10. This recorded data can then be used to update the user's database regarding local care resources from the recorded locations. Additionally, or alternatively the centralized database 408 can be updated with the recorded data to update its database of local care resources. When performed alternatively, the user's local database will then be updated by a subsequent update received from the central database 408 of the system.

Additional recording features of device 10 running the application of the present invention include, but are not limited to: logging a date and time of a telephone call between the patient and the physician; and downloading or sending the date and time to an electronic medical record of the physician for the patient.

Additional tracking features of the track and treat tool include, but are not limited to: tracking duration of existence of one or more of a patient user's symptoms, and sending, displaying or audibly playing a reminder to make a physician's appointment when the duration of the symptom exceeds a predetermined time.

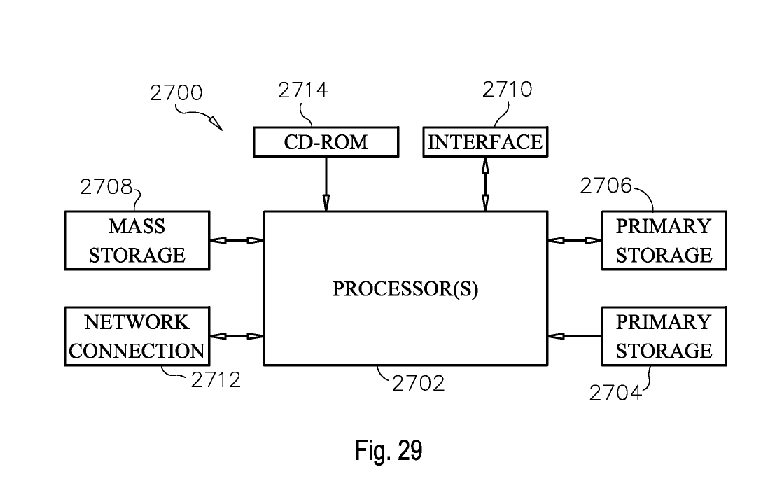

FIG. 29 illustrates a typical computer system 2700 in accordance with an embodiment of the present invention. The computer system 2700 in total, or one or more components thereof may be incorporated into a system according to the present invention, and all or part may be included in connection server 400/database 408, device 10, desktop computer 402, laptop computer 404 and/or PDA/other mobile computing device 10′ described herein, or may be configured externally to control one or more functions performed by the system of the present invention. Computer system 2700 includes any number of processors 2702 (also referred to as central processing units, or CPUs) that are coupled to storage devices including primary storage 2706 (typically a random access memory, or RAM), primary storage 2704 (typically a read only memory, or ROM). Primary storage 2704 acts to transfer data and instructions uni-directionally to the CPU and primary storage 2706 is used typically to transfer data and instructions in a bi-directional manner Both of these primary storage devices may include any suitable computer-readable media such as those described above. A mass storage device 2708 is also coupled bi-directionally to CPU 2702 and provides additional data storage capacity and may include any of the computer-readable media described above. Mass storage device 2708 may be used to store programs, such as algorithms for the Pillbox tools, profile screen, diagnosis tools, symptoms tools, track and treat tools, etc., as well as medical records data, and/or other programming such as that required for producing outputs, storage, etc., and is typically a secondary storage medium such as a hard disk in the case of a desktop computer, or flash memory in the case of a smartphone, PDA or other devices 10, 10′. It will be appreciated that the information retained within the mass storage device 508, may, in appropriate cases, be incorporated in standard fashion as part of primary storage 506 as virtual memory, thereby increasing the effective memory of primary storage 506. A specific mass storage device such as a CD-ROM or DVD-ROM 2714 may also pass data uni-directionally to the CPU, but these are not typically provided with the smaller, more mobile devices, such as 10 and 10′, although they are typically included in the other examples of computing devices referred to herein.

CPU 2702 is also coupled to an interface 2710 that includes one or more input/output devices such as video monitors, user interface, track balls, mice, keyboards, microphones, touch-sensitive displays, transducer card readers, magnetic or paper tape readers, tablets, styluses, voice or handwriting recognizers, apparatus for inputting datasets, instruments for emitting signals to reflect them off an object and receiving reflected signals to generate data for input datasets, or other well-known input devices such as, of course, other computers. Finally, CPU 2702 may be coupled to a computer or telecommunications network using a network connection as shown generally at 2712, which may include various types of modems and telephone receivers/transmitters. With such a network connection, it is contemplated that the CPU might receive information from the network, or might output information to the network in the course of performing the above-described method steps.

The hardware elements described above may implement the instructions of multiple software modules for performing the operations of this invention. For example, instructions for processing a medical treatment plan may be stored on mass storage device 2708 or 2714 and executed on CPU 2702 in conjunction with primary memory 2706.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM), and other physical forms of computer readable matter. However, computer readable media are not intended to refer to carrier waves. Examples of program instructions include both machine code, such as produced by a compiler, and files containing higher level code that may be executed by the computer using an interpreter.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A computer readable medium including one or more sequences of instructions for performing mobile medical information management, wherein execution of the one or more sequences of instructions by one or more processors of a mobile medical computing device causes the mobile medical computing device to perform a process comprising:
accessing one or more web-based patient portals and downloading medical history records of the patient from said one or more web-based portals, based upon a user profile including personal information that uniquely identifies the patient; and
outputting data from the downloaded medical history to at least one of the patient and a physician or other authorized care provider treating or evaluating the patient.

2. The computer readable medium of claim 1, further including instructions which, when executed by the mobile medical computing device, cause the device to:
record a conversation between the user and the physician or other authorized care provider, when the user is a patient, or between the user and a patient when the user is the physician or other authorized care provider, for later review by the user.

3. The computer readable medium of claim 2, further including instructions which, when executed by the mobile medical computing device, cause the device to:
automatically transcribe the recorded conversation for outputting a transcribed version of the recorded conversation.

4. The computer readable medium of claim 3, further including instructions which, when executed by the mobile medical computing device, cause the device to perform a process comprising:
outputting the transcribed recording, wherein said outputting comprises at least one of: printing the transcribed recording; providing voice recognition highlight of a chief complaint by the patient during the conversation; automatically incorporating the transcribed recording into the physician's or other authorized care provider's electronic medical record regarding the patient; automatically incorporating the transcribed recording into the patients electronic medical record stored in the mobile medical computing device; automatically electronically sending the transcribed recording over the internet or by wireless text transmission to another database of the patient, into the patients electronic medical record stored in the mobile medical computing device; automatically electronically sending the transcribed recording over the internet or by wireless text transmission to another physician's or other authorized care provider's electronic medical record regarding the patient and automatically incorporating the transcribed recording into the other physician's or other authorized care provider's electronic medical record regarding the patient.

5. The computer readable medium of claim 3, further including instructions which, when executed by the mobile medical computing device, cause the device to perform a process comprising:
automatically editing the transcription, thereby creating a detailed visit note meeting requirements for transmitting to an insurer or another provider.

6. The computer readable medium of claim 1, further including instructions which, when executed by the mobile medical computing device, cause the device to perform a process comprising:
accessing web-based medical treatment data; and
preparing a customized treatment plan, customized according to the web-based medical treatment data accessed.

7. The computer readable medium of claim 6, wherein the customized treatment plan is a Smart Treatment Plan.

8. The computer readable medium of claim 6, wherein the customized treatment plan is a Symptom Relief Plan.

9. The computer readable medium of claim 6, wherein relative weighting values of symptoms identified are assigned in the customized treatment plan.

10. The computer readable medium of claim 6, wherein relative weighting values of symptoms are used to assign differential diagnoses in the custom treatment plan.

11. The computer readable medium of claim 6, wherein the treatment plan identifies diagnostic tests applicable to symptoms identified in the custom treatment plan.

12. The computer readable medium of claim 6, wherein the treatment plan identifies emerging developments in treating a diagnosis or symptom identified in the custom treatment plan.

13. The computer readable medium of claim 6, wherein the treatment plan provides facts learned in prior cases and/or research applicable to attending to a diagnosis or symptom identified in the custom treatment plan.

14. The computer readable medium of claim 6, wherein the treatment plan identifies a surgical procedure applicable to a symptom or diagnosis identified in the custom treatment plan.

15. The computer readable medium of claim 6, wherein the treatment plan identifies additional resources that can be accessed online to read further information applicable to an item identified in the custom treatment plan.

16. The computer readable medium of claim 6, wherein the treatment plan identifies at least one medication applicable to at least one symptom identified in the custom treatment plan.

17. The computer readable medium of claim 6, wherein the treatment plan identifies at least one home remedy applicable to at least one symptom identified in the custom treatment plan.

18. The computer readable medium of claim 6, wherein the web-based medical treatment data is specific to an identified community of users.

19. The computer readable medium of claim 6, wherein the web-based medical treatment data is specific to a zip code.

20. The computer readable medium of claim 6, wherein the web-based medical treatment data is specific to the patient.

21. The computer readable medium of claim 6, further including instructions which, when executed by the mobile medical computing device, cause the device to perform a process comprising:
sending or outputting the customized treatment plan to at least one of the patient and physician or other authorized care provider.

22. The computer readable medium of claim 6, further including instructions which, when executed by the mobile medical computing device, cause the device to perform a process comprising:
crowd sourcing of anonymous medical treatment data;
updating of the customized treatment plan based on the anonymous medical treatment data; and
sending or outputting the updated, customized treatment plan to at least one of the patient and physician or other authorized care provider.

23. The computer readable medium of claim 22, wherein said updating comprises real-time updating and wherein said sending or outputting occurs immediately after performing said real-time updating.

24. The computer readable medium of claim 1, further including instructions which, when executed by the mobile medical computing device, cause the device to perform a process comprising:
record, for playback as a voice memo, a hospital discharge summary and follow-up care recommendations.

25. The computer readable medium of claim 22, further including instructions which, when executed by the mobile medical computing device, cause the device to:
automatically transcribe the hospital discharge summary and follow-up care recommendations to a text file.

26. The computer readable medium of claim 1, further including instructions which, when executed by the mobile medical computing device, cause the device to perform at least one of:
automatically electronically storing the text file into the mobile medical computing device on which the voice memo is recorded; sending the text file over the internet or by wireless text transmission to another database of the patient, into the patient's electronic medical record stored in the mobile medical computing device; automatically electronically sending the text file over the internet or by wireless text transmission to the physician's or other authorized care provider's electronic medical record regarding the patient and automatically incorporating the text file into the physician's or other authorized care provider's electronic medical record regarding the patient; or automatically electronically sending the text file over the internet or by wireless text transmission to another physician's or other authorized care provider's electronic medical record regarding the patient and automatically incorporating the text file into the other physician's or other authorized care provider's electronic medical record regarding the patient.

27. The computer readable medium of claim 1, further including instructions which, when executed by the mobile medical computing device, cause the device to perform a process comprising:
receiving data specific to the patient in regard to the treatment plan;
analyzing the data specific to the patient relative to at least one of: the treatment plan, data specific to at least one other patient, or statistics calculated from data specific to a plurality of other patients; and
sending an alert to the patient when a non-conforming treatment is determined by said analyzing.

28. The computer readable medium of claim 1, further including instructions which, when executed by the mobile medical computing device, cause the device to perform a process comprising:
locating a nearby pharmacy having a needed medication and which is currently open for business.

29. The computer readable medium of claim 1, further including instructions which, when executed by the mobile medical computing device, cause the device to perform a process comprising:
locating an expert-approved vendor or provider.

30. The computer readable medium of claim 1, further including instructions which, when executed by the mobile medical computing device, cause the device to perform a process comprising:
providing a custom-designed drug database specific to the patient's needs, wherein the custom-designed drug database includes expert-curated content.

31. The computer readable medium of claim 30, wherein said custom-designed drug database lists top three side effects for each of at least one drug listed in said database, wherein said top three side effects are determined by experts in a field of use for which each said at least one drug is prescribed.

32. The computer readable medium of claim 1, further including instructions which, when executed by the mobile medical computing device, cause the device to perform a process comprising:
calculating a pediatric dosage from an adult dosage provided to said mobile medical computing device.

33. The computer readable medium of claim 1, further including instructions which, when executed by the mobile medical computing device, cause the device to perform a process comprising:
updating a patient's drug regimen by the physician or other authorized care provider; and
sending the updated drug regimen to the mobile medical computing device of the patient.

34. The computer readable medium of claim 33, wherein said sending includes at least one of sending a graphical image of each drug to be discontinued, or sending a graphical image of each drug to be used in an initiated drug treatment.

35. The computer readable medium of claim 1, further including instructions which, when executed by the mobile medical computing device, cause the device to perform a process comprising:
accessing the profile of the user, and
performing at least one of: playing one or more voice memos stored in the profile; displaying at least one pop-up window; displaying at least one calendar reminder; and displaying at least one multi-dimensional graph.

36. The computer readable medium of claim 1, further including instructions which, when executed by the mobile medical computing device, cause the device to perform a process comprising:
providing a key checklist of items to be performed by a physician or other authorized care provider when treating a patient according to a treatment plan.

37. The computer readable medium of claim 36, wherein said checklist serves as a learning tool or reminder for a medical student.

38. The computer readable medium of claim 1, further including instructions which, when executed by the mobile medical computing device, cause the device to perform a process comprising:
providing a key checklist of items to be performed by a patient when being treated according to a treatment plan.

39. The computer readable medium of claim 1, further including instructions which, when executed by the mobile medical computing device, cause the device to perform a process comprising:
accessing negotiated reduced prices for preferred health care products from web-based information source; and
displaying said negotiated reduced prices for viewing by the user.

40. The computer readable medium of claim 1, further including instructions which, when executed by the mobile medical computing device, cause the device to perform a process comprising:
allowing anonymous diagnosis groups to share strategies for care and/or resources.

41. The computer readable medium of claim 1, further including instructions which, when executed by the mobile medical computing device, cause the device to perform a process comprising:
sending a secure text message to another mobile medical computing device running said computer readable medium, wherein said secure text message can be sent from a patient to the physician or other authorized care provider, from the physician or other authorized care provider to the patient, from the physician or other authorized care provider to one or more other physicians or other authorized care providers, or point-to-multipoint from any one of the patient or other authorized care provider, physician or other authorized care provider and other physicians or other authorized care providers to more than one of the patient or other authorized care provider, physician and other physicians or other authorized care providers.

42. The computer readable medium of claim 1, further including instructions which, when executed by the mobile medical computing device, cause the device to perform a process comprising:
identifying a nearby provider that performs a recommended procedure in-office.

43. The computer readable medium of claim 1, further including instructions which, when executed by the mobile medical computing device, cause the device to perform a process comprising:
displaying a current pillbox feature including graphical displays of each pill currently being taken by a patient.

44. The computer readable medium of claim 1, further including instructions which, when executed by the mobile medical computing device, cause the device to perform a process comprising:
displaying an updated pillbox feature highlighting pills that have been added and/or deleted from a previously current pillbox.

45. The computer readable medium of claim 1, further including instructions which, when executed by the mobile medical computing device, cause the device to perform a process comprising:
recording locations of physician or other authorized care provider and pharmacy visits, using a global positioning satellite access feature of said mobile medical computing device; and
creating a centralized database regarding local care resources from said recorded locations.

46. The computer readable medium of claim 1, further including instructions which, when executed by the mobile medical computing device, cause the device to perform a process comprising:
receiving inputted information from the patient regarding severity of symptoms on a repeated basis;
tracking the inputted information, relative to stored parameters chosen by at least one of the patient and the physician or other authorized care provider; and
identifying improvement and/or worsening of one or more of said symptoms.

47. The computer readable medium of claim 1, further including instructions which, when executed by the mobile medical computing device, cause the device to perform a process comprising:
displaying and/or audibly reminding the patient of at least one of: a scheduled physician's or other authorized care provider's appointment, a need to make a physician's or other authorized care provider's appointment, a time to take a medication, or a need to refill a prescription.

48. The computer readable medium of claim 1, further including instructions which, when executed by the mobile medical computing device, cause the device to perform a process comprising:
logging a date and time of a telephone call between the patient and the physician or other authorized care provider; and
downloading or sending said date and time to an electronic medical record of the physician or other authorized care provider for the patient.

49. The computer readable medium of claim 46, further including instructions which, when executed by the mobile medical computing device, cause the device to perform a process comprising:
tracking duration of existence of one or more of said symptoms; and
sending, displaying or audibly playing a reminder to make a physician's or other authorized care provider's appointment when said duration exceeds a predetermined time.

50. The computer readable medium of claim 1, further including instructions which, when executed by the mobile medical computing device, cause the device to perform a process comprising:
receiving updates for treatment resulting from a web-based survey tool that can be accessed by selected physicians or other authorized care providers to provide best practices data, wherein said best practices data includes one or more of: knowledge that the selected physicians or other authorized care providers have learned that can prevent misdiagnosis or poor treatment outcomes; differential diagnoses that are often linked with a diagnosis at issue; side-effects of medications observed in the selected physicians' or other authorized care providers' practices; home remedies useful in treatment of the diagnosis at issue; home remedies that improve overall quality of life; or resources for patients and families to assist in self-care.

51. A method of providing and updating medical care information, said method comprising:
providing a web-based survey tool that can be accessed by selected physicians to provide best practices data, wherein said best practices data includes one or more of: knowledge that the selected physicians or other authorized care providers have learned that can prevent misdiagnosis or poor treatment outcomes; differential diagnoses that are often linked with a diagnosis at issue; side-effects of medications observed in the selected physicians' or other authorized care providers' practices; home remedies useful in treatment of the diagnosis at issue; home remedies that improve overall quality of life; or resources for patients and families to assist in self-care;
downloading results received from one or more of said selected physicians or other authorized care providers having accessed said web-based survey tool and inputted said best practices data;
editing the downloaded results and creating updated data; and
sending said updated data to a mobile medical computing device.

52. The method of claim 51, wherein said editing includes data mining the downloaded results and said updated data includes at least one graphical representation generated using mined data resulting from said data mining.

53. The method of claim 51, wherein said sending said updated data comprises sending an application software update to said mobile medical computing device for updating application software executing on said mobile medical computing device.

54. The method of claim 51, wherein said updated data, when executed on said mobile medical computing device, displays a series of screen images and textual information and/or voice data relating to said screen images, describing a logical information flow of a standard physician's or other authorized care provider's office visit.

55. A mobile medical care and information system, said system comprising:
a mobile medical computing device comprising at least one processor; and
programming which, when executed by said at least one processor, performs a process including:
accessing one or more web-based patient portals and downloading medical history records of a patient from said one or more web-based portals, based upon a user profile including personal information that uniquely identifies the patient and
outputting data from the downloaded medical history to at least one of the patient and a physician or other authorized care provider treating or evaluating the patient.

56. A method of facilitating medical care and information, said method comprising:
providing a mobile medical computing device;
recording a conversation between a user of the device and a doctor, when the user is a patient, or between the user of the device and a patient or other medical healthcare professional when the user is a doctor, for later review by the user; and
automatically transcribing the recorded conversation for outputting a transcribed version of the recorded conversation.
